(19) United States
(12) Patent Application Publication
(10) Pub. No.: US 2022/0380495 A1
(43) Pub. Date: Dec. 1, 2022

(54) REACTIVE OLIGOMERS, ADDITIVE MANUFACTURING METHODS, AND ARTICLES THEREOF

(71) Applicant: THE UNIVERSITY OF NORTH CAROLINA AT CHAPEL HILL, CHAPEL HILL, NC (US)

(72) Inventor: Theo DINGEMANS, Chapel Hill, NC (US)

(21) Appl. No.: 17/775,221

(22) PCT Filed: Nov. 6, 2020
(86) PCT No.: PCT/US2020/059521

§ 371 Date: May 6, 2022

Related U.S. Application Data
(60) Provisional application No. 62/932,892, filed on Nov. 8, 2019.

(51) Int. Cl. C08F 138/00; C09D 149/00; C09D 4/00; B33Y 10/00; B33Y 70/00; B29C 64/118; B29C 64/153; B33Y 40/20

(52) U.S. Cl. CPC C08F 138/00; C09D 149/00; C09D 4/00; B33Y 10/00; B33Y 70/00; B29C 64/118; B29C 64/153; B33Y 40/20; C08F 2810/20; B29K 2079/085

(57) ABSTRACT

A reactive oligomer has a backbone derived from at least one of polyamideimide, polyimide, polyetherimide, polyaryletherketone, polyethersulfone, polyphenylene sulfide, polyamide, polyester, polyarylate, polyesteramide, polycarbonate, polybenzoxazole or polybenzimidazole and functionalized with at least one unreacted functional group capable of thermal chain extension and crosslinking after formation of the reactive oligomer, wherein the reactive oligomer has an Mₙ of about 250 to about 10,000 g/mol, calculated using the Carothers equation. Compositions comprising the reactive oligomer have at least one other component that includes a second reactive oligomer, an oligomer lacking unreacted functional groups capable of thermal chain extension and crosslinking, a thermoplastic polymer, a thermoplastic polymer having the same backbone repeat units as the reactive oligomer, a filler, or an additive. A method of manufacture of an article comprises heating a composition comprising the reactive oligomer at a sufficient temperature and time to shape and crosslink the reactive oligomer, including additive manufacturing.

### CROSS REFERENCE TO RELATED APPLICATION

This application claims the benefit of U.S. Provisional Application Nos. 62/932,892 filed Nov. 8, 2019 and 63/075,610 filed Sep. 8, 2020, both of which are incorporated by reference in their entirety herein.

### BACKGROUND

All-aromatic polyamideimides (PAIs) are high performance polymers having alternating cyclic imide and amide linkages in the polymer backbone, and were first commercialized in the early 1970s. High molecular weight PAIs have excellent high temperature strength, low temperature toughness and impact strength, and exceptional chemical resistance and dimensional stability. High molecular weight PAIs can have amic acid groups in the polymer backbone that are not imidized. The amic acid groups lend some flexibility to the polymer backbone, which makes the PAIs somewhat melt processable, although not easily. However, there are still several challenges associated with melt processing of high molecular weight PAL. The melt viscosity is highly sensitive to temperature and shear rate, and the PAI has a narrow processing window with processing temperatures greater than 600° F. (316° C.) required. Amic acids convert thermally to imides by cyclodehydration, and conversion of amic acid groups to cyclic imide groups results in rapid increase in rigidity of the polymer backbone, and therefore a rapid increase in melt viscosity. If this happens during extrusion, there is a risk that the polymer melt might solidify in the extruder. Due to the presence of non-imidized amic acid groups, PAI is highly moisture sensitive and must be thoroughly dried before, and maintained dry during, melt processing to prevent molecular weight and thermal/mechanical property degradation. Moreover, imidization and removing water of imidization for 20 or more days at 500° F. (260° C.) may be required to obtain optimal properties. These difficulties have limited the use of high molecular weight PAI to the manufacture of simple stock shapes such as rods, plates, tubes, and other profiles. These stock shapes can then be machined into parts not accessible by injection molding by, for example, turning, drilling, and milling steps.

In view of the processing limitations of high molecular weight PAIs, less viscous injection molding grades have been developed. These grades can be used to produce injection-molded, filled and unfilled parts and stock-shapes, but with difficulty. Injection molding grades are believed to be mixtures of amine-terminated low molecular weight (oligomeric) polyamides with dianhydride chain-extenders, such as pyromellitic anhydride (PMDA), to build molecular weight in situ. The oligomeric nature of the polyamides lowers melt viscosity, which aids in melt processing steps, and the amine-terminated polyamide oligomer is reacted with a dianhydride to form a high molecular weight polyamide amic acid intermediate through chain-extension. After processing, the produced parts and stock shapes need to be post cured. In post curing, the amic acid groups cyclodehydrate to form the PAI. A major disadvantage of this route to PAI is that large amounts of water need to be removed from the final part. There are two sources of such water: i) physisorbed water associated with the hygroscopic residual amic acid moieties in the chain-extended PAI; and ii) water generated in the cyclodehydration step. Removing water from parts and stock shapes is a time-consuming process requiring multiples days to weeks under a programmed heating protocol that is dependent on the thickness of the part and its final application. There is a need in the art for all-aromatic PAIs that do not require extended thermal post-cure and time-consuming water removal steps.

Although injection molding grade of PAI was an improvement over high molecular weight PAI, there are still many difficulties in melt processing. As discussed above, amic acid groups are still present in the chain-extended PAI, so it must be thoroughly dried before use. It is also still necessary to perform thermal post-treatment steps to complete polymerization (chain-extension) and/or imidize amic acid groups. As discussed above, water is generated in these post-treatment steps, and must be removed to avoid foaming, formation of micro bubbles, and embrittlement of the part. There are other difficulties with injection molding grade PAI as well. Residence time must be optimized, because excessive residence time will result in loss of flow due to chain extension and increasing viscosity. Molds must be filled rapidly and pressure must be optimized for each mold size and shape. Injection molding with family mold designs does not work well. The viscosity of injection molding grade PAI is still highly shear sensitive. Therefore, injection speed, injection pressure, back pressure, screw speed, barrel temperature, cycle time, and mold heating must all be optimized for each specific mold shape and size.

Post-heat treatment is still critical for injection molding grade PAL. Although as-molded parts might appear to be finished, they are actually weak, brittle, and have poor chemical resistance and wear resistance, and sub-optimal thermal resistance. To achieve optimal properties, molded parts must be heated in a forced-air oven on a cure schedule of a series of incremental temperature increases at time intervals, which must be optimized for each type and size of part. A general cure schedule recommended by a manufacturer is: 1 day at 375° F. (191° C.), 1 day at 425° F. (218° C.), 1 day at 475° F. (246° C.), and 5 days at 500° F. (260° C.), for a total of 8 days. Thicker parts can take longer to cure because the water of reaction must diffuse from the part for the reaction to proceed. Therefore, the reaction rate diminishes as the diffusion path lengthens. Moreover, certain parts, such as those with very thin walls and/or delicate features, may require fixturing during post-cure to meet tight dimensional tolerances.

In view of the above problems, there remains a need in the art for easily melt processable and curable PAIs that do not require extensive drying before processing and do not require extensive thermal post-treatment to remove water generated from cyclodehydration of amic acid functional groups. There also remains a need for a PAI that is suitable for a variety of article manufacturing processes, including additive manufacturing, such as fused deposition molding (FDM) using filaments or rods, selective laser sintering (SLS) for powder bed printing, directed energy deposition (DED) laser engineered net shaping (LENS), and composite-based additive manufacturing (CBAM).

These challenges are not limited to PAIs. There also remains in the need in the art for other engineering polymers and high performance polymers that not only are easily melt processable and curable, but also provide articles having superior thermal and mechanical properties. In particular, such improvements are also highly desirable for polyimides, polyetherimides, polyaryletherketones, polyethersulfones, polyphenylene sulfides, polyamides, polyesters, polyarylates, polyesteramides, polycarbonates, polybenzoxazoles, and polybenzimidazoles as well as polyamideimides.

The subject matter described herein addresses these shortcomings in the art and more.

### BRIEF DESCRIPTION

A reactive oligomer comprises a backbone derived from at least one of polyamideimide, polyimide, polyetherimide, polyaryletherketone, polyethersulfone, polyphenylene sulfide, polyamide, polyester, polyarylate, polyesteramide, polycarbonate, polybenzoxazole or polybenzimidazole and functionalized with at least one unreacted functional group capable of thermal chain extension and crosslinking after formation of the reactive oligomer, wherein the reactive oligomer has a number average molecular weight (M) of about 250 to about 10,000 g/mol, calculated using the Carothers equation.

Compositions comprising the reactive oligomer can comprise at least one other component. A method of compounding the reactive oligomer comprises mixing the reactive oligomer with the at least one other component at a sufficient temperature and time to form a homogeneous molten mixture, but not crosslink the unreacted functional groups. The at least one other component can be at least one of a second reactive oligomer, an oligomer lacking unreacted functional groups capable of thermal chain extension and crosslinking, a thermoplastic polymer, a thermoplastic polymer having the same backbone repeat units as the reactive oligomer, a filler, or an additive.

A method of manufacture of an article comprises heating a composition comprising the reactive oligomer at a sufficient temperature and time to shape and crosslink the reactive oligomer. The method of manufacture can be additive manufacturing. Articles manufactured from compositions comprising the reactive oligomer include additive manufactured articles.

### BRIEF DESCRIPTION OF THE DRAWINGS

Referring now to the drawings:

FIG. 1A to 1D illustrate the concepts of diffusion across interfaces, and chain entanglement and crosslinking across interfaces. FIGS. 1A and 1B depict diffusion and entanglement of a high molecular weight high performance thermoplastic. FIGS. 1C and 1D depict diffusion, entanglement, and chain extension and crosslinking of reactive oligomers.

FIG. 2 is a graph of axial force (N) vs. time (min) for melt polymerization of 1,3-phenylene diamine, 4,4′-oxydianiline, trimellitic anhydride, and 4-(phenylethynyl)phthalic anhydride in a twin-screw extruder.

### DETAILED DESCRIPTION

A reactive oligomer comprising a backbone derived from at least one of polyamideimide, polyimide, polyetherimide, polyaryletherketone, polyethersulfone, polyphenylene sulfide, polyamide, polyester, polyarylate, polyesteramide, polycarbonate, polybenzoxazole or polybenzimidazole and functionalized with at least one unreacted functional group capable of thermal chain extension and crosslinking after formation of the reactive oligomer, wherein the reactive oligomer has a number average molecular weight (M) of 250 to 10,000 g/mol, calculated using the Carothers equation. The at least one unreacted functional group can be at least one of maleimide, 5-norbornene-2,3-dicarboxylic imide, phthalonitrile, benzocyclobutene, biphenylene, cyanate ester, ketoethyne, ethyne, methylethyne, phenylethyne, propargyl ether or benzoxazine.

It can be desirable for the reactive oligomer to be curable in stages at different temperature ranges, i.e. to be partially cured at a first temperature range, and to be further cured at a second, higher, temperature range. Thus, in some embodiments, the reactive oligomer is, functionalized with first and second unreacted functional groups capable of thermal chain extension and crosslinking after formation of the reactive oligomer, wherein the first unreacted functional group is self-reactive within a first temperature range, the second unreacted functional group is self-reactive within a second temperature range, and the second temperature range is higher than the first temperature range.

The reactive oligomer has a backbone derived from at least one of polyamideimide, polyimide, polyetherimide, polyaryletherketone, polyethersulfone, polyphenylene sulfide, polyamide, polyester, polyarylate, polyesteramide, polycarbonate, polybenzoxazole or polybenzimidazole. The backbone can be linear or branched.

x-PAI

In some embodiments, the reactive oligomer has a backbone derived from polyamideimide and is defined herein as a reactive polyamideimide oligomer. Also disclosed herein are reactive polyamide amic acid oligomers, reactive ammonium carboxylate salts, methods of manufacturing the reactive oligomers and reactive ammonium carboxylate salts, methods for processing the reactive oligomers and reactive ammonium carboxylate salts, and articles made from the reactive oligomers and reactive ammonium carboxylate salts. The routes to polyamideimide articles described herein remove the need for an extended thermal post cure and a time-consuming water removal step. This is accomplished by designing a fully imidized reactive polyamideimide oligomer that can be melt processed followed by a short (at most a few hours) thermal post-cure to yield high molecular weight polyamideimide via chain extension/crosslinking. The latter reactions take place by incorporating carefully selected functional groups into the reactive polyamideimide oligomer. These functional groups remain unreacted during oligomerization and are then available for thermal post-cure. During thermal post-cure, these functional groups can polymerize (chain extend/crosslink) via addition reactions without generating small molecule by-products like water.

The reactive polyamideimide oligomers with unreacted functional groups described herein allow for the production of stock-shapes, injection molded complex parts, 3D-printed parts and fiber- or mineral-reinforced composites without any thickness limitations because a water-removal step from the final product is no longer necessary. These routes to polyamideimides not only provide processing advantages (e.g., low viscosity, no residual water, no generated water), but also allows for the design and fabrication of PAI articles that were previously impossible to manufacture.

Having a Mₙ in the range of about 1,000 to about 10,000 g/mol provides lower melt viscosities and lower processing temperatures, so that melt processing can be done using conventional melt processing equipment. However, low molecular weight polymers (oligomers) are known to have poor mechanical properties because they lack polymer chain entanglements. Using crosslinkable monomers and/or crosslinkable end-cappers in the preparation of the reactive oligomers, molecular weight can be increased either by in-situ thermal polymerization (e.g. during reaction injection molding) or during a thermal post-treatment step (e.g. when preparing fiber reinforced composites).

Several advantages accrue to the reactive polyamideimide oligomers, which have thermally curable groups. The reactive polyamideimide oligomers are easily melt processable, do not require extensive drying before processing, and do not require extensive thermal post-treatment. Complex parts can be made from the reactive polyamideimide oligomer in one step. Curing can be done at about 160 to about 450° C., depending on the thermally curable group. In some embodiments, curing is done at about 300 to about 450° C., and can be completed in as little as about 1 to about 60 minutes compared to several days for currently available grades of PAL. When the reactive polyamideimide oligomer is fully imidized prior to melt processing, there is no need for the difficult step of water removal from stock shapes or injection molded parts. Advantageously, the reactive polyamideimide oligomers can be used for one-step injection molding of complex parts under conditions in which the reactive oligomers are cured instantaneously. Alternatively, parts can be easily thermally cured for about 1 to about 60 minutes. Moreover T_{g}, elongation at break, strength at break, and toughness of the cured reactive polyamideimide oligomer can be far superior to that of currently available PAI.

The reactive polyamideimide oligomer comprises units derived from at least one aromatic diamine, at least one aromatic di-, tri-, or tetra-functional carboxylic acid or functional equivalent thereof, and at least one crosslinkable monomer or crosslinkable end-capper; wherein the crosslinkable monomer or crosslinkable end-capper is reactive with the at least one aromatic diamine or at least one di-, tri-, or tetra-functional aromatic carboxylic acid or functional equivalent thereof and has at least one unreacted functional group capable of chain extension and crosslinking after formation of the reactive polyamideimide oligomer; and the reactive polyamideimide oligomer has a number average molecular weight (Mn) of about 250 to about 10,000 g/mol, preferably about 1,000 to about 10,000 g/mol, calculated using the Carothers equation.

The reactive polyamideimide oligomer comprises units derived from at least one aromatic diamine. The at least one aromatic diamine can have any of the chemical structures depicted below.

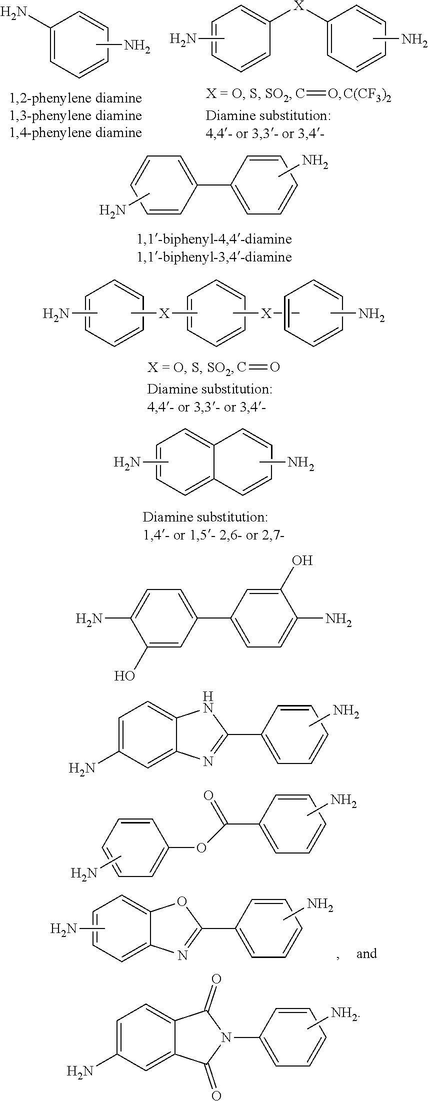

In some aspects, the at least one diamine is at least one of 1,3-phenylene diamine, 4,4′-oxydianiline, or 3,4′-oxydianiline.

The reactive polyamideimide oligomer also comprises at least one aromatic di-, tri-, or tetra-functional carboxylic acid or functional equivalent thereof. Functional equivalents of a carboxylic acid are functional groups in which the carboxyl carbon atom is in the same oxidation state, e.g. carboxylic acid esters, carboxylic acid halides, and carboxylic acid anhydrides. For example, trimellitic anhydrides functional equivalents are compounds in which the substituent carbon atoms in the 1-, 2-, and 4-positions on the benzene ring are in the same oxidation state. A functional equivalent of trimellitic anhydride is 4-chloroformylphthalic anhydride. The at least one aromatic di-, tri-, or tetra-functional carboxylic acid or functional equivalent thereof includes at least one aromatic di-, tri-, or tetra-functional carboxylic acid or functional equivalent thereof having vicinal (ortho) carboxylic acid or functional equivalent groups, for example a phthalic anhydride group, so that 5-membered phthalimide rings can form in the reactive oligomer backbone. The at least one aromatic di-, tri-, or tetra-functional carboxylic acid or functional equivalent thereof can have any of the chemical structures depicted below. “Functional equivalents” of carboxylic acids include compounds in which the carbon atom of the carboxylic acid group is in the same oxidation state, and includes esters, acid chlorides, and anhydrides thereof.

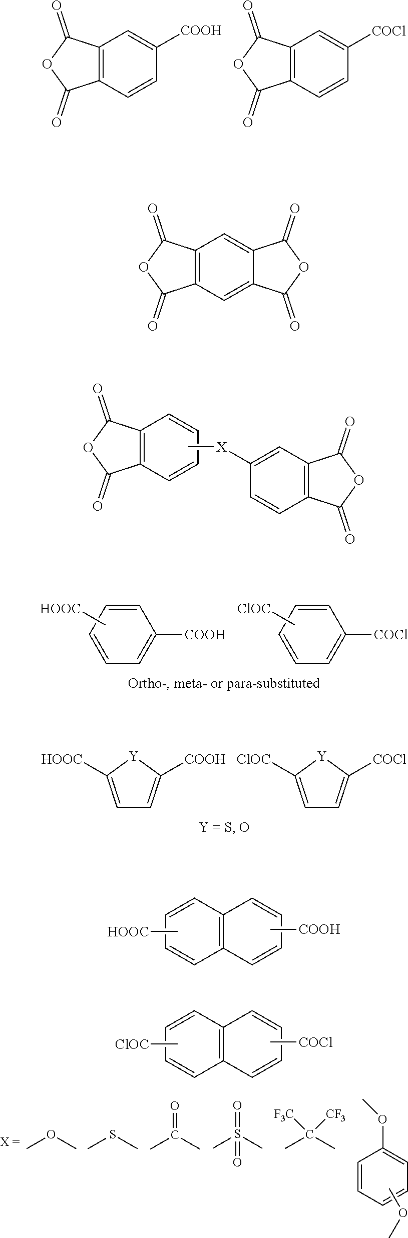

In some embodiments, the at least one aromatic di-, tri-, or tetra-functional carboxylic acid or functional equivalent thereof is at least one of trimellitic anhydride, 4-chloroformylphthalic anhydride, isophthalic anhydride, isophthaloyl chloride, pyromellitic dianhydride, or biphenyl tetracarboxylic acid dianhydride.

The reactive polyamideimide oligomer also comprises at least one crosslinkable monomer or crosslinkable end-capper that is reactive with the at least one aromatic diamine or at least one di-, tri-, or tetra-functional aromatic carboxylic acid or functional equivalent thereof and has at least one unreacted functional group capable of chain extension and crosslinking after formation of the reactive polyamideimide oligomer. This functional group remains unreacted after formation of the reactive polyamideimide oligomer so that it is available to participate in subsequent chain extension, branching, and crosslinking reactions. The chain extension, branching, and crosslinking that occur after formation of the reactive polyamideimide oligomer are known collectively as “curing”. “Crosslinking” as used herein is also a shorthand for any combination of chain extension, branching, and crosslinking. The curing or crosslinking can be initiated by heat, actinic (electromagnetic) radiation, and electron beam radiation. In some embodiments, the curing is initiated thermally. The unreacted functional group that participates in subsequent chain extension, branching, and crosslinking reactions is at least one of ethyne, methylethyne, phenylethyne, ketoethyne, propargyl ether, norbornene, maleimide, cyanate ester, phthalonitrile, benzocyclobutene, biphenylene, or benzoxazine. These unreacted functional groups are depicted in Table 1 with chemical formulas, chemical names, and curing temperature ranges. The at least one crosslinkable monomer or crosslinkable end-capper can be two crosslinkable monomers or crosslinkable end-cappers that are reactive at different temperature ranges.

TABLE 1
Functional groups capable of thermal chain extension, branching, and crosslinking
and cure temperature ranges.

| | | | Cure Temperature |
|---|---|---|---|
| Entry | Structure | Name | (° C.) |
| 1 | 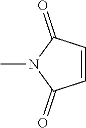 | Maleimide | 200-250 |
| 2 | 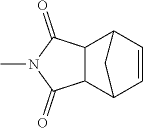 | Norbornene | 300-375 |
| 3 | 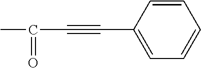 | Ketoethynyl | 190-230 (<190 when catalyzed) |
| 4 | 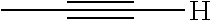 | Ethynyl | 230-280 |
| 5 | 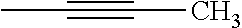 | Methylethynyl | 280-330 |
| 6 | 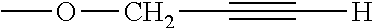 | Propargylether | 200-275 |
| 7 | 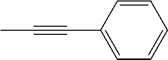 | Phenylethynyl | 330-400 |
| 8 | 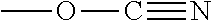 | Cyanate ester | 165-220 |
| 9 | 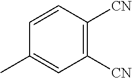 | Phthalonitrile | 300-350 |
| 10 | 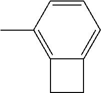 | Benzocylcobutene | 205-285 |
| 11 | 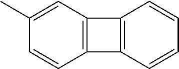 | Biphenylene | 280-330 |
| 12 | 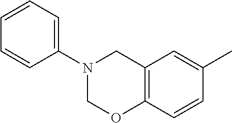 [SMILES: Cc1ccc2c(c1)CN(c1ccccc1)CO2] | Benzoxazine | 200-300 |
| 13 | 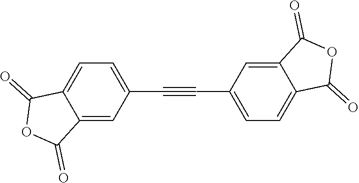 [SMILES: O=C1OC(=O)c2cc(C#Cc3ccc4c(c3)C(=O)OC4=O)ccc21] | 1,2-Diphenylethyne | 380-440 |

In some embodiments, the at least one unreacted functional group is derived from a monomer or end-capper selected from the group consisting of:

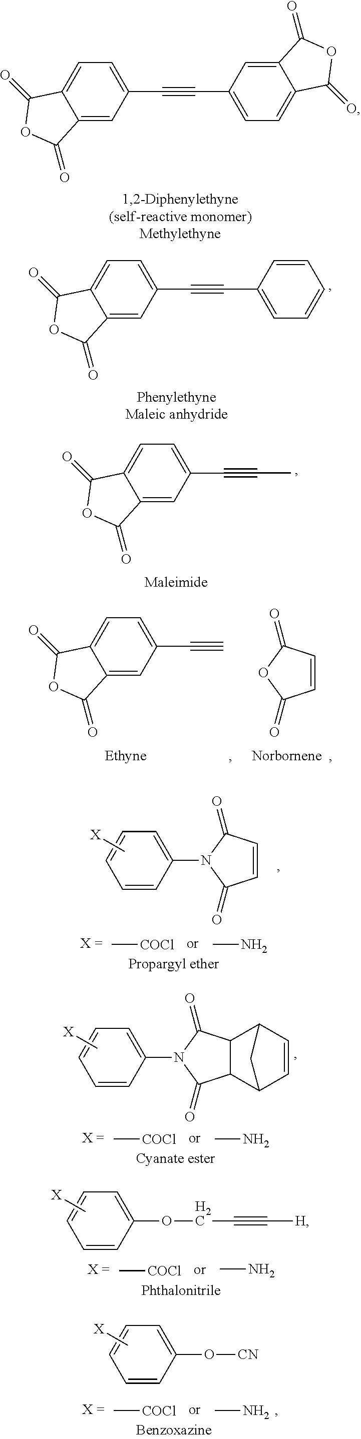

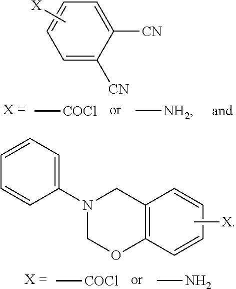

1,2-Diphenylethyne is a crosslinkable monomer. All the other compounds are crosslinkable end-cappers. In some embodiments, the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

The reactive polyamideimide oligomer can further comprise units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof, but has no unreacted functional groups capable of chain extension and crosslinking after formation of the reactive polyamideimide oligomer. The non-crosslinkable end-capper can be at least one of benzoic acid, benzoyl chloride, phthalic anhydride, or aniline.

The reactive polyamideimide oligomer can be linear or branched. In some embodiments, the reactive polyamideimide oligomer is branched. Branching is obtained by using tri-functional monomers. Thus, in some embodiments, the reactive polyamideimide oligomer further comprises units derived from at least one of an aromatic triamine, an aromatic tricarboxylic acid, or an aromatic tricarboxylic acid chloride. An example of an aromatic triamine is 1,3,5-triaminobenzene, and example of an aromatic tricarboxylic acid is 1,3,5-benzenetricarboxylic acid, and an example of an aromatic tricarboxylic acid chloride is 1,3,5-benzenetricarboxylic acid chloride.

Number average molecular weight, Mₙ as used herein is a target value, not a measured value. The amounts of monomers and crosslinkable end-cappers used to prepare the reactive oligomers are calculated using the Carothers equation, Eq. (2). Eq. (1) is used to calculate the degree of polymerization needed to achieve the target .

$$\overline{{M}_{n}} = \overline{{M}_{0}} \cdot \overline{{x}_{n}} \qquad ( 1 )$$

$$\overline{{x}_{n}} = \frac{1 + r}{1 + r - 2 rp} \qquad ( 2 )$$

(also referred to as Mₙ herein) is the target number average molecular weight, selected from the range of about 250 to about 10,000 g/mole, preferably about 1,000 to about 10,000 g/mol) and is the average molecular weight of the oligomer repeat unit. With and known, the number average degree of polymerization ( ) is calculated and substituted into Eq. 2. The reaction is assumed to go to completion so p=1, which simplifies Eq. 2 to an equation with one unknown, r, which is the reactant ratio and provides the stoichiometric off-set needed to prepare the desired reactive oligomer at the target .

Polyamide amic acids are intermediates in the synthesis of polyamideimides. As depicted in Scheme 1 below, polyamideimides are produced by cyclodehydration of the intermediate polyamide amic acid (upper right structure).

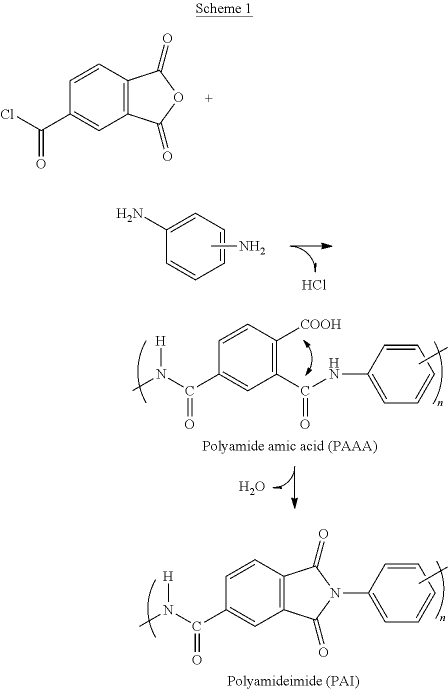

Since polyamide amic acids are intermediates in the preparation of polyamideimides, the reactive polyamideimide oligomer can have various degrees of imidization, i.e. conversion of the polyamide amic acid intermediate to the polyamideimide. Thus, in some embodiments, the reactive polyamideimide oligomer is derived from a reactive polyamide amic acid oligomer intermediate by cyclodehydration, and greater than about 80% and less than or equal to 100% of amic acid groups in the reactive polyamide amic acid intermediate are imidized. When the degree of imidization is in this range, the reactive polyamideimide oligomer is considered “fully imidized”. Within this range, greater than or equal to 85%, 90%, 95%, 96%, 97%, 98%, and 99%, and less than or equal to 100%, of the polyamide amic acid groups can be imidized.

It may be useful in some applications for the reactive polyamideimide oligomer to be less than 80% imidized. Thus, in some embodiments, the reactive polyamideimide oligomer is derived from a reactive polyamide amic acid oligomer intermediate by cyclodehydration, and greater than or equal to 20% and less than or equal to 80% of amic acid groups in the reactive polyamide amic acid intermediate are imidized. Within the range, greater than or equal to 30%, 40%, 50%, 60%, and 70% and less than or equal to 80%, of the amic acid groups can be imidized.

Advantageously, the reactive polyamideimide oligomer has a melt complex viscosity of about 1,000 to about 100,000 Pa·s at 360° C., measured by oscillatory shear rheology between parallel plates at a heating rate of 10° C./minute under N₂, a frequency of 2 radians/second, and a strain of 0.03% to 1.0%. Within this range, the melt complex viscosity is a function of Mₙ and the types and relative amounts of the at least one diamine, the at least one di-, tri-, or tetra-functional aromatic carboxylic acid or functional equivalent thereof, and crosslinkable or non-crosslinkable monomers and end-cappers used to make the reactive polyamide oligomer. Thus, the melt complex viscosity as a function of shear rate, time, temperature, and heating rate can be tuned by selection of monomers and reactive and non-reactive end-cappers, and relative amounts thereof. For example, the melt complex viscosity can be greater than or equal to 2,000, 3,000, 4,000, or 5,000 Pa·s and less than or equal to 90,000, 70,000, 50,000, or 30,000 Pa·s. In some embodiments, the melt complex viscosity is about 5,000 to about 30,000 Pa·s at 360° C. In contrast, currently available PAI is reported to have a melt complex viscosity of 100,000 Pa·s at 2 radians/second.

Specific reactive polyamideimide oligomers are disclosed herein. For example, the reactive polyamideimide oligomer can comprise units derived from at least one anhydride selected from trimellitic anhydride and 4-chloroformylphthalic anhydride, at least one aromatic diamine selected from 1,3-diaminobenzene, 3,4′-oxydianiline, and 4,4′-oxydianiline, 4-methylethynylphthalic anhydride, and optionally 4-phenylethynylphthalic anhydride. The reactive polyamideimide oligomer can also comprise units derived from at least one dianhydride selected from pyromellitic dianhydride and 4,4′-oxydiphthalic anhydride, at least one difunctional aromatic compound selected from isophthalic acid and isophthaloyl chloride, at least one aromatic diamine selected from 1,3-diaminobenzene, 3,4′-oxydianiline, and 4,4′-oxydianiline, 4-methylethynylphthalic anhydride, and optionally 4-phenylethynylphthalic anhydride. The reactive polyamideimide oligomer can also comprise units derived from at least one dianhydride selected from pyromellitic dianhydride and 4,4′-oxydiphthalic anhydride, at least one difunctional aromatic compound selected from isophthalic acid and isophthaloyl chloride, at least one aromatic diamine selected from 1,3-diaminobenzene, 3,4′-oxydianiline, and 4,4′-oxydianiline, 4,4′-(ethyne-1,2-diyl)diphthalic anhydride, and at least one anhydride selected from phthalic anhydride, 4-methylethynylphthalic anhydride or 4-phenylethynylphthalic anhydride.

x-PAI Methods of Manufacturing

The reactive polyamideimide oligomer can be manufactured by a method comprising: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form a reactive polyamide amic acid; and heating the reactive polyamide amic acid oligomer at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer. Manufacture of exemplary reactive polyamideimide oligomers are provided in Scheme 2.

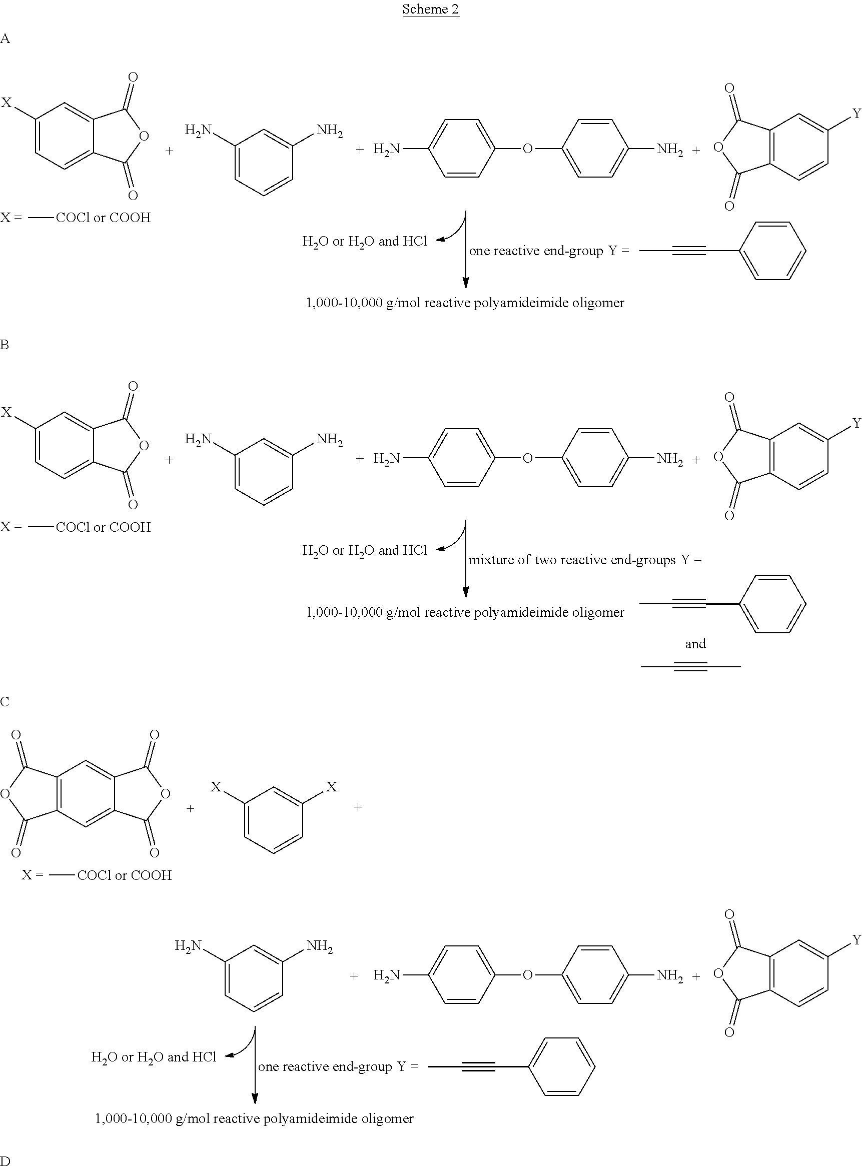

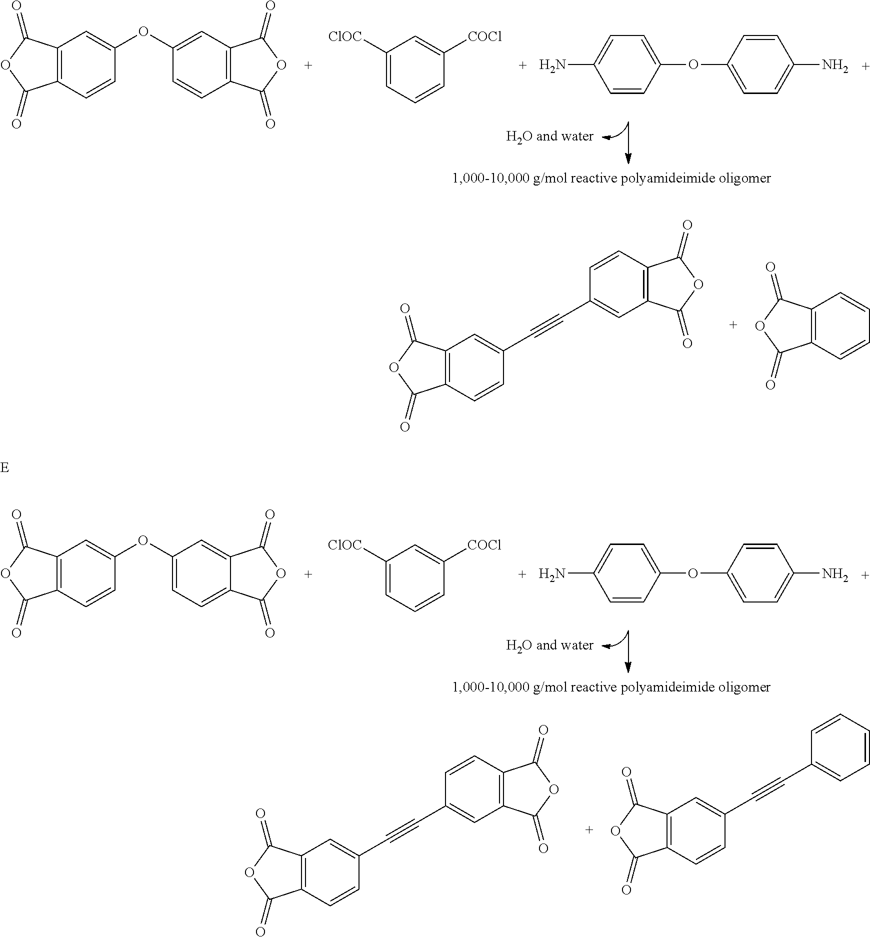

A—Synthesis of reactive polyamideimide oligomer with only one type of crosslinkable end-capper;
B—Synthesis of reactive polyamideimide oligomer with two different crosslinkable end-cappers;
C—Synthesis of reactive polyamideimide oligomer from a dianhydride (tetrafunctional) and a diacid/diacid chloride (difunctional) with only one type of crosslinkable end-capper;
D—Synthesis of reactive polyamideimide oligomer from a crosslinkable monomer and a non-crosslinkable end-capper; and
E—Synthesis of reactive polyamideimide oligomer from a crosslinkable monomer and a crosslinkable end-capper.

The sufficient temperature and time to make the reactive polyamideimide oligomer are about 140° C. to about 220° C. for about 1 minute to about 120 minutes. As discussed above, the reactive polyamideimide oligomer is manufactured via formation of a reactive polyamide amic acid oligomer intermediate. The temperature and time required to imidize the reactive polyamide amic acid oligomer intermediate in this method depends on whether polar solvent is present or not, the specific reactive polyamideimide oligomer being made, and the desired degree of imidization. When the imidization is done in the absence of solvent, i.e. with neat reactive polyamide amic acid oligomer in the solid state, the sufficient temperature and time to make the reactive polyamideimide oligomer are about 220° C. to about 300° C. for about 1 minute to about 120 minutes. When the imidization is done in the presence of a polar solvent, the sufficient temperature and time to make the reactive polyamideimide oligomer are about 140° C. to about 220° C. for about 1 minute to about 120 minutes.

The reactive polyamideimide oligomer is manufactured in the presence of a polar solvent, which lowers the temperature range sufficient to make the reactive oligomer. The polar solvent should have a boiling point of at least 150° C. at one atmosphere. The polar solvent can be at least one of N-methyl-2-pyrrolidone, N,N-dimethylacetamide, N,N-dimethylformamide, 1,2-dichlorobenzene, 1,2,4-trichlorobenzene, or sulfolane. In some embodiments, the polar solvent is N-methyl-2-pyrrolidone. The method of manufacture can further comprise removal of the polar solvent from the polyamide amic acid oligomer prior to heating the reactive polyamide amic acid oligomer at a sufficient temperature and time to make the reactive polyamideimide oligomer.

There are different methods for imidization of the reactive polyamide amic acid oligomer. The reactive polyamideimide oligomer can be made by adding toluene to the reactive polyamide amic acid oligomer and azeotropic distillation of toluene and water. The reactive polyamideimide oligomer can also be made by microwave irradiation of the reactive polyamide amic acid oligomer. The imidization agent can be acetic anhydride. Acidic by-products are generated by imidization, e.g. acetic acid when acetic anhydride is used. Therefore, bases, for example tertiary amines, can be used. The tertiary amine can be, for example, pyridine or triethylamine. Thus, in some embodiments, the reactive polyamideimide oligomer is made by heating the reactive polyamide amic acid oligomer in the presence of acetic anhydride and a catalytic amount of a tertiary amine.

Another method of manufacture of the reactive polyamideimide oligomer is copolymerization in the presence of a phosphorylation agent and a catalytic amount of a salt. In this method, the di-, tri-, or tetra-functional carboxylic acid or functional equivalent thereof, does not include an acid halide, such as an acid chloride. The advantage of this method is that costly acid chlorides are not necessary as starting materials. By way of example, copolymerization is conducted in the presence of triphenyl phosphite, a polar solvent such as NMP as solvent, and a catalytic amount of a salt such as LiCl or CaCl₂. Heating up to 120° C. for 1.5 to 2 h. under nitrogen results in formation of a reactive polyamide amic acid oligomer and partial imidization to the corresponding reactive polyamideimide oligomer. Further heating up to 150° C. with additional pyridine for up to 5 h under nitrogen provides full imidization.

The reactive polyamideimide oligomer can also be made by reactive extrusion. Thus, a method of manufacture of the reactive polyamideimide oligomer comprises reactive extrusion of at least one aromatic diamine or activated derivative thereof (e.g. diacetylated diamine), at least one aromatic di-, tri-, or tetra-functional carboxylic acid or functional equivalent thereof, and at least one crosslinkable monomer or crosslinkable end-capper at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

The reactive extrusion can be conducted in the presence of a polar solvent. The polar solvent can be at least one of N-methyl-2-pyrrolidone, N,N-dimethylacetamide, N,N-dimethylformamide, 1,2-dichlorobenzene, 1,2,4-trichlorobenzene, or sulfolane. In some embodiments, the polar solvent is N-methyl-2-pyrrolidone. The polar solvent can dissolve the monomers, or alternately, can partially dissolve the monomers and form a fluid suspension or slurry of monomers together with oligomers and intermediates formed during reactive extrusion.

The reactive extrusion can be conducted in the presence of an acid catalyst to facilitate imidization (cyclodehydration) of amic acid intermediates. When liquid under the reactive extrusion conditions, the acid catalyst can also partially dissolve the monomers and form a fluid suspension or slurry of monomers together with oligomers and intermediates formed during reactive extrusion. When the acid catalyst is a liquid, it can be removed by distillation through vent ports during the reactive extrusion. In some embodiments, the acid catalyst is acetic acid, and it is removed by distillation during the reactive extrusion. The reactive extrusion can also be conducted in the presence of acetic anhydride, wherein the acetic anhydride is removed by distillation during the reactive extrusion. In order to facilitate removal of any water, HCl, polar solvent, acid catalyst, and acetic anhydride present or generated, reactive extrusion can be conducted in a melt extruder having a plurality of pre-set heating zones equipped with vent ports or other means for removal of these volatiles.

The reactive polyamideimide oligomer can also be manufactured by the “ammonium carboxylate salt” method. The ammonium carboxylate salt method comprises: heating at least one aromatic diamine, at least one aromatic di-, tri-, or tetra-functional carboxylic acid or functional equivalent thereof, and at least one crosslinkable monomer or crosslinkable end-capper in the presence of at least one of water or a C₁₋₄ alcohol at a sufficient temperature and time to form at least one reactive ammonium carboxylate salt; removing excess water and C₁₋₄ alcohol; and heating the reactive ammonium carboxylate salt at a sufficient temperature and time to form the reactive polyamideimide oligomer; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer. The C₁₋₄ alcohol can be, for example, at least one of methanol, ethanol, 1-propanol, isopropanol, 1-butanol, isobutanol, sec-butanol, or tert-butanol. In some embodiments, the C₁₋₄ alcohol is at least one of methanol or ethanol. Manufacture of an exemplary reactive polyamideimide oligomer by the ammonium carboxylate salt method is described in Scheme 3 below.

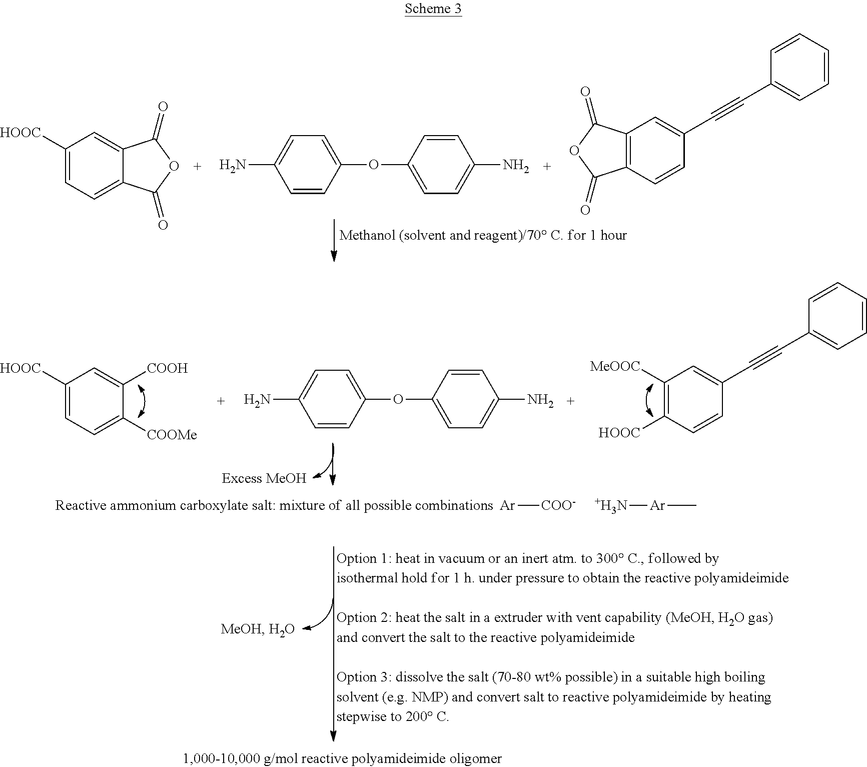

The anhydrides and diamines are heated in at least one of water or a C₁₋₄ alcohol, for example methanol or ethanol, at 70° C. for 1 h. This will ring-open the anhydrides and make the corresponding dicarboxylic acid alkyl half-esters, e.g. methyl or ethyl half-esters. The at least one of water or a C₁₋₄ alcohol is then removed by vacuum distillation. Thus, the reactive ammonium carboxylate salt is a mixture of all possible combinations of Ar—COO⁻ and ⁺H₃N—Ar in which Ar represents the aryl groups, and in which Ar—COO⁻ is a C₁₋₄ alkyl half-ester. The ammonium carboxylate salt (analogous to a Nylon salt) can be converted to the reactive polyamideimide oligomer by polymerization and imidization, which can be accomplished in various ways. Polymerization and imidization can be done by heating dry reactive ammonium carboxylate salt in an inert atmosphere, and preferably under pressure (0 to 300 MPa), up to 300° C. to obtain the reactive polyamideimide oligomer. (Option 1 in Scheme 3) The heating can be done in an sealed vessel (Option 1 in Scheme 3) and/or in an extruder with vent capability for removal of water and methanol or ethanol vapor. (Option 2 in Scheme 3) For example, the reactive ammonium carboxylate salt can be heated under an inert atmosphere stepwise at 60, 100, and 200° C. for 1 hr each in a sealed vessel, then cooled to 25° C., and then oligomerized in an extruder at 320 to 360° C. to obtain the reactive polyamideimide oligomer. Thus, in some embodiments, the method comprises reactive extrusion of the reactive ammonium carboxylate salt at a sufficient temperature and time to form the reactive polyamideimide oligomer. Polymerization and imidization can also be done by dissolving the reactive ammonium carboxylate salt in at least one polar solvent, such as water, N-methyl-2-pyrrolidone, N,N-dimethylacetamide, N,N-dimethylformamide, 1,2-dichlorobenzene, 1,2,4-trichlorobenzene, or sulfolane, followed by heating to 160° C. (Option 3 in Scheme 3) Thus, in some embodiments, the method comprises dissolving the reactive ammonium carboxylate salt in a polar solvent prior to heating at a sufficient temperature, pressure, and time to form the reactive polyamideimide oligomer.

Alternatively, the at least one aromatic diamine, at least one aromatic di-, tri-, or tetra-functional carboxylic acid or functional equivalent thereof, and at least one crosslinkable monomer or crosslinkable end-capper can be mixed with water, methanol, ethanol, mixture of methanol/water, or mixture of ethanol/water followed by heating in a pressure-resistant container (bomb calorimeter or autoclave) to 220° C. to polymerize and imidize the reactive ammonium carboxylate salt.

Advantageously, the reactive ammonium carboxylate salt has a melt complex viscosity that ranges between about 1 to about 100 Pa·s at a temperature range between about 80 to about 120° C., and solubility of in a polar solvent such as NMP is up to 70 to 80 wt % at 60° C. The low melt complex viscosity and high solubility of the reactive ammonium carboxylate salt allows for high throughput for manufacture of the reactive polyamideimide oligomer.

### Polyamide Amic Acids

As mentioned above, reactive polyamide amic acid oligomers are intermediates in the manufacture of reactive polyamideimide oligomers. Thus, a reactive polyamide amic acid oligomer comprises units derived from at least one aromatic diamine, at least one aromatic di-, tri-, or tetra-functional carboxylic acid or functional equivalent thereof, and at least one crosslinkable monomer or crosslinkable end-capper, wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer; and wherein the reactive polyamide amic acid oligomer has a number average molecular weight (M) of about 1,000 to about 10,000 g/mol, calculated using the Carothers equation. Reactive polyamideimide oligomers and reactive polyamide amic acid oligomers are closely related in that reactive polyamide amic acid oligomer is an intermediate in the formation of the corresponding reactive polyamideimide oligomer. They only differ in the degree of imidization. While reactive polyamideimide oligomer as herein defined can have greater than 20% and less than or equal to 100% of amic acid groups in the reactive polyamide amic acid intermediate imidized, 0% to about 20% of amic acid groups are imidized in the reactive polyamide amic acid oligomer as herein defined.

Compositional descriptions that apply to the reactive polyamideimide oligomers disclosed herein likewise apply to the reactive polyamide amic acid oligomers. Thus, the aromatic diamine can be at least one of 1,3-phenylene diamine, 4,4′-oxydianiline, or 3,4′-oxydianiline and the di-, tri-, or tetra-functional aromatic carboxylic acid or functional equivalent thereof can be at least one of trimellitic anhydride, 4-chloroformylphthalic anhydride, isophthalic anhydride, isophthaloyl chloride, pyromellitic dianhydride, or biphenyl tetracarboxylic acid dianhydride. The unreacted functional group that participates in subsequent chain extension, branching, and crosslinking reactions can be at least one of ethyne, methylethyne, phenylethyne, ketoethyne, propargyl ether, norbornene, maleimide, cyanate ester, phthalonitrile, benzocyclobutene, biphenylene, or benzoxazine. These unreacted functional groups are depicted in Table 1 with chemical formulas, chemical names, and curing temperature ranges. The at least one crosslinkable monomer or crosslinkable end-capper can be two crosslinkable monomers or crosslinkable end-cappers that are reactive at different temperature ranges. In some embodiments, the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

The reactive polyamide amic acid oligomer can further comprise units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof, but has no unreacted functional groups capable of chain extension and crosslinking after formation of the reactive polyamideimide oligomer. The non-crosslinkable end-capper can be at least one of benzoic acid, benzoyl chloride, phthalic anhydride, or aniline.

The reactive polyamide amic acid oligomer can be manufactured by a method comprising: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form the reactive polyamide amic acid; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer.

The reactive polyamide amic acid oligomer is manufactured in the presence of a polar solvent, which lowers the temperature range sufficient to make the reactive oligomer. The polar solvent should have a boiling point of at least 150° C. at one atmosphere. The polar solvent can be at least one of N-methyl-2-pyrrolidone, N,N-dimethylacetamide, N,N-dimethylformamide, 1,2-dichlorobenzene, 1,2,4-trichlorobenzene, or sulfolane. In some embodiments, the polar solvent is N-methyl-2-pyrrolidone. In some embodiments, the method further comprises isolating the reactive polyamide amic acid oligomer from the polar solvent.

### Other Backbone Structures

The reactive oligomer can have backbones derived from other polymers besides polyamideimide. In some embodiments, the reactive oligomer has a backbone derived from polyimide and is defined herein as a reactive polyimide oligomer. The reactive polyimide oligomer can have the Formula (I):

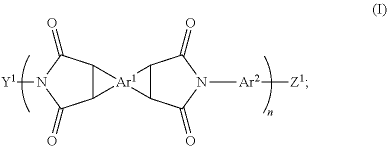

wherein the tetravalent aryl group represented by Ar¹ is at least one of:

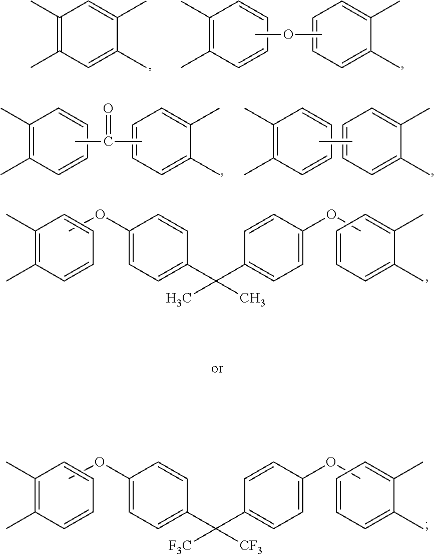

the divalent aryl group represented by Ar² is at least one of:

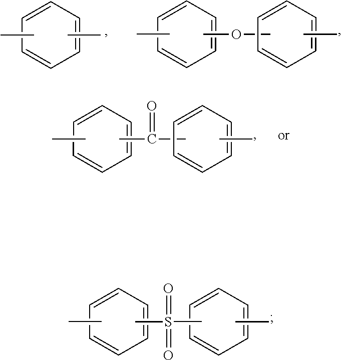

Y¹ and Z¹ are each independently derived from an end-capper selected from the group consisting of:

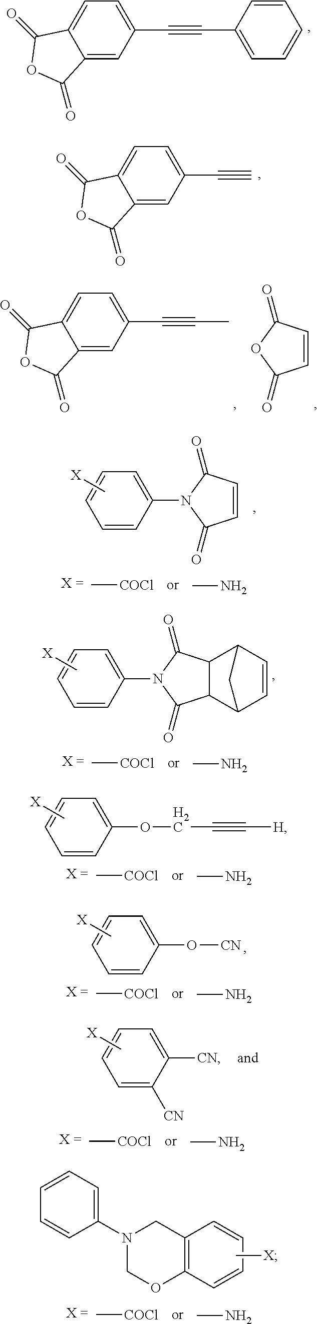

n is selected to provide a calculated Mₙ in the range of about 250 to about 10,000 g/mol, preferably about 1,000 to about 10,000 g/mol.

Molar ratios of monomers can be selected such that there is an excess of amine-functional end-groups or carboxylic acid anhydride-functional end-groups in the polyimide oligomer backbone, i.e. there can be amine-terminated or carboxylic acid anhydride-terminated polyimide oligomer backbones. When there is an excess of amine end-groups, acid chloride-functional end-cappers (X=—COCl) or anhydride end-cappers are selected. When there is an excess of anhydride end-groups, amine-functional end-cappers (X=—NH₂) are selected.

It can be desirable for the reactive polyimide oligomer to be curable in stages at different temperature ranges, i.e. to be partially cured at a first temperature range, and to be further cured at a second, higher, temperature range. Thus, in some embodiments, the reactive polyimide oligomer is functionalized with first and second unreacted functional groups capable of thermal chain extension and crosslinking after formation of the reactive oligomer, wherein the first unreacted functional group is self-reactive within a first temperature range, the second unreacted functional group is self-reactive within a second temperature range, and the second temperature range is higher than the first temperature range. Thus, the reactive polyimide oligomer of Formula (I) is curable in stages at different temperature ranges when Y¹ and Z¹ are different.

In some embodiments, at least one of Ar¹ or Ar² has an ether linkage between aryl groups, i.e. the reactive oligomer is a reactive polyetherimide oligomer. The unreacted functional group in the reactive polyetherimide oligomer can be at least one of methylethynyl, phenylethynyl, or maleimide. In particular, the unreacted functional group can be derived from at least one of 4-methylethynylphthalic anhydride, 4-phenylethynylphthalic anhydride, 4,4′-(ethyne-1,2-diyl)diphthalic dianhydride or N-(4-aminophenyl)maleimide.

Exemplary reactive polyetherimide oligomers are disclosed herein. For example, the reactive polyetherimide oligomer can comprise units derived from 4,4′-(4,4′-isopropylidenediphenoxy)bis(phthalic anhydride) (CAS 38103-06-9), 1,3-phenylene diamine, 4-methylethynylphthalic anhydride, and N-(4-aminophenyl)maleimide. The reactive polyetherimide oligomer can also comprise units derived from 2,3,3′,4′-biphenyl tetracarboxylic dianhydride, at least one aromatic diamine selected from 1,3-benzenediamine, 3,4′-oxydianiline, and 4,4′-oxydianiline, 4-methylethynylphthalic anhydride, and optionally 4-phenylethynylphthalic anhydride.

The reactive oligomer can also have a backbone derived from a polyaryletherketone, and is referred to herein as a reactive polyaryletherketone (PAEK) oligomer. For example, the reactive PAEK oligomer can be a reactive polyether ether ketone oligomer or a reactive polyether ketone oligomer. The reactive PAEK oligomer can have the Formula (II):

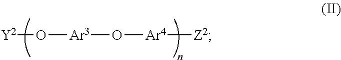

wherein the divalent aryl group represented by Ar³ is at least one of:

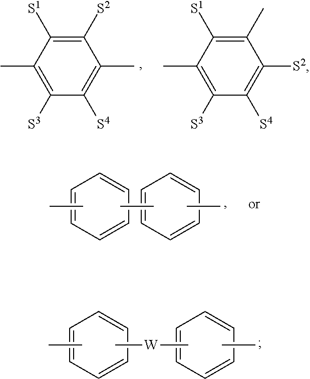

wherein S¹, S², S³, and S⁴ are each independently selected from the group consisting of H, F, Cl, Br, C₁₋₆ linear or branched alkyl, and phenyl; and

### W is:

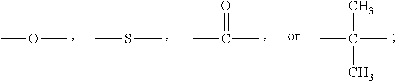

the divalent aryl group represented by Ar⁴ is at least one of:

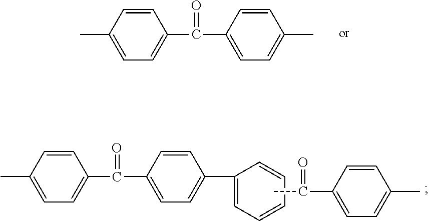

Y² and Z² are each independently derived from an end-capper selected from the group consisting of:

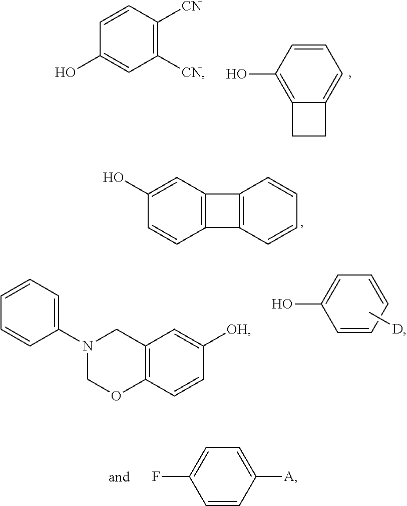

wherein D is:

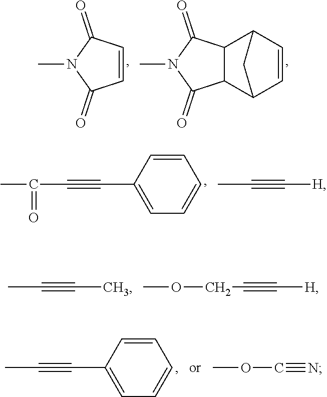

A is:

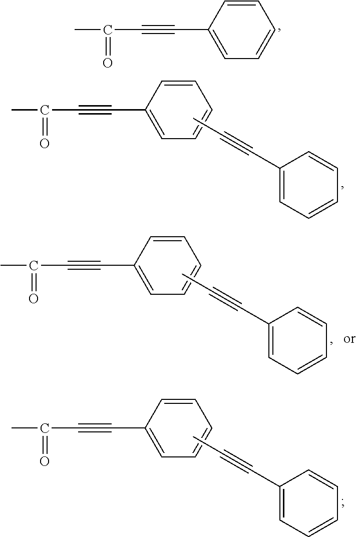

and
n is selected to provide a calculated Mₙ in the range of about 250 to about 10,000 g/mol, preferably about 1,000 to about 10,000 g/mol.

Molar ratios of monomers can be selected such that there is an excess of fluorine-functional end-groups or phenolic end-groups in the PAEK oligomer backbone, i.e. there can be fluorine-terminated or phenolic-terminated PAEK oligomer backbones. When there is an excess of fluorine-functional end-groups, phenol-functional end-cappers are selected. When there is an excess of phenolic end-groups, fluorine-functional end-cappers are selected. The unreacted functional group in the reactive PAEK oligomer can be at least one of methylethynyl, phenylethynyl, or maleimide.

It can be desirable for the reactive PAEK oligomer to be curable in stages at different temperature ranges, i.e. to be partially cured at a first temperature range, and to be further cured at a second, higher, temperature range. Thus, in some embodiments, the reactive PAEK oligomer is functionalized with first and second unreacted functional groups capable of thermal chain extension and crosslinking after formation of the reactive oligomer, wherein the first unreacted functional group is self-reactive within a first temperature range, the second unreacted functional group is self-reactive within a second temperature range, and the second temperature range is higher than the first temperature range. Thus, the reactive PAEK oligomer of Formula (II) is curable in stages at different temperature ranges when Y² and Z² are different.

The reactive oligomer can also have a backbone derived from a polyethersulfone, and is referred to herein as a reactive polyethersulfone oligomer. In some embodiments, the backbone is derived from a polysulfone (PSU), a polyphenylsulfone (PPSU), or a polyethersulfone (PES) and are referred to herein as reactive polysulfone oligomers, reactive polyphenylsulfone oligomers, or reactive polyethersulfone oligomers, respectively. The reactive polyethersulfone oligomer can have the Formula (III):

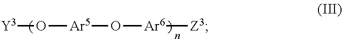

wherein the divalent aryl group represented by Ar⁵ is:

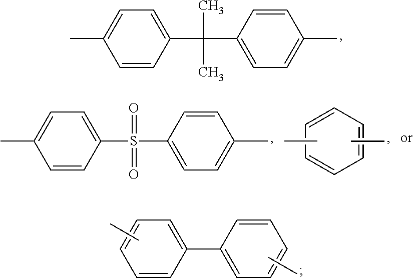

the divalent aryl group represented by Ar⁶ has the Formula (IIIa):

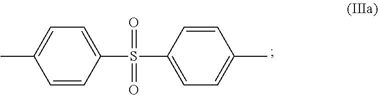

Y³ and Z³ are each independently derived from an end-capper selected from the group consisting of:

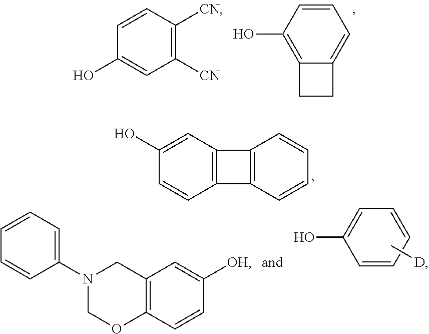

wherein D is:

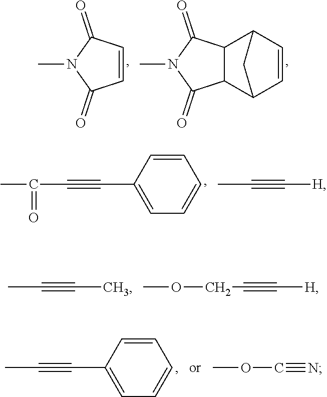

and
n is selected to provide a calculated Mₙ in the range of about 250 to about 10,000 g/mol, preferably about 1,000 to about 10,000 g/mol.

It can be desirable for the reactive polyethersulfone oligomer to be curable in stages at different temperature ranges, i.e. to be partially cured at a first temperature range, and to be further cured at a second, higher, temperature range. Thus, in some embodiments, the reactive polyethersulfone oligomer is functionalized with first and second unreacted functional groups capable of thermal chain extension and crosslinking after formation of the reactive oligomer, wherein the first unreacted functional group is self-reactive within a first temperature range, the second unreacted functional group is self-reactive within a second temperature range, and the second temperature range is higher than the first temperature range. Thus, the reactive polyethersulfone oligomer of Formula (III) is curable in stages at different temperature ranges when Y³ and Z³ are different.

Molar ratios of monomers can be selected such that there is an excess of fluorine-functional end-groups or phenolic end-groups in the polyethersulfone oligomer backbone, i.e. there can be fluorine-terminated or phenolic-terminated polyethersulfone oligomer backbones. When there is an excess of fluorine-functional end-groups, phenol-functional end-cappers are selected. When there is an excess of phenolic end-groups, fluorine-functional end-cappers are selected. The unreacted functional group in the reactive polyethersulfone oligomer can be at least one of methylethynyl, phenylethynyl, or maleimide.

The reactive oligomer can also have a backbone derived from a polyphenylene sulfide, and is referred to herein as a reactive polyphenylene sulfide oligomer. The reactive polyphenylene sulfide oligomer can have the Formula (IV):

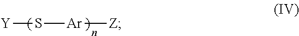

wherein the divalent aryl group represented by Ar is:

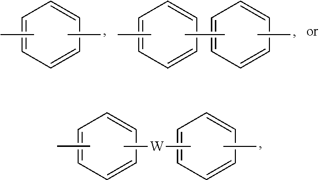

wherein W is:

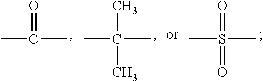

Y and Z are each independently derived from an end-capper selected from the group consisting of:

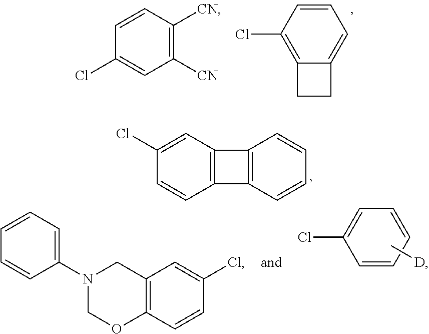

wherein D is:

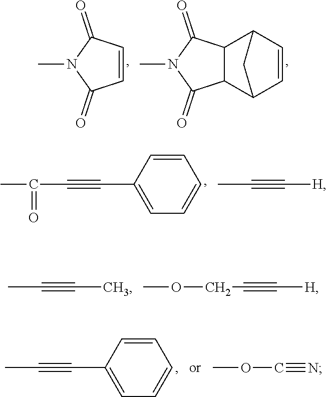

and
n is selected to provide a calculated Mₙ in the range of about 250 to about 10,000 g/mol, preferably about 1,000 to about 10,000 g/mol.

It can be desirable for the reactive polyphenylene sulfide oligomer to be curable in stages at different temperature ranges, i.e. to be partially cured at a first temperature range, and to be further cured at a second, higher, temperature range. Thus, in some embodiments, the reactive polyphenylene sulfide oligomer is functionalized with first and second unreacted functional groups capable of thermal chain extension and crosslinking after formation of the reactive oligomer, wherein the first unreacted functional group is self-reactive within a first temperature range, the second unreacted functional group is self-reactive within a second temperature range, and the second temperature range is higher than the first temperature range. Thus, the reactive polyphenylene sulfide oligomer of Formula (IV) is curable in stages at different temperature ranges when Y and Z are different.

Molar ratios of monomers can be selected such that there is an excess of fluorine-functional end-groups or phenolic end-groups in the polyphenylene sulfide oligomer backbone, i.e. there can be fluorine-terminated or phenolic-terminated poly oligomer backbones. When there is an excess of fluorine-functional end-groups, phenol-functional end-cappers are selected. When there is an excess of phenolic end-groups, fluorine-functional end-cappers are selected. The unreacted functional group in the reactive polyphenylene sulfide oligomer can be at least one of methylethynyl, phenylethynyl, or maleimide.

The reactive oligomer can also have a backbone derived from a polyamide, and is referred to herein as a reactive polyamide oligomer. The reactive polyamide oligomer can have the Formula (Va) or (Vb):

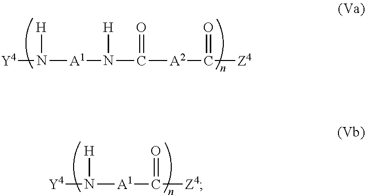

wherein the divalent groups represented by A and A are each independently a C₄-C₁₂ alkylene, cycloalkylene, alkylcycloalkylene, cycloalkylalkylene, or 1,2-, 1,3-, or 1,4-xylylene;
Y⁴ and Z⁴ are each independently derived from end-cappers selected from the group consisting of

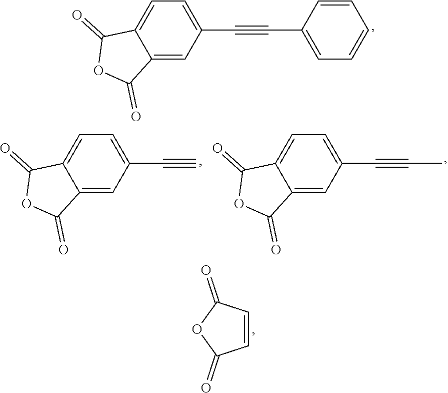

### n is N

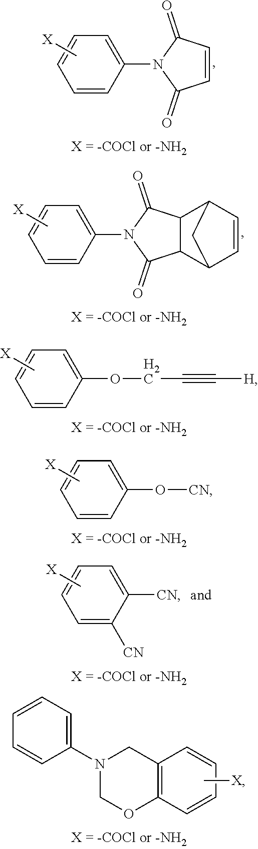

and selected to provide a calculated Mₙ in the range of about 250 to about 10,000 g/mol, preferably about 1,000 to about 10,000 g/mol.

Molar ratios of monomers can be selected such that there is an excess of amine-functional end-groups or carboxylic acid anhydride-functional end-groups in the polyamide oligomer backbone, i.e. there can be amine-terminated or carboxylic acid anhydride-terminated polyamide oligomer backbones. When there is an excess of amine end-groups, acid chloride-functional end-cappers (X=—COCl) or anhydride end-cappers are selected. When there is an excess of anhydride end-groups, amine-functional end-cappers (X=—NH₂) are selected.

It can be desirable for the reactive polyamide oligomer to be curable in stages at different temperature ranges, i.e. to be partially cured at a first temperature range, and to be further cured at a second, higher, temperature range. Thus, in some embodiments, the reactive polyamide oligomer is functionalized with first and second unreacted functional groups capable of thermal chain extension and crosslinking after formation of the reactive polyamide oligomer, wherein the first unreacted functional group is self-reactive within a first temperature range, the second unreacted functional group is self-reactive within a second temperature range, and the second temperature range is higher than the first temperature range. Thus, the reactive polyamide oligomer of Formula (Va) or (Vb) is curable in stages at different temperature ranges when Y⁴ and Z⁴ are different. The unreacted functional group in the reactive polyamide oligomer can be at least one of methylethynyl, phenylethynyl, or maleimide.

The reactive oligomer can also have a backbone derived from a polyester, and is referred to herein as a reactive polyester oligomer. The reactive polyester oligomer can have the Formula (VIa) or (VIb):

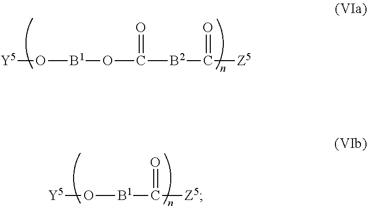

wherein the divalent groups represented by B¹ and B² are each independently a C₄-C₁₂ alkylene, cycloalkylene, alkylcycloalkylene, cycloalkylalkylene,

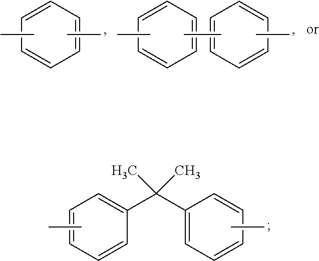

Y⁵ and Z⁵ are each independently derived from an end-capper selected from the group consisting of:

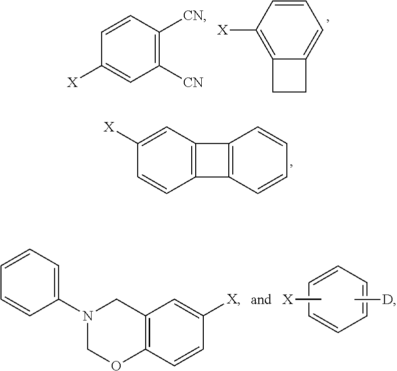

wherein D is:

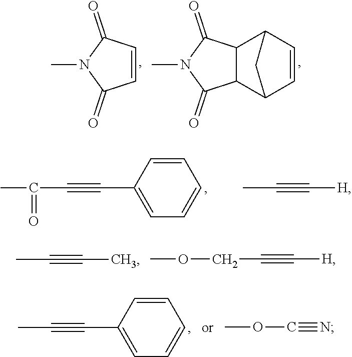

and X is —OH, —NH₂, —COOH, or —COCl; and n is selected to provide a calculated Mₙ in the range of about 250 to about 10,000 g/mol, preferably about 1,000 to about 10,000 g/mol.

Molar ratios of monomers can be selected such that there is an excess of either hydroxy-functional end-groups, or carboxylic acid or acid chloride functional end-groups, in the polyester oligomer backbone, i.e. there can be hydroxy-terminated, or carboxylic acid- or acid chloride-terminated polyester oligomer backbones. When there is an excess of hydroxy end-groups, carboxylic acid- (X=—COOH) or acid chloride- (X=—COCl) functional end-cappers are selected. When there is an excess of carboxylic acid end-groups, hydroxy-functional (X=—OH) or amine-functional end-cappers (X=—NH₂) are selected.

It can be desirable for the reactive polyester oligomer to be curable in stages at different temperature ranges, i.e. to be partially cured at a first temperature range, and to be further cured at a second, higher, temperature range. Thus, in some embodiments, the reactive polyester oligomer is functionalized with first and second unreacted functional groups capable of thermal chain extension and crosslinking after formation of the reactive polyester oligomer, wherein the first unreacted functional group is self-reactive within a first temperature range, the second unreacted functional group is self-reactive within a second temperature range, and the second temperature range is higher than the first temperature range. Thus, the reactive polyester oligomer of Formula (VIa) or (VIb) is curable in stages at different temperature ranges when Y⁵ and Z⁵ are different. The unreacted functional group in the reactive polyester oligomer can be at least one of methylethynyl, phenylethynyl, or maleimide.

The reactive oligomer can also have a backbone derived from a polyesteramide, and is referred to herein as a reactive polyesteramide oligomer. The reactive polyesteramide oligomer can have the Formula (VIIa) or (VIIb):

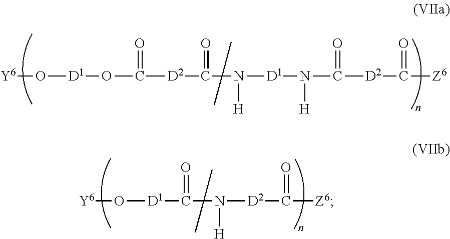

wherein the divalent groups represented by D¹ and D² are each independently a C₄-C₁₂ alkylene, cycloalkylene, alkylcycloalkylene, cycloalkylalkylene,

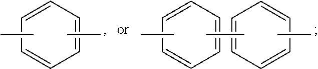

Y⁶ and Z⁶ are each independently derived from an end-capper selected from the group consisting of:

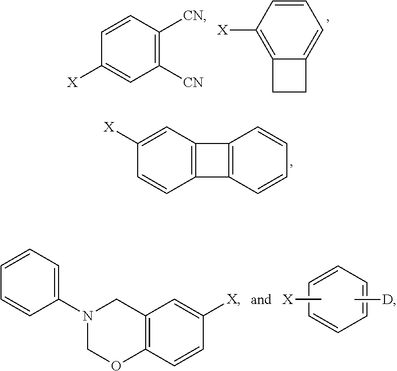

wherein D is:

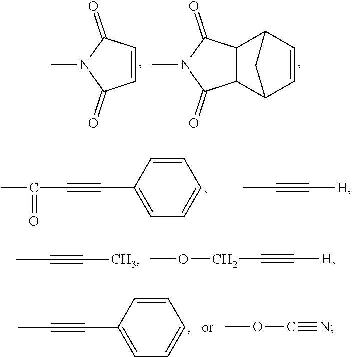

X is —OH, —NH₂, —COOH, or —COCl; and n is selected to provide a calculated Mₙ in the range of about 250 to about 10,000 g/mol, preferably about 1,000 to about 10,000 g/mol.

Molar ratios of monomers can be selected such that there is an excess of either hydroxy-functional end-groups, or carboxylic acid or acid chloride functional end-groups, in the polyesteramide oligomer backbone, i.e. there can be hydroxy-terminated, or carboxylic acid- or acid chloride-terminated polyesteramide oligomer backbones. When there is an excess of hydroxy end-groups, carboxylic acid- (X=—COOH) or acid chloride- (X=—COCl) functional end-cappers are selected. When there is an excess of carboxylic acid end-groups, hydroxy-functional (X=—OH) or amine-functional end-cappers (X=—NH₂) are selected.

It can be desirable for the reactive polyesteramide oligomer to be curable in stages at different temperature ranges, i.e. to be partially cured at a first temperature range, and to be further cured at a second, higher, temperature range. Thus, in some embodiments, the reactive polyesteramide oligomer is functionalized with first and second unreacted functional groups capable of thermal chain extension and crosslinking after formation of the reactive polyesteramide oligomer, wherein the first unreacted functional group is self-reactive within a first temperature range, the second unreacted functional group is self-reactive within a second temperature range, and the second temperature range is higher than the first temperature range. Thus, the reactive polyesteramide oligomer of Formula (VIIa) or (VIIb) is curable in stages at different temperature ranges when Y⁶ and Z⁶ are different. The unreacted functional group in the reactive polyesteramide oligomer can be at least one of methylethynyl, phenylethynyl, or maleimide.

### Compositions

Compositions comprising at least one reactive oligomer, including mixtures of reactive oligomers, are also disclosed. In some embodiments, the composition comprises first and second reactive aromatic oligomers, wherein the first reactive oligomer is functionalized with a first unreacted functional group capable of thermal chain extension and crosslinking after formation of the first reactive aromatic oligomer, the second reactive oligomer is functionalized with a second unreacted functional group capable of thermal chain extension and crosslinking after formation of the second reactive oligomer, the first unreacted functional group is self-reactive within a first temperature range, the second unreacted functional group is self-reactive within a second temperature range, and the second temperature range is higher than the first temperature range. The use of combinations of first and second reactive oligomers having different unreacted functional groups, for example in compositions for additive manufacturing, provides a way of controlling the overall thermal cure range of the compositions.

The composition can also comprise first and second reactive oligomers, wherein the first reactive oligomer has a first number average molecular weight (Mₙ), and the second the second reactive oligomer has a second number average molecular weight (Mₙ). For example, a composition can comprise a first reactive oligomer having a Mₙ of 3,000 g/mol and a second reactive oligomer having a Mₙ of 8,000 g/mol to obtain physical properties different than those of both the first and second reactive oligomers.

The composition can also comprise a reactive oligomer and a thermoplastic polymer. In some embodiments of a mixture of a reactive oligomer and a thermoplastic polymer, the thermoplastic polymer can comprise the same backbone repeat units as the at least one reactive oligomer. In these mixtures, for example, the reactive oligomer can be a reactive polyamideimide oligomer and the thermoplastic polymer can be a polyamideimide polymer having the same backbone repeat units, but a higher molecular weight. Thus, the reactive oligomers provide a useful way to modify the physical properties of thermoplastic polymers.

The composition can also comprise a reactive oligomer and an oligomer lacking unreacted functional groups capable of thermal chain extension. The oligomer lacking unreacted functional groups capable of thermal chain extension can also have a Mₙ of about 250 to 10,000 g/mol, preferably a Mₙ of about 1,000 to 10,000 g/mol.

The composition can also comprise at least one of a filler or additive. Examples of fillers include carbon black, ceramic powders, mica, talc, silica, silicates, metal powders (Al, Cu, Ni, Fe), and chopped fibers, such as carbon, glass, para-amid, meta-aramid, polybenzimidazole (PBI), polybenzoxazole (PBO), silicon carbide, boron, and alumina, graphene, graphene oxide, reduced graphene oxide, carbon nanotubes, and clay platelets.

It can be desirable to coat a layer of the reactive oligomer onto articles comprising a thermoplastic polymer, for example a thermoplastic polymer having the same backbone repeat units as the reactive oligomer. For example, the article can be a powder or filament for additive manufacturing comprising a thermoplastic polymer. Thus, in some embodiments, a composition comprises a reactive oligomer coating onto thermoplastic particles or filaments, optionally wherein the thermoplastic polymer has the same backbone repeat units as the.

### Compounding

It can be desirable to compound the reactive oligomer with other materials in order to improve thermomechanical properties. Thus, a method of compounding the reactive oligomer comprises mixing the reactive oligomer with at least one other component at a sufficient temperature and time to form a homogeneous molten mixture, but not crosslink the unreacted functional groups. The other component can be, for example, at least one of a second reactive oligomer, an oligomer lacking unreacted functional groups capable of thermal chain extension and crosslinking, a thermoplastic polymer, a thermoplastic polymer having the same backbone repeat units as the reactive oligomer, a filler, or an additive.

### Manufacturing Methods

The reactive oligomer and compositions comprising the reactive oligomer can be used to manufacture a variety of articles or parts with useful properties. Thus, a method of manufacture of an article, comprises heating the reactive oligomer at a sufficient temperature and time to shape and crosslink the reactive aromatic oligomer. The sufficient temperature and time to shape and crosslink the reactive oligomers depends upon the cure temperature ranges of the unreacted functional groups capable of thermal chain extension, branching, and crosslinking in the reactive oligomer. As can be seen from Table 1, the sufficient temperature is in the range of about 160 to about 450° C. It can be desirable to select a temperature such that the unreacted groups crosslink and the reactive oligomer is cured in about 1 to about 60 minutes. Thus, the sufficient temperature and time is about 160 to about 450° C. for about 1 to about 60 minutes. In some embodiments, the sufficient temperature and time is about 300 to about 450° C. for about 1 to about 60 minutes, and preferably about 350 to about 400° C. for about 30 to about 60 minutes, for example about 360° C. for about 45 minutes. Articles manufactured by this method are also disclosed.

The method of manufacture using the reactive oligomer and compositions thereof comprising the reactive oligomer can be additive manufacturing. Articles manufactured from the reactive oligomers and compositions thereof by additive manufacturing are also disclosed. The reactive oligomers and compositions thereof are suitable for several additive manufacturing methods, including fused filament fabrication (FFF), selective laser sintering (SLS), directed energy deposition (DED), laser engineered net shaping (LENS), and composite-based additive manufacturing (CBAM).

In some embodiments of additive manufacturing, the method is fused filament fabrication. Fused filament fabrication comprises extruding the reactive oligomer or composition thereof in adjacent horizontal layers such that there is an interface between each layer and exposing the layers to heat at a sufficient temperature and time to crosslink the reactive oligomer and form the article. In this method, the reactive oligomers migrate and covalently bond across the interfaces, thereby forming a monolithic article. Articles manufactured by fused filament fabrication are also disclosed. Articles manufactured from the reactive oligomer or composition by fused filament fabrication are also disclosed.

Fused filament fabrication uses material extrusion to print items, where a feedstock material is pushed through an extruder. In most fused filament fabrication 3D printing machines, the feedstock material comes in the form of a filament wound onto a spool. The 3D printer liquefier is the component predominantly used in this type of printing. Extruders for these printers have a hot end and a cold end. The “cold” end is cooler than the hot end, but can still be in the temperature range of 100 to 250° C. The cold end pulls material from the spool, using gear- or roller-based torque to the material and controlling the feed rate by means of a stepper motor. The cold end pushes feedstock into the hot end. The hot end consists of a heating chamber and a nozzle. The heating chamber hosts the liquefier, which melts the feedstock to transform it into a molten state. It allows the molten material to exit from the small nozzle to form a thin, tacky bead of plastic that will adhere to the material it is laid on. The nozzle will usually have a diameter of between 0.3 mm and 1.0 mm. Different types of nozzles and heating methods are used depending upon the material to be print.

The filament can be in the form of a thin filament wound onto a spool. In a variation of this method, the feedstock is in the form of a rod instead of a filament. Since the rod is thicker than the filament, it can be pushed towards the hot end by means of a piston or rollers, applying a greater force and/or velocity compared to conventional fused filament fabrication.

Weld lines are defined as the planar interface between adjacent layers of extruded material. The reactive polyamideimide oligomers diffuse across the interfaces and react to rapidly increase polymer chain entanglements and network formation across the interfaces, thereby fusing adjacent layers together. The weld lines (interfaces) are further strengthened by chain extension and/or crosslinking of the reactive aromatic oligomers entangled across the interfaces, resulting in improved z-axis strength.

In some embodiments of additive manufacturing, the method is selective laser sintering. Selective laser sintering comprises selectively sintering and crosslinking particles of the reactive aromatic oligomer or composition thereof with a laser to form the article. Similar to fused filament fabrication, the reactive aromatic oligomers migrate and covalently bond across particle interfaces, thereby forming a monolithic article. Articles manufactured by selective laser sintering are also disclosed. Selective laser sintering (SLS) involves the use of a high-power laser (e.g. a carbon dioxide laser) to fuse small particles of plastic, metal, ceramic, or glass powders into a mass that has a desired three-dimensional shape. The laser selectively fuses powdered material by scanning cross-sections generated from a 3D digital description of the part (e.g. from a CAD file or scan data) on the surface of a powder bed. After each cross-section is scanned, the powder bed is lowered by one-layer thickness, a new layer of material is applied on top, and the process is repeated until the part is completed. The SLS machine preheats the bulk powder material in the powder bed to a temperature below the flow point of the powder, to make it easier for the laser to raise the temperature of the selected regions to the point where the powder softens and fuses together. Articles manufactured from the reactive aromatic oligomers by selective laser sintering are also disclosed.

In contrast with some other additive manufacturing processes, such as stereolithography (SLA) and fused filament fabrication (FFF), which most often require special support structures to fabricate overhanging designs, SLS does not need a separate feeder for support material because the part being constructed is surrounded by unsintered powder at all times, this allows for the construction of previously impossible geometries. Also, since the machine's chamber is always filled with powder material the fabrication of multiple parts has a far lower impact on the overall difficulty and price of the design because through a technique known as “nesting”, multiple parts can be positioned to fit within the boundaries of the machine.

In additive manufacturing methods such as FFF and SLS using the reactive oligomers as the raw materials, the reactive oligomers rapidly diffuse across particle or filament interfaces, thereby increasing polymer chain entanglements and chain-chain interactions across the particle or filament interfaces, and fusing adjacent particles or filaments together. The interfaces are further strengthened by chain extension and crosslinking of the reactive oligomers entangled across the interfaces.

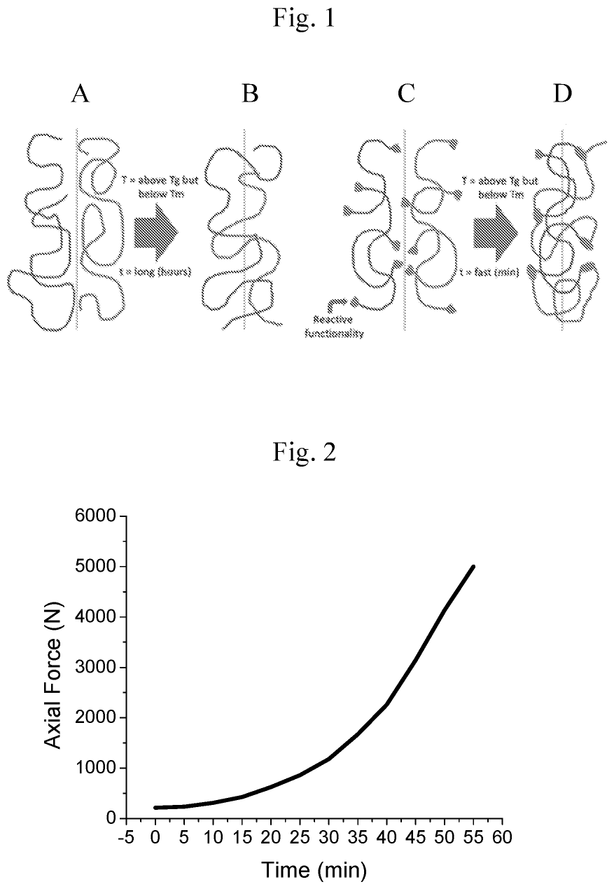

The concepts of diffusion across interfaces, and chain entanglement and crosslinking across interfaces are further illustrated by FIG. 1A to 1D. In each of FIGS. 1A and 1D, the oligomer or polymer on the left is in the solid state and the oligomer or polymer on the right is in the molten state. FIG. 1A depicts high molecular weight high performance thermoplastic on either side of an interface. The high molecular weight polymer can diffuse across the interface in both directions and form chain entanglements depicted in FIG. 1B. However long thermal annealing times (hours) at temperatures above T_{g} but below Tₘ are required.

FIG. 1C depicts reactive oligomer on either side of an interface. The low molecular weight reactive oligomer diffuses much faster across the interface in both directions above T_{g} but below Tₘ and form chain entanglements depicted in FIG. 1D. This rapid diffusion results in reduced thermal annealing times. Chain extension and crosslinking can also occur through the unreacted functional groups. The net effect of faster diffusion, chain entanglement, and chain extension and crosslinking is improved inter-layer strength, i.e. improved z-axis strength in FFF and in SLS.

The processes of chain entanglement, network formation, chain extension, and crosslinking across interfaces in additive manufacturing described above can be optimized by using reactive oligomers having two different reactive end groups in the same oligomer. A first unreacted functional group is self-reactive within a first temperature range, a second unreacted functional group is self-reactive within a second temperature range, and the second temperature range is higher than the first temperature range. For these reactive oligomers, a method of additive manufacturing comprises the steps of: curing the first unreacted functional groups within the first temperature range; and curing the second unreacted functional groups within the second temperature range. The first unreacted functional groups that are self-reactive over a first cure temperature range can crosslink first to fix the printed structure in place. The partially crosslinked oligomers still having second unreacted functional groups that are self-reactive over a second temperature range that is higher than the first temperature range can diffuse across the interfaces and cure at the second cure temperature range, thereby building molecular weight, crosslink density, and strength of the part. The interfaces can be between adjacent filaments, as in fused filament fabrication, or between adjacent particles, as in selective laser sintering. Articles manufactured from reactive oligomers having a first unreacted functional group that is self-reactive within a first temperature range and a second unreacted functional group that is self-reactive within a second temperature range by additive manufacturing are also disclosed.

The process of chain entanglement, network formation, chain extension, and crosslinking across interfaces in additive manufacturing can also be optimized by using two different reactive oligomers, each having a different reactive end group, wherein a first unreacted functional group is self-reactive within a first temperature range, a second unreacted functional group is self-reactive within a second temperature range, and the second temperature range is higher than the first temperature range. For these reactive oligomers, a method of additive manufacturing comprises the steps of: curing a first reactive oligomer functionalized with a first unreacted functional group within a first temperature range; and curing a second reactive oligomer functionalized with a second unreacted functional group within a second temperature range, wherein the second temperature range is higher than the second temperature range. Oligomer chains having first unreacted functional groups with a first cure temperature can crosslink first to fix the printed structure in place. Oligomer chains having second unreacted functional groups with a second cure temperature that is higher than the first cure temperature can diffuse across the interfaces and cure at the second cure temperature, thereby building molecular weight, crosslink density, and strength of the part. The interfaces can be between adjacent filaments, as in fused filament fabrication, or between adjacent particles, as in selective laser sintering. Articles manufactured from first reactive oligomers having a first unreacted functional group that is self-reactive within a first temperature range and second reactive aromatic oligomers having a second unreacted functional group that is self-reactive within a second temperature range by additive manufacturing are also disclosed.

The reactive polyamideimide oligomers and reactive polyamide amic acid oligomers, methods of manufacture using the reactive oligomers, and articles made from the reactive oligomers have several advantageous properties. Currently available high molecular weight PAI can have relatively high levels of amic acid groups in order to have sufficiently low complex viscosity to be melt processable. The presence of amic acid groups can make PAI extremely hygroscopic. Therefore, pre-processing drying is also required. The manufacturing and processing of currently available PAI configured as illustrated in FIG. 1, would involve imidization of polyamide amic acid stock shapes or injection molded parts, long periods of thermal post-treatment to remove water generated from conversion of amic acid groups to imide groups are necessary. PAI parts that have been machined are also exposed to a multi-day thermal treatment protocol after machining. A general cure schedule recommended by a manufacturer is: 1 day at 375° F. (191° C.), 1 day at 425° F. (218° C.), 1 day at 475° F. (246° C.), and 5 days at 500° F. (260° C.), for a total of 8 days. In contrast, curing for the reactive polyamideimide oligomers at about 300 to about 450° C. can be completed in as little as about 1 to about 60 minutes. Advantageously, this reduction in the thermal post-treatment time results in greatly reduced manufacturing cycle time and cost.

The reactive polyamideimide oligomers having a Mₙ of about 1,000 to about 10,000 g/mol advantageously exhibit a melt complex viscosity of about 1,000 to about 100,000 Pa·s at 360° C., specifically about 5,000 to about 30,000 Pa·s at 360° C. In contrast, currently available PAI is reported to have a melt complex viscosity of about 1,000,000 Pa·s at 2 radians/second. The low melt complex viscosity of the fully imidized reactive polyamideimide oligomer relative to currently available PAI is unexpected. In contrast to the low melt complex viscosity obtained, the combination of backbone phthalimide units, which are rigid, alternating with aromatic amide units, which are expected to be strongly hydrogen bonded as in polyaramid, is expected to result in a high melting point and high melt complex viscosity even for the reactive polyamideimide oligomers. Advantageously, with melt complex viscosity in the range of from about 1,000 to about 100,000 Pa·s at 360° C., melt processing can be done using conventional melt processing equipment, and ready-to-use injection molded parts, films, fibers and melt processable high temperature adhesives can be made. Also, compared to polyamide amic acid polymers, fully imidized reactive polyamideimide oligomers are less hygroscopic than polyamide amic acid polymers, and can be insoluble in polar solvents such as DMF, NMP, and DMAc, depending on the monomer and reactive and non-reactive end-capper used.

Advantageously, thermal cure temperature ranges and after-cure thermomechanical properties can be controlled by selection of backbone monomers, crosslinkable monomers, crosslinkable end-cappers, and non-crosslinkable end-cappers. Moreover, improved thermomechanical properties are obtained with the present reactive polyamideimide oligomers. Reference is made to Example 1C below, which is a reactive polyamideimide oligomer having a Mₙ of 5,000 g/mol in which both reactive end groups are phenylethyne. A film made from the reactive polyamideimide oligomer and cured for 1 h at 370° C. had a T_{g} of 326° C., which is about 46° C. higher than the T_{g} of a currently available PAI film. Reference is also made to Example 2 below, which is a reactive polyamideimide oligomer having a Mₙ of 5,000 g/mol and mixed reactive end groups (50/50 methylethyne/phenylethyne). A film made from the reactive polyamideimide oligomer and cured for 1 h at 370° C. had a T_{g} of 301° C. The film had a toughness of 94.3 MJ/m³. In contrast, currently available PAI has a toughness of only ˜10 MJ/m³. Therefore, the toughness of PAI films made from this reactive polyamideimide oligomer can be almost 10 times higher than PAI made from currently available PAL. T_{g}, strength at break, and elongation at break are also increased compared to currently available PAI.

Advantageously, the low melt complex viscosity of the reactive polyamideimide oligomers relative to high molecular weight polyamideimide polymers makes reactive polyamideimide oligomers ideally suited for preparing fiber reinforced composites such as glass, carbon, and aramid fiber reinforced composites. Solution-based pre-preg, melt impregnation, and melt pultrusion methods can all be used. High molecular weight polyamide amic acid could be used to prepare fiber/resin pre-pregs and composites. However, it would be difficult to obtain enough melt flow to melt consolidate polyamide amic acid pre-pregs into a composite panel. Also, it can be difficult to remove water from the composite panel during imidization of the polyamide amic acid. This means it would be difficult to achieve less than 2% voids, which is considered acceptable. Alternatively, high molecular weight polyamide amic acid can be converted to high molecular weight polyamideimide at the pre-preg stage, and the polyamideimide pre-pregs can be consolidated into a composite. The even higher melt complex viscosity of the high molecular weight polyamideimide can make it difficult to obtain sufficient melt flow under pressure to consolidate the pre-pregs into an acceptable quality composite panel. Therefore, the relatively low melt complex viscosity of reactive polyamideimide oligomers provides an advantage over both high molecular weight polyamideimide and high molecular weight polyamide amic acid in fabrication of fiber reinforced composites.

In contrast to high molecular weight polyamideimide polymers, the low melt complex viscosity of the reactive polyamideimide oligomers also makes them ideally suited for 3D printing applications. The reactive polyamideimide oligomers can be utilized in filament, rod, or powder form.

This disclosure is further illustrated by the following aspects of the disclosure, which are not intended to limit the claims.

### Embodiments Based on Current Claims

Aspect 1. A reactive oligomer comprising a backbone derived from at least one of polyamideimide, polyimide, polyetherimide, polyaryletherketone, polyethersulfone, polyphenylene sulfide, polyamide, polyester, polyarylate, polyesteramide, polycarbonate, polybenzoxazole or polybenzimidazole and functionalized with at least one unreacted functional group capable of thermal chain extension and crosslinking after formation of the reactive oligomer, wherein the reactive oligomer has a number average molecular weight (Mₙ) of about 250 to about 10,000 g/mol, calculated using the Carothers equation.

Aspect 2. The reactive oligomer of aspect 1, wherein the at least one unreacted functional group is at least one of maleimide, 5-norbornene-2,3-dicarboxylic imide, phthalonitrile, benzocyclobutene, biphenylene, cyanate ester, ketoethyne, ethyne, methylethyne, phenylethyne, propargyl ether or benzoxazine.

Aspect 3. The reactive oligomer of aspects 1 or 2, functionalized with first and second unreacted functional groups capable of thermal chain extension and crosslinking after formation of the reactive oligomer, wherein the first unreacted functional group is self-reactive within a first temperature range, the second unreacted functional group is self-reactive within a second temperature range, and the second temperature range is higher than the first temperature range.

Aspect 4. The reactive oligomer of any of aspects 1 to 3, wherein the backbone is linear or branched.

Aspect 5. The reactive oligomer of any of aspects 1 to 4, wherein the backbone is derived from a polyamideimide.

Aspect 6. The reactive oligomer of aspect 5, wherein the at least one unreacted functional group is derived from a monomer or end-capper selected from the group consisting of:

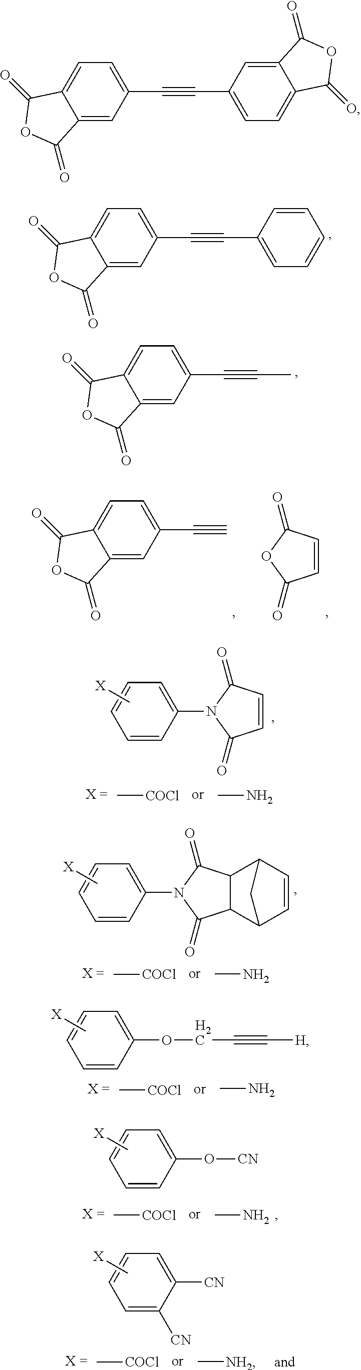

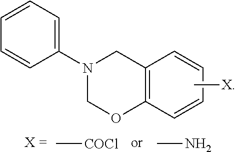

Aspect 7. The reactive oligomer of aspect 5, comprising units derived from at least one anhydride selected from trimellitic anhydride and 4-chloroformylphthalic anhydride, at least one aromatic diamine selected from 1,3-diaminobenzene, 3,4′-oxydianiline, and 4,4′-oxydianiline, 4-methylethynylphthalic anhydride, and optionally 4-phenylethynylphthalic anhydride.

Aspect 8. The reactive oligomer of aspect 5, comprising units derived from at least one dianhydride selected from pyromellitic dianhydride and 4,4′-oxydiphthalic anhydride, at least one difunctional aromatic compound selected from isophthalic acid and isophthaloyl chloride, at least one aromatic diamine selected from 1,3-diaminobenzene, 3,4′-oxydianiline, and 4,4′-oxydianiline, 4-methylethynylphthalic anhydride, and optionally 4-phenylethynylphthalic anhydride.

Aspect 9. The reactive oligomer of aspect 5, comprising units derived from at least one dianhydride selected from pyromellitic dianhydride and 4,4′-oxydiphthalic anhydride, at least one difunctional aromatic compound selected from isophthalic acid and isophthaloyl chloride, at least one aromatic diamine selected from 1,3-diaminobenzene, 3,4′-oxydianiline, and 4,4′-oxydianiline, 4,4′-(ethyne-1,2-diyl)diphthalic anhydride, and at least one anhydride selected from phthalic anhydride, 4-methylethynylphthalic anhydride, and 4-phenylethynylphthalic anhydride.

Aspect 10. The reactive oligomer of any of aspects 1 to 4, wherein the backbone is derived from a polyimide.

Aspect 11. The reactive oligomer of aspect 10, having the Formula (I):

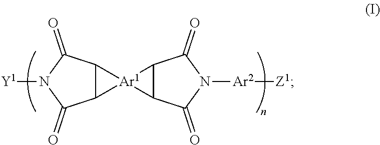

wherein the tetravalent aryl group represented by Ar¹ is at least one of:

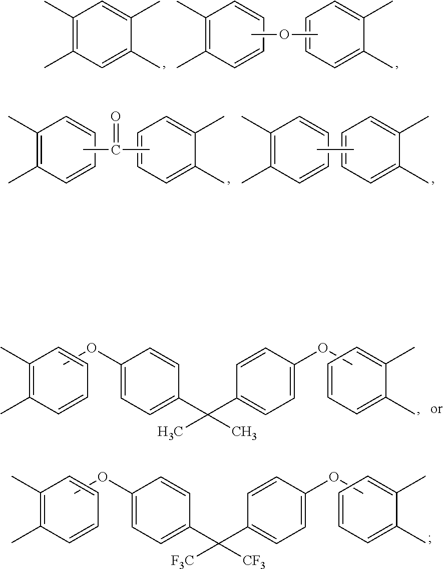

the divalent aryl group represented by Ar² is at least one of:

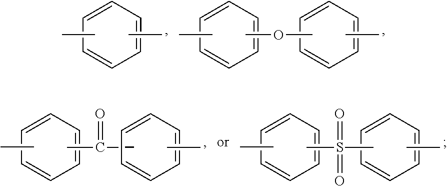

Y¹ and Z¹ are each independently derived from an end-capper selected from the group consisting of:

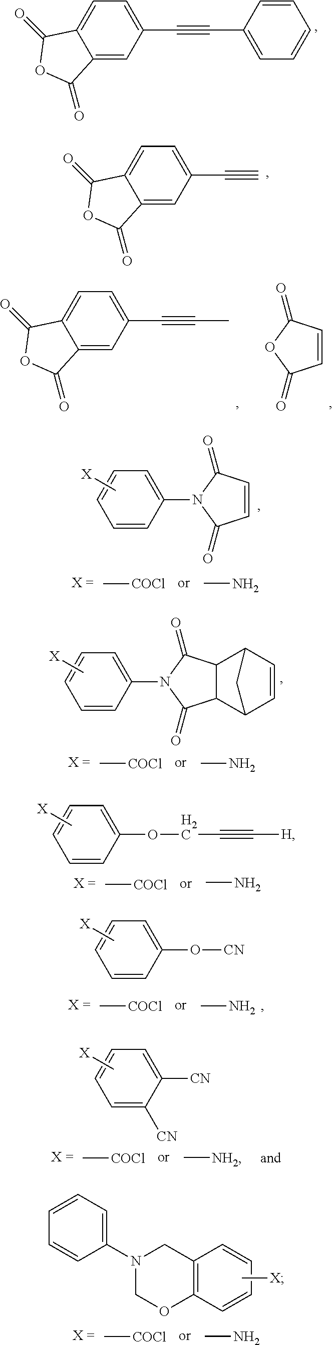

n is selected to provide a calculated Mₙ in the range of about 250 to about 10,000 g/mol.

Aspect 12. The reactive oligomer of aspect 11, wherein Y and Z are different.

Aspect 13. The reactive oligomer of any of aspects 10 to 12, wherein the polyimide is a polyetherimide.

Aspect 14. The reactive oligomer of aspect 13, wherein the unreacted functional group is at least one of methylethynyl, phenylethynyl or maleimide.

Aspect 15. The reactive oligomer of aspect 13, wherein the unreacted functional group is derived from at least one of 4-methylethynylphthalic anhydride, 4-phenylethynylphthalic anhydride, 4,4′-(ethyne-1,2-diyl)diphthalic dianhydride or N-(4-aminophenyl)maleimide.

Aspect 16. The reactive oligomer of aspect 13, comprising units derived from 4,4′-(4,4′-isopropylidenediphenoxy)bis(phthalic anhydride) (CAS 38103-06-9), 1,3-phenylene diamine, 4-methylethynylphthalic anhydride, and N-(4-aminophenyl)maleimide.

Aspect 17. The reactive oligomer of aspect 13, comprising units derived from 2,3,3′,4′-biphenyl tetracarboxylic dianhydride, at least one aromatic diamine selected from 1,3-benzenediamine, 3,4′-oxydianiline, and 4,4′-oxydianiline, 4-methylethynylphthalic anhydride, and optionally 4-phenylethynylphthalic anhydride.

Aspect 18. The reactive oligomer of any of aspects 1 to 4, wherein the backbone is derived from a polyaryletherketone.

Aspect 19. The reactive oligomer of aspect 18, having the Formula (II)

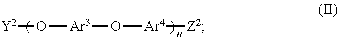

wherein the divalent aryl group represented by Ar³ is at least one of:

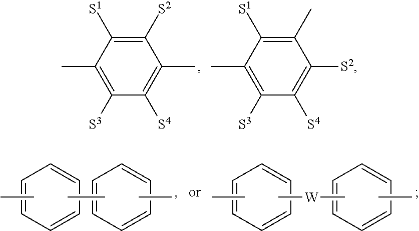

wherein S, S², S³, and S are each independently selected from the group consisting of H, F, Cl, Br, C₁₋₆ linear or branched alkyl, and phenyl; and W is:

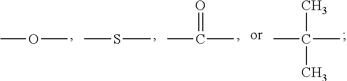

the divalent aryl group represented by Ar⁴ is at least one of:

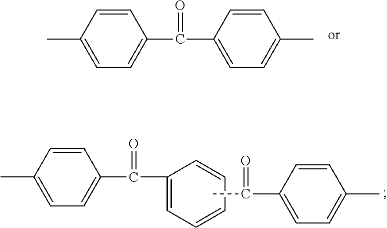

Y² and Z² are each independently derived from an end-capper selected from the group consisting of

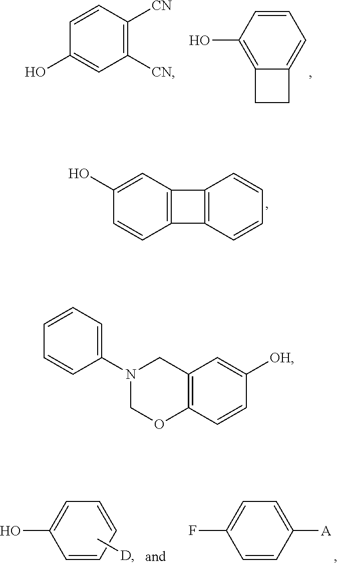

wherein D is:

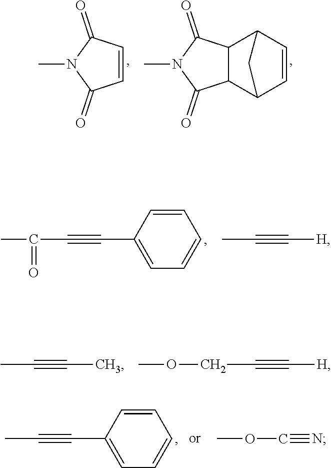

and

### A is:

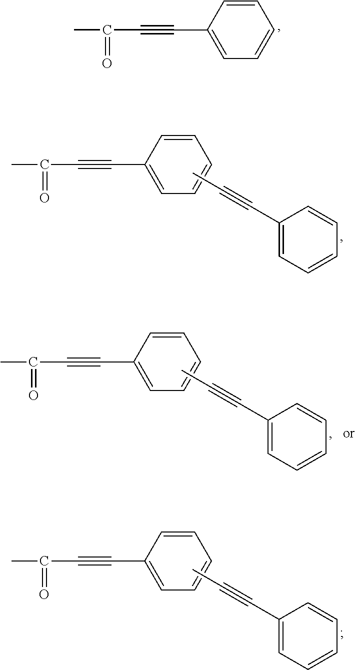

and
n is selected to provide a calculated Mₙ in the range of about 250 to about 10,000 g/mol.

Aspect 20. The reactive oligomer of aspect 19, wherein Y³ and Z³ are different.

Aspect 21. The reactive oligomer of aspect 19 or 20, wherein the unreacted functional group is at least one of methylethynyl, phenylethynyl or maleimide.

Aspect 22. The reactive oligomer of any of aspects 1 to 4, wherein the backbone is derived from a polyethersulfone.

Aspect 23. The reactive oligomer of aspect 22, wherein the backbone is derived from a polysulfone (PSU), polyphenylsulfone (PPSU), or polyethersulfone (PES).

Aspect 24. The reactive oligomer of aspect 22, having the Formula (III):

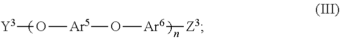

wherein the divalent aryl group represented by Ar⁵ is:

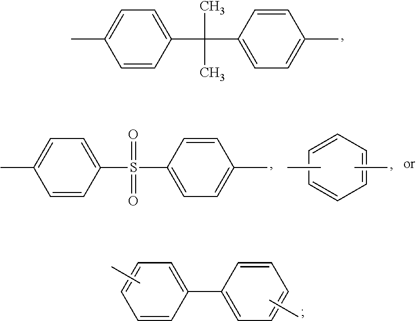

the divalent aryl group represented by Ar⁶ has the Formula (IIIa):

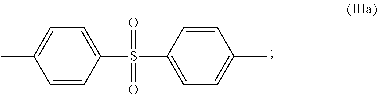

Y³ and Z³ are each independently derived from an end-capper selected from the group consisting of:

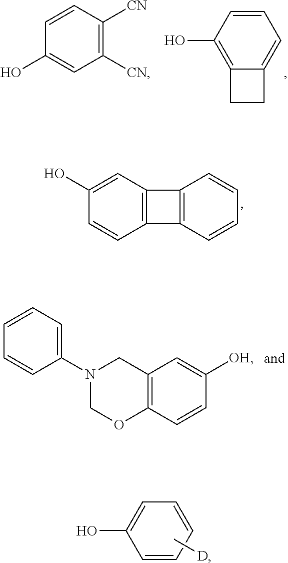

wherein D is:

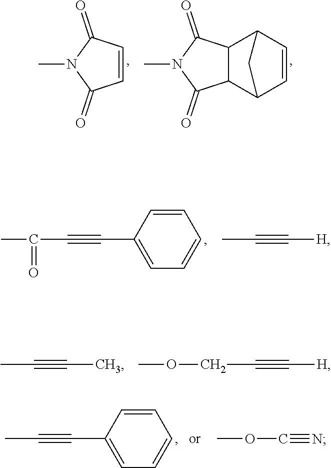

and
n is selected to provide a calculated Mₙ in the range of about 250 to about 10,000 g/mol.

Aspect 25. The reactive oligomer of aspect 24, wherein Y³ and Z³ are different.

Aspect 26. The reactive oligomer of aspect 22 or 23, wherein the unreacted functional group is at least one of methylethynyl, phenylethynyl or maleimide.

Aspect 27. The reactive oligomer of any of aspects 1 to 4, wherein the backbone is derived from a polyphenylene sulfide.

Aspect 28. The reactive oligomer of aspect 27, having the Formula (IV):

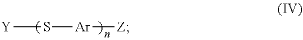

wherein the divalent aryl group represented by Ar is:

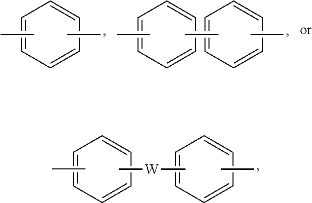

wherein W is:

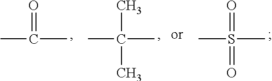

Y and Z are each independently derived from an end-capper selected from the group consisting of:

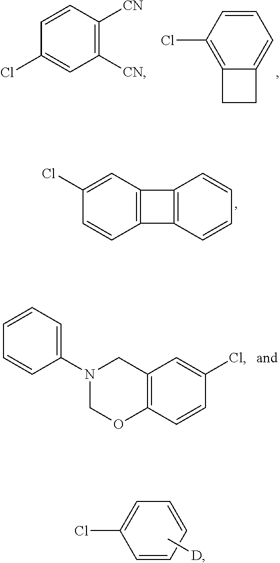

wherein D is:

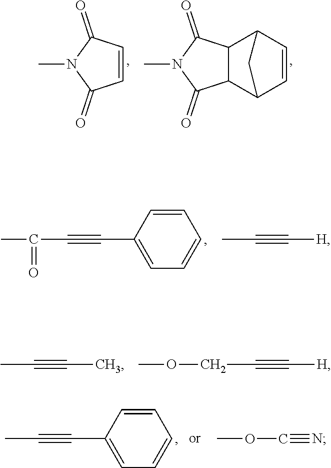

and
n is selected to provide a calculated Mₙ in the range of about 250 to about 10,000 g/mol.

Aspect 29. The reactive oligomer of aspect 28, wherein Y and Z are different.

Aspect 30. The reactive oligomer of aspect 27, wherein the unreacted functional group is at least one of methylethynyl, phenylethynyl or maleimide.

Aspect 31. The reactive oligomer of any of aspects 1 to 4, wherein the backbone is derived from a polyamide.

Aspect 32. The reactive oligomer of aspect 31, having the Formula (Va) or (Vb):

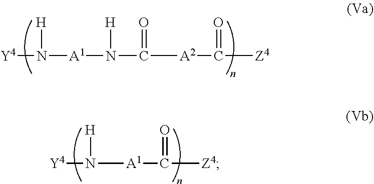

wherein the divalent groups represented by A¹ and A² are each independently a C₄-C₁₂ alkylene, cycloalkylene, alkylcycloalkylene, cycloalkylalkylene, or 1,2-, 1,3-, or 1,4-xylylene;
Y⁴ and Z⁴ are each independently derived from end-cappers selected from the group consisting of:

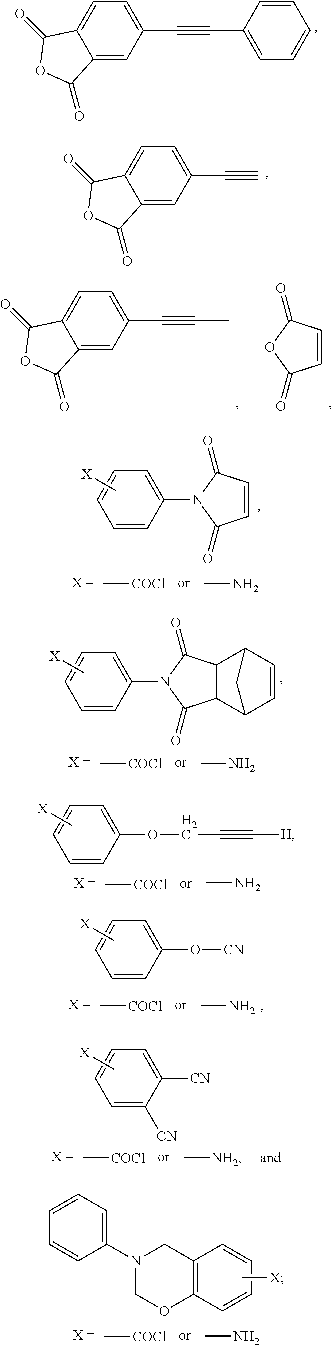

and
n is selected to provide a calculated Mₙ in the range of about 250 to about 10,000 g/mol.

Aspect 33. The reactive oligomer of aspect 32, wherein Y⁴ and Z⁴ are different.

Aspect 34. The reactive oligomer of aspect 31, wherein the unreacted functional group is at least one of methylethynyl, phenylethynyl or maleimide.

Aspect 35. The reactive oligomer of any of aspects 1 to 4, wherein the backbone is derived from a polyester.

Aspect 36. The reactive oligomer of aspect 35, having the Formula (VIa) or (VIb):

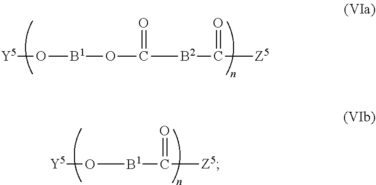

wherein the divalent groups represented by B¹ and B² are each independently a C₄-C₁₂ alkylene, cycloalkylene, alkylcycloalkylene, cycloalkylalkylene,

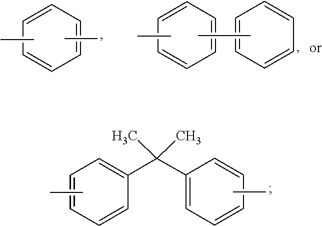

Y⁵ and Z⁵ are each independently derived from an end-capper selected from the group consisting of:

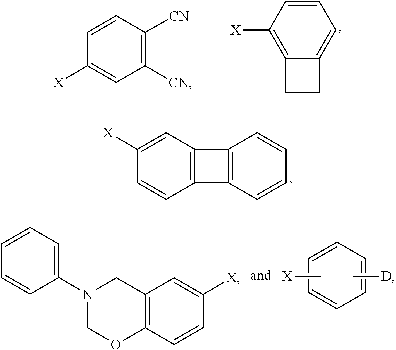

wherein D is:

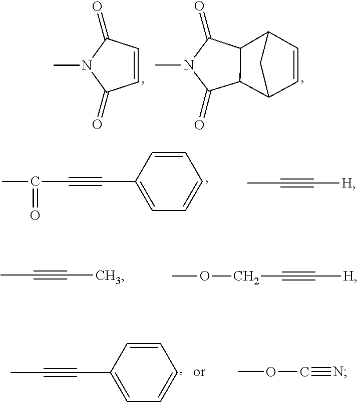

and

### X is —OH, —NH₂, —COOH, or —COCl; and

n is selected to provide a calculated Mₙ in the range of about 250 to about 10,000 g/mol.

Aspect 37. The reactive oligomer of aspect 36, wherein Y⁵ and Z⁵ are different.

Aspect 38. The reactive oligomer of aspect 35, wherein the unreacted functional group is at least one of methylethynyl, phenylethynyl or maleimide.

Aspect 39. The reactive oligomer of any of aspects 1 to 4, wherein the backbone is derived from a polyesteramide.

Aspect 40. The reactive oligomer of aspect 39, having the Formula (VIIa) or (VIIb):

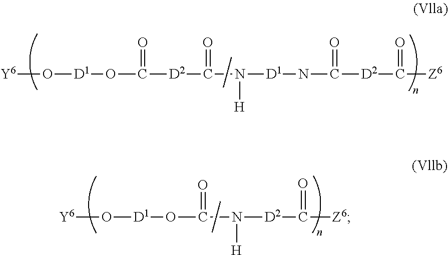

wherein the divalent groups represented by D¹ and D² are each independently a C₄-C₁₂ alkylene, cycloalkylene, alkylcycloalkylene, cycloalkylalkylene,

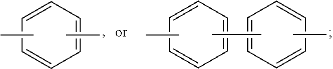

Y⁶ and Z⁶ are each independently derived from an end-capper selected from the group consisting of:

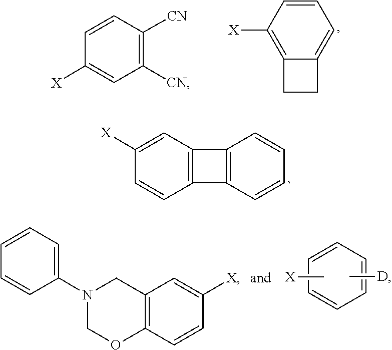

wherein D is:

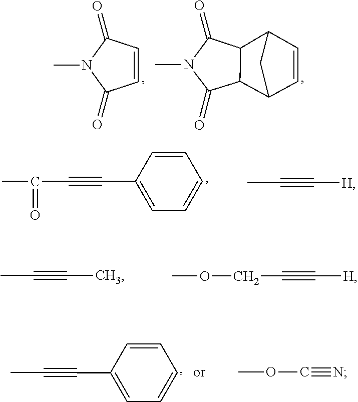

and

### X is —OH, —NH₂, —COOH, or —COCl; and

n is selected to provide a calculated Mₙ in the range of about 250 to about 10,000 g/mol.

Aspect 41. The reactive oligomer of aspect 40, wherein Y⁶ and Z⁶ are different.

Aspect 42. The reactive oligomer of aspect 40, wherein the unreacted functional group is at least one of methylethynyl, phenylethynyl or maleimide.

Aspect 43. A composition comprising at least one reactive oligomer of any of aspects 1 to 42.

Aspect 44. The composition of aspect 43, comprising first and second reactive oligomers, wherein the first reactive oligomer is functionalized with a first unreacted functional group capable of thermal chain extension and crosslinking after formation of the first reactive oligomer, the second reactive oligomer is functionalized with a second unreacted functional group capable of thermal chain extension and crosslinking after formation of the second reactive oligomer, the first unreacted functional group is self-reactive within a first temperature range, the second unreacted functional group is self-reactive within a second temperature range, and the second temperature range is higher than the first temperature range.

Aspect 45. The composition of aspect 43, comprising first and second reactive oligomers, wherein the first reactive oligomer has a first number average molecular weight (Mₙ), and the second the second reactive oligomer has a second number average molecular weight (Mₙ).

Aspect 46. The composition of any of aspects 43 to 45, further comprising a thermoplastic polymer.

Aspect 47. The composition of aspect 46, wherein the thermoplastic polymer comprises the same backbone repeat units as the at least one reactive oligomer.

Aspect 48. The composition of any of aspects 43 or 47, further comprising an oligomer lacking unreacted functional groups capable of thermal chain extension and crosslinking.

Aspect 49. The composition of any of aspects 43 to 48, further comprising at least one of a filler or additive.

Aspect 50. A composition comprising the reactive oligomer of any of aspects 1 to 42 coated onto thermoplastic polymer particles or filaments.

Aspect 51. The composition of aspect 50, wherein the thermoplastic polymer comprises the same backbone repeat units as the reactive oligomer.

Aspect 52. A method of compounding the composition of any of aspects 43 to 51, comprising mixing components of the composition at a sufficient temperature and time to form a homogeneous molten mixture, but not crosslink the unreacted functional groups.

Aspect 53. A method of manufacture of an article, the method comprising heating the composition of any of aspects 43 to 51 at a sufficient temperature and time to shape and crosslink the reactive oligomer.

Aspect 54. The method of manufacture of aspect 53, wherein the method is additive manufacturing.

Aspect 55. The method of additive manufacturing of aspect 54, wherein the method is fused filament fabrication (FFF), selective laser sintering (SLS), directed energy deposition (DED) laser engineered net shaping (LENS), or composite-based additive manufacturing (CBAM).

Aspect 56. A method of additive manufacturing using the reactive oligomer of aspect 3, comprising the steps of: curing the first unreacted functional group within the first temperature range; and curing the second unreacted functional group within the second temperature range.

Aspect 57. A method of additive manufacturing using the composition of aspect 44, comprising the steps of: curing the first reactive oligomer functionalized with the first unreacted functional group within the first temperature range; and curing the second reactive oligomer functionalized with the second unreacted functional group within the second temperature range.

Aspect 58. The method of manufacturing of aspect 54, wherein the method is fused filament fabrication, the method comprising extruding the composition in adjacent horizontal layers such that there is an interface between each layer, and exposing the layers to heat at a sufficient temperature and time to crosslink the reactive oligomer and form an article.

Aspect 59. The method of manufacture of aspect 54, wherein the method is selective laser sintering, the method comprising selectively sintering and crosslinking particles of the composition with a laser to form an article.

Aspect 60. An article manufactured by the method of any of aspects 53 to 58.

Aspect 101. A reactive polyamideimide oligomer comprising units derived from at least one aromatic diamine, at least one aromatic di-, tri-, or tetra-functional carboxylic acid or functional equivalent thereof, and at least one crosslinkable monomer or crosslinkable end-capper; wherein the crosslinkable monomer or crosslinkable end-capper is reactive with the at least one aromatic diamine or at least one di-, tri- or tetra-functional aromatic carboxylic acid or functional equivalent thereof and has at least one unreacted functional group capable of thermal chain extension and crosslinking after formation of the reactive polyamideimide oligomer; and wherein the reactive polyamideimide oligomer has a number average molecular weight (M) of about 1,000 to about 10,000 g/mol, calculated using the Carothers equation.

Aspect 102. The reactive polyamideimide oligomer of aspect 101, wherein the reactive polyamideimide oligomer is derived from a reactive polyamide amic acid oligomer intermediate by cyclodehydration, and greater than 80% and less than or equal to 100% of amic acid groups in the reactive polyamide amic acid intermediate are imidized.

Aspect 103. The reactive polyamideimide oligomer of aspect 101, wherein the reactive polyamideimide oligomer is derived from a reactive polyamide amic acid oligomer intermediate by cyclodehydration, and greater than or equal to 20% and less than or equal to 80% of amic acid groups in the reactive polyamide amic acid intermediate are imidized.

Aspect 104. The reactive polyamideimide oligomer of any of aspects 101 to 103, wherein the crosslinkable monomer or crosslinkable end-capper has one unreacted functional group capable of thermal chain extension and crosslinking after formation of the reactive polyamideimide oligomer.

Aspect 105. The reactive polyamideimide oligomer of any of aspects 101 to 104, wherein the at least one crosslinkable monomer or crosslinkable end-capper is at least one crosslinkable end-capper.

Aspect 106. The reactive polyamideimide oligomer of any of aspects 101 to 105, wherein the at least one aromatic diamine is two aromatic diamines.

Aspect 107. The reactive polyamideimide oligomer of any of aspects 101 to 106, wherein the at least one aromatic di-, tri-, or tetra-functional carboxylic acid or functional equivalent thereof is two aromatic di-, tri-, or tetra-functional carboxylic acids or functional equivalents thereof.

Aspect 108. The reactive polyamideimide oligomer of any of aspects 101 to 107, prepared by a process comprising simultaneous step-growth polymerization of the at least one aromatic diamine, the at least one aromatic di-, tri-, or tetra-functional carboxylic acid or functional equivalent thereof, and the at least one crosslinkable monomer or crosslinkable end-capper.

Aspect 109. The reactive polyamideimide oligomer of any of aspects 101 to 108, wherein the aromatic diamine is at least one of:

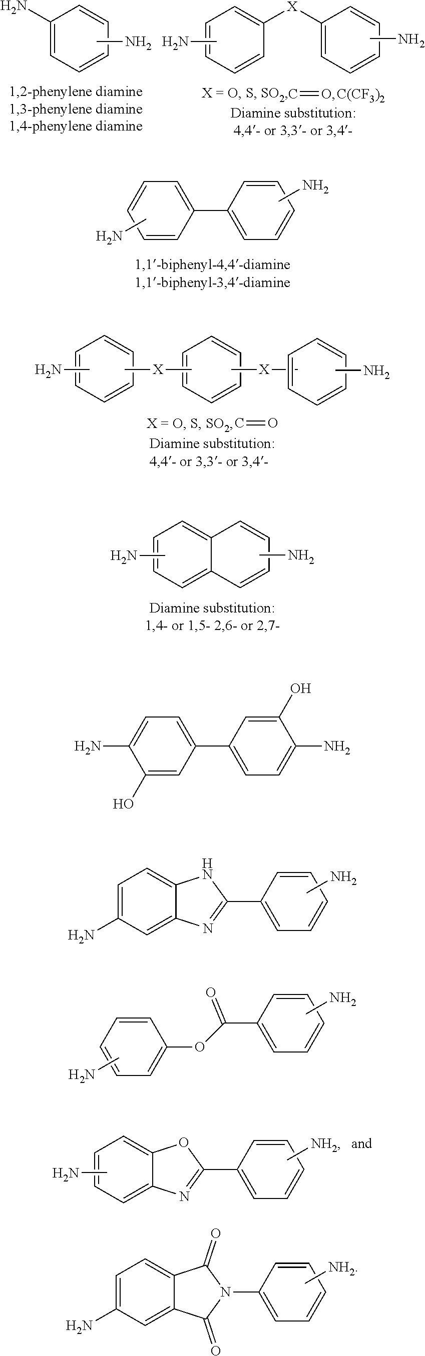

Aspect 110. The reactive polyamideimide oligomer of any of aspects 101 to 109, wherein the aromatic diamine is at least one of 1,3-phenylene diamine, 4,4′-oxydianiline, or 3,4′-oxydianiline.

Aspect 111. The reactive polyamideimide oligomer of any of aspects 101 to 110, wherein the di-, tri-, or tetra-functional aromatic carboxylic acid or functional equivalent thereof is at least one of:

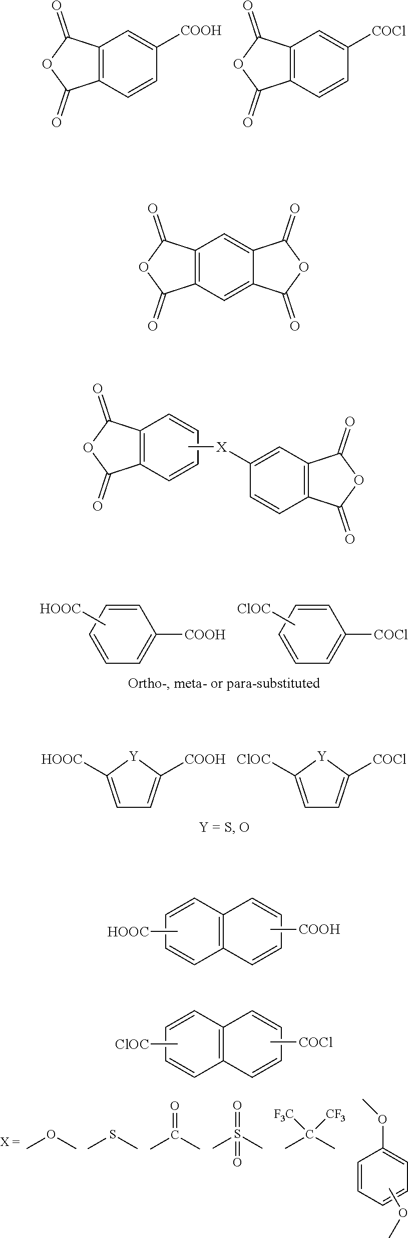

Aspect 112. The reactive polyamideimide oligomer of any of aspects 101 to 111, wherein the di-, tri-, or tetra-functional aromatic carboxylic acid or functional equivalent thereof is at least one of trimellitic anhydride, 4-chloroformylphthalic anhydride, isophthalic anhydride, isophthaloyl chloride, pyromellitic dianhydride, or biphenyl tetracarboxylic acid dianhydride.

Aspect 113. The reactive polyamideimide oligomer of any of aspects 101 to 112, wherein the unreacted functional group is at least one of ethyne, methylethyne, phenylethyne, ketoethyne, propargyl ether, norbornene, maleimide, cyanate ester, phthalonitrile, benzocyclobutene, biphenylene, or benzoxazine.

Aspect 114. The reactive polyamideimide oligomer of any of aspects 101 to 113, wherein the crosslinkable monomer or crosslinkable end-capper is at least one of:

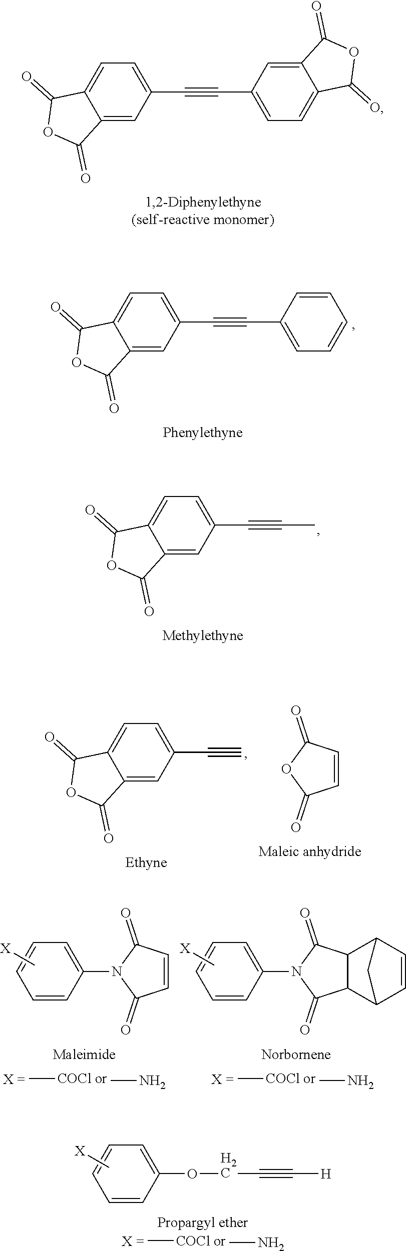

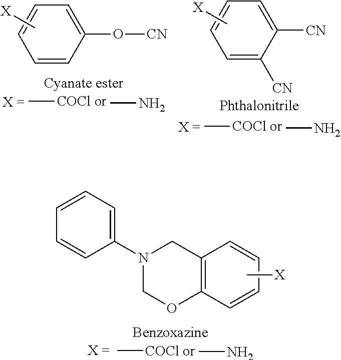

Aspect 115. The reactive polyamideimide oligomer of any of aspects 101 to 114, wherein the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 116. The reactive polyamideimide oligomer of any of aspects 101 to 115, comprising two crosslinkable monomers or crosslinkable end-cappers that are reactive at different temperature ranges.

Aspect 117. The reactive polyamideimide oligomer of any of aspects 101 to 116, further comprising units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof.

Aspect 118. The reactive polyamideimide oligomer of aspect 117, wherein the non-crosslinkable end-capper is at least one of benzoic acid, benzoyl chloride, phthalic anhydride, or aniline.

Aspect 119. The reactive polyamideimide oligomer of any of aspects 101 to 118, further comprising units derived from at least one of an aromatic triamine, an aromatic tricarboxylic acid, or an aromatic tricarboxylic acid chloride.

Aspect 120. The reactive polyamideimide oligomer of any of aspects 101 to 119, wherein the reactive polyamideimide oligomer has a melt complex viscosity of about 1,000 to about 100,000 Pa·s at 360° C., measured by oscillatory shear rheology between parallel plates at a heating rate of 10° C./minute under N₂, a frequency of 2 radians/second, and a strain of 0.03% to 1.0%.

Aspect 121. A reactive polyamideimide oligomer comprising units derived from:

an aromatic diamine selected from at least one of:

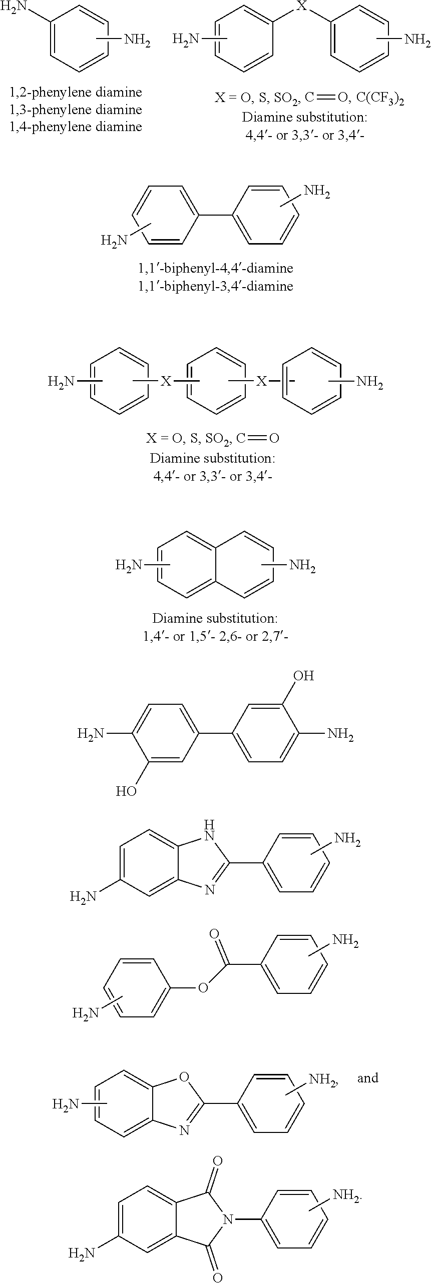

a di-, tri-, or tetra-functional aromatic carboxylic acid or functional equivalent thereof selected from at least one of:

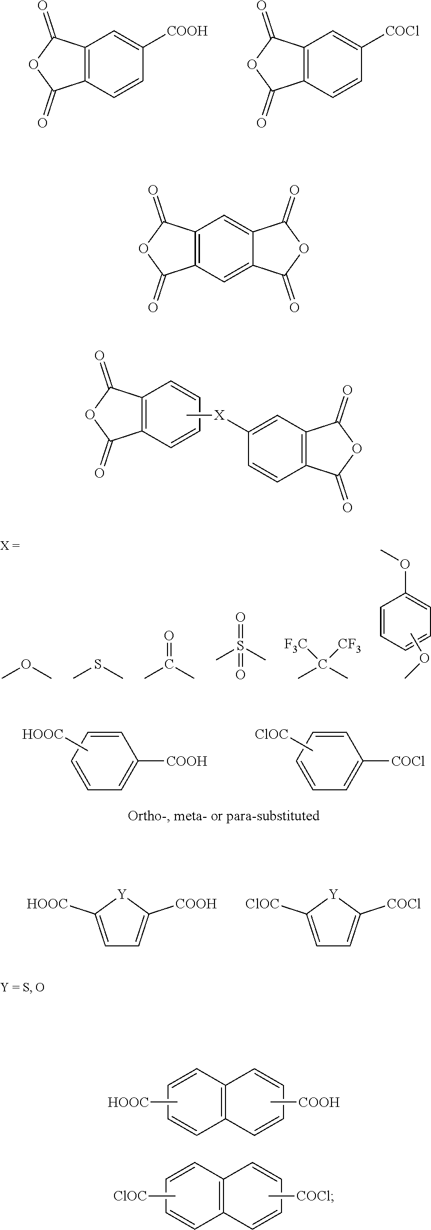

and
a crosslinkable monomer or crosslinkable end-capper selected from at least one of

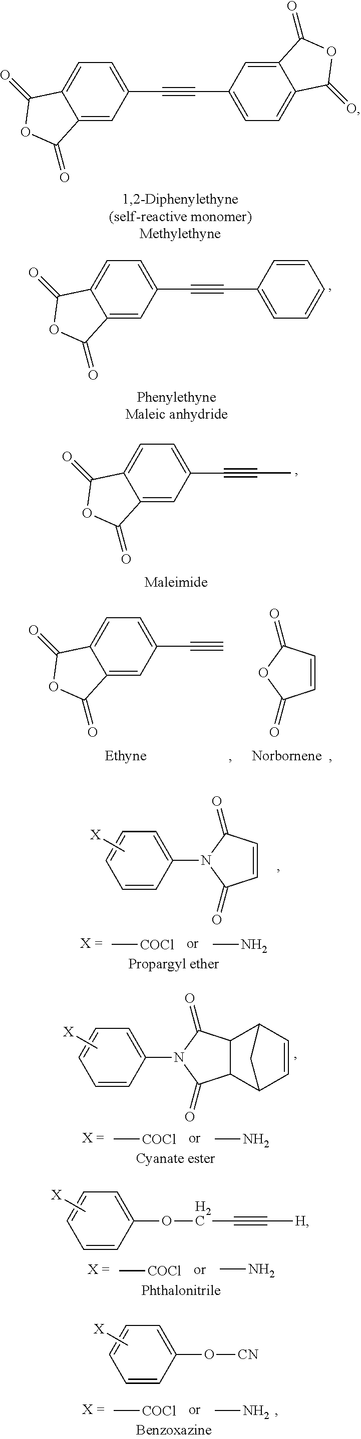

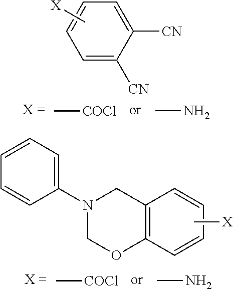

Aspect 122. A reactive polyamideimide oligomer comprising units derived from: an aromatic diamine selected from at least one of 1,3-phenylene diamine, 4,4′-oxydianiline, or 3,4′-oxydianiline; a di-, tri-, or tetra-functional aromatic carboxylic acid or functional equivalent thereof selected from at least one of trimellitic anhydride, 4-chloroformylphthalic anhydride, isophthalic anhydride, isophthaloyl chloride, pyromellitic dianhydride, or biphenyl tetracarboxylic acid dianhydride; and a crosslinkable monomer or crosslinkable end-capper selected from at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 123. A method of manufacture of the reactive polyamideimide oligomer of any of aspects 101 to 122, the method comprising: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form a reactive polyamide amic acid oligomer; and heating the reactive polyamide amic acid oligomer at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

Aspect 124. The method of manufacture of aspect 123, wherein the sufficient temperature and time to make the reactive polyamideimide oligomer are about 140° C. to about 220° C. for about 1 minute to about 120 minutes.

Aspect 125. The method of manufacture of aspect 123 or 124, wherein the polar solvent is at least one of N-methyl-2-pyrollidone, N,N-dimethylacetamide, N,N-dimethylformamide, 1,2-dichlorobenzene, 1,2,4-trichlorobenzene, or sulfolane.

Aspect 126. The method of manufacture of any of aspects 123 to 125, further comprising removing the polar solvent from the polyamide amic acid oligomer prior to heating the reactive polyamide amic acid oligomer at a sufficient temperature and time to make the reactive polyamideimide oligomer.

Aspect 127. The method of manufacture of aspect 126, wherein the sufficient temperature and time to make the reactive polyamideimide oligomer are about 220° C. to about 300° C. for about 1 minute to about 120 minutes.

Aspect 128. The method of manufacture of any of aspects 123 to 127, wherein the method further comprises adding toluene to the reactive polyamide amic acid oligomer and azeotropic distillation of toluene and water.

Aspect 129. The method of manufacture of any of aspects 123 to 127, wherein the method further comprises heating the reactive polyamide amic acid oligomer in the presence of acetic anhydride and a catalytic amount of a tertiary amine.

Aspect 130. The method of manufacture of any of aspects 123 to 127, wherein the method further comprises microwave irradiation of the reactive polyamide amic acid oligomer.

Aspect 131. The method of manufacture of any of aspects 123 to 127, wherein the copolymerizing is conducted in the presence of a phosphorylation agent and a catalytic amount of a salt.

Aspect 132. A method of manufacture of the reactive polyamideimide oligomer of any of aspects 1 to 16, the method comprising: heating at least one aromatic diamine, at least one aromatic di-, tri-, or tetra-functional carboxylic acid or functional equivalent thereof, and at least one crosslinkable monomer or crosslinkable end-capper in the presence of at least one of water or a C₁₋₄ alcohol at a sufficient temperature and time to form at least one reactive ammonium carboxylate salt; optionally removing excess water or C₁₋₄ alcohol; and heating the reactive ammonium carboxylate salt at a sufficient temperature and time to form the reactive polyamideimide oligomer; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

Aspect 133. The method of aspect 132, the method comprising reactive extrusion of the reactive ammonium carboxylate salt at a sufficient temperature and time to form the reactive polyamideimide oligomer.

Aspect 134. The method of aspect 26, the method comprising dissolving the reactive ammonium carboxylate salt in a polar solvent prior to heating at a sufficient temperature, pressure, and time to form the reactive polyamideimide oligomer.

Aspect 135. A method of manufacture of the reactive polyamideimide oligomer of any of aspects 101 to 122, the method comprising reactive extrusion of at least one aromatic diamine or activated derivative thereof, at least one aromatic di-, tri-, or tetra-functional carboxylic acid or functional equivalent thereof, and at least one crosslinkable monomer or crosslinkable end-capper at a sufficient temperature and time to make the reactive polyamideimide oligomer; wherein the crosslinkable monomer or crosslinkable end-capper is reactive with at least one aromatic diamine or the at least one di-, tri-, or tetra-functional aromatic carboxylic acid or functional equivalent thereof and has at least one unreacted functional group capable of chain extension and crosslinking after formation of the reactive polyamideimide oligomer.

Aspect 136. The method of manufacture of aspect 135, wherein the wherein the reactive extrusion is conducted in the presence of a polar solvent, and the polar solvent is removed by distillation during the reactive extrusion.

Aspect 137. The method of manufacture of aspect 135 or 136, wherein the reactive extrusion is conducted in the presence of an acid catalyst.

Aspect 138. The method of manufacture of aspect 137, wherein the acid catalyst is acetic acid, and the acetic acid is removed by distillation during the reactive extrusion.

Aspect 139. The method of manufacture of any of aspects 135 to 138, wherein the reactive extrusion is conducted in the presence of acetic anhydride, and the acetic anhydride is removed by distillation during the reactive extrusion.

Aspect 140. The method of manufacture of any of aspects 135 to 139, wherein the reactive extrusion is conducted in a melt extruder having a plurality of pre-set heating zones equipped with vent ports.

Aspect 141. A blend composition comprising the reactive polyamideimide oligomer of any of aspects 101 to 122 and a thermoplastic polymer.

Aspect 142. A method of compounding the reactive polyamideimide oligomer of any of aspects 101 to 122, comprising mixing the reactive polyamideimide oligomer with at least one other material at a sufficient temperature and time to melt, but not crosslink, the reactive polyamideimide oligomer.

Aspect 143. A method of manufacture of an article, the method comprising heating the reactive polyamideimide oligomer of any of aspects 101 to 122 at a sufficient temperature and time to shape and crosslink the reactive polyamideimide oligomer.

Aspect 144. The method of manufacture of aspect 143, wherein the sufficient temperature and time is about 160 to about 450° C. for about 1 to about 60 minutes.

Aspect 145. An article manufactured by the method of aspect 143 or 144.

Aspect 146. An article comprising the reactive polyamideimide oligomer of any of aspects 101 to 122.

Aspect 147. The article of aspect 146, wherein the reactive polyamideimide oligomer is crosslinked.

Aspect 148. The method of manufacture of aspect 143 or 144, wherein the method is additive manufacturing.

Aspect 149. The method of manufacture of aspect 148, wherein the method is fused filament fabrication, the method comprising extruding the reactive polyamideimide oligomer in adjacent horizontal layers such that there is an interface between each layer of polyamideimide oligomer, and exposing the layers to heat at a sufficient temperature and time to crosslink the reactive polyamideimide oligomer and form the article.

Aspect 150. The method of manufacture of aspect 148, wherein the method is selective laser sintering, the method comprising selectively sintering and crosslinking particles of the reactive polyamideimide oligomer with a laser to form the article.

Aspect 151. The method of manufacture of aspect 148, wherein the method is directed energy deposition (DED) or laser engineered net shaping (LENS).

Aspect 152. An article manufactured by the method of any of aspects 148 to 151.

Aspect 153. An additive manufactured article comprising the reactive polyamideimide oligomer of any of aspects 101 to 122.

Aspect 154. The additive manufactured article of aspect 153, wherein the reactive polyamideimide oligomer is crosslinked.

Aspect 155. A reactive polyamide amic acid oligomer comprising units derived from at least one aromatic diamine, at least one aromatic di-, tri-, or tetra-functional carboxylic acid or functional equivalent thereof, and at least one crosslinkable monomer or crosslinkable end-capper, wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer; and wherein the reactive polyamide amic acid oligomer has a number average molecular weight (M) of about 1,000 to about 10,000 g/mol, calculated using the Carothers equation.

Aspect 156. The reactive polyamide amic acid oligomer of aspect 155, wherein 0% to about 20% of amic acid groups are imidized.

Aspect 157. The reactive polyamide amic acid oligomer of aspect 155 or 156, wherein the crosslinkable monomer or crosslinkable end-capper has one unreacted functional group capable of thermal chain extension and crosslinking after formation of the reactive polyamideimide oligomer.

Aspect 158. The reactive polyamide amic acid oligomer of any of aspects 155 to 157, wherein the at least one crosslinkable monomer or crosslinkable end-capper is at least one crosslinkable end-capper.

Aspect 159. The reactive polyamide amic acid oligomer of any of aspects 155 to 158, wherein the at least one aromatic diamine is two aromatic diamines.

Aspect 160. The reactive polyamide amic acid oligomer of any of aspects 155 to 159, wherein the at least one aromatic di-, tri-, or tetra-functional carboxylic acid or functional equivalent thereof is two aromatic di-, tri-, or tetra-functional carboxylic acids or functional equivalents thereof.

Aspect 161. The reactive polyamide amic acid oligomer of any of aspects 155 to 160, prepared by a process comprising simultaneous step-growth polymerization of the at least one aromatic diamine, the at least one aromatic di-, tri-, or tetra-functional carboxylic acid or functional equivalent thereof, and the at least one crosslinkable monomer or crosslinkable end-capper.

Aspect 162. The reactive polyamide amic acid oligomer of any of aspects 155 to 161, wherein the aromatic diamine is at least one of:

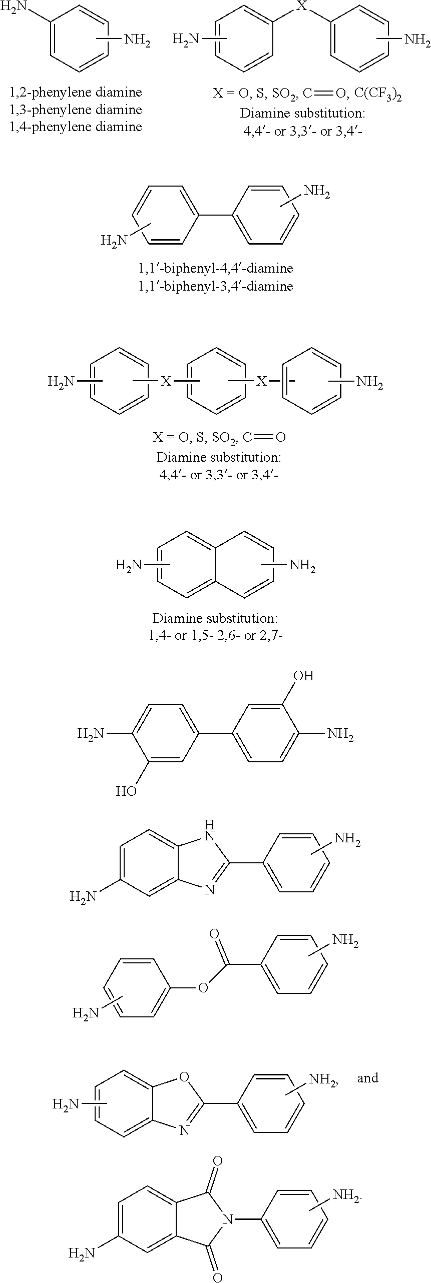

Aspect 163. The reactive polyamide amic acid oligomer of any of aspects 155 to 162, wherein the aromatic diamine is at least one of 1,3-phenylene diamine, 4,4′-oxydianiline, or 3,4′-oxydianiline.

Aspect 164. The reactive polyamide amic acid oligomer of any of aspects 155 to 163, wherein the di-, tri-, or tetra-functional aromatic carboxylic acid or functional equivalent thereof is at least one of.

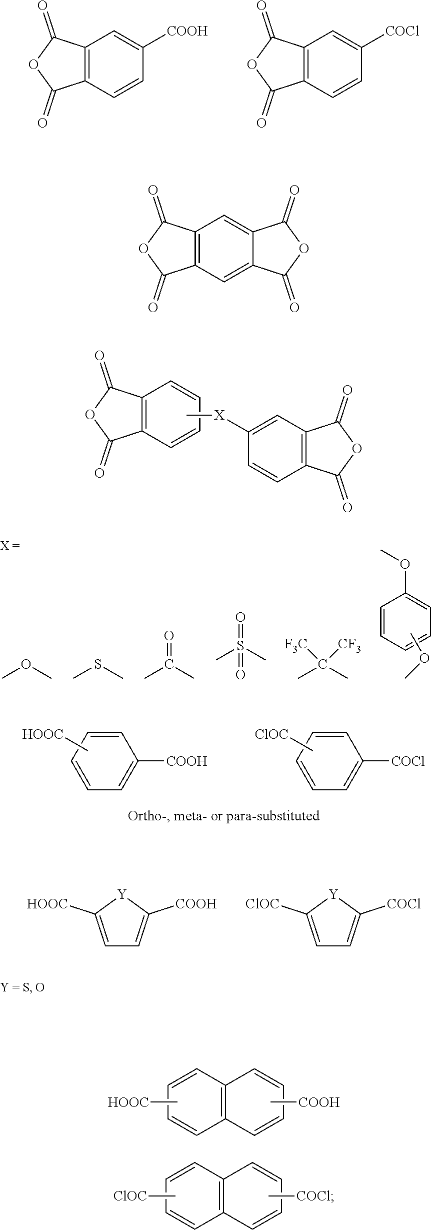

Aspect 165. The reactive polyamide amic acid oligomer of any of aspects 155 to 62a, wherein the di-, tri-, or tetra-functional aromatic carboxylic acid or functional equivalent thereof is at least one of trimellitic anhydride, 4-chloroformylphthalic anhydride, isophthalic anhydride, isophthaloyl chloride, pyromellitic dianhydride, or biphenyl tetracarboxylic acid dianhydride.

Aspect 166. The reactive polyamide amic acid oligomer of any of aspects 155 to 165, wherein the at least one unreacted functional group is at least one of ethyne, methylethyne, phenylethyne, ketoethyne, propargyl ether, norbornene, maleimide, cyanate ester, phthalonitrile, benzocyclobutene, biphenylene, or benzoxazine.

Aspect 167. The reactive polyamide amic acid oligomer of any of aspects 155 to 166, wherein the crosslinkable monomer or crosslinkable end-capper is at least one of:

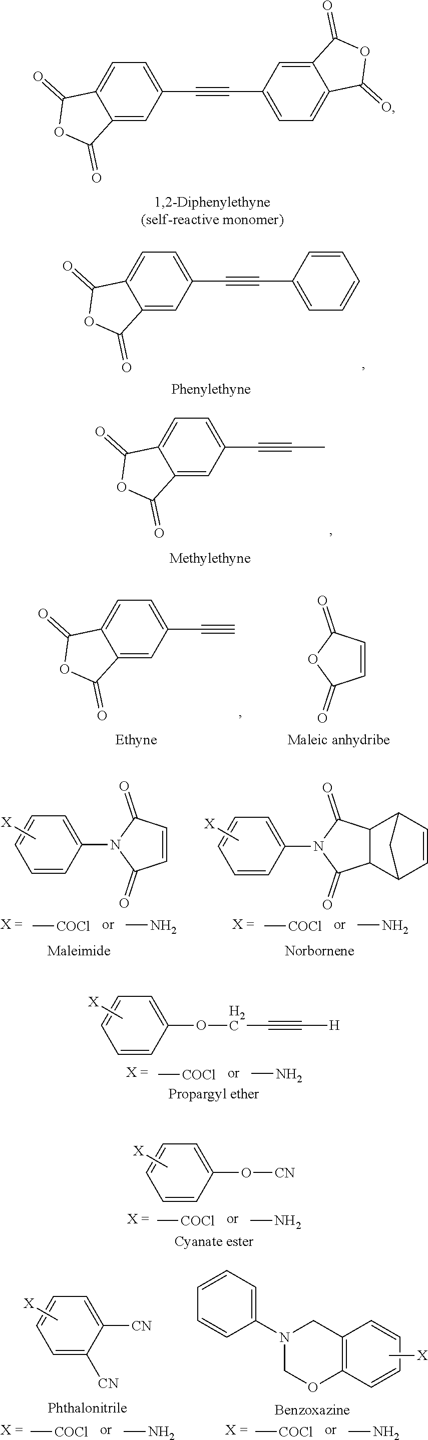

Aspect 168. The reactive polyamide amic acid oligomer of any of aspects 155 to 167, wherein the crosslinkable monomer or crosslinkable end-capper is at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 169. The reactive polyamide amic acid oligomer of any of aspects 155 to 168, comprising two crosslinkable monomers or crosslinkable end-cappers that are reactive at different temperature ranges.

Aspect 170. The reactive polyamide amic acid oligomer of any of aspects 155 to 169, further comprising units derived from at least one non-crosslinkable end-capper, wherein the non-crosslinkable end-capper is reactive with the at least one aromatic diamine or at least one di-, tri-, or tetra-functional aromatic carboxylic acid or functional equivalent thereof.

Aspect 171. The reactive polyamide amic acid oligomer of aspect 170, wherein the non-crosslinkable end-capper is at least one of benzoic acid, benzoyl chloride, phthalic anhydride, or aniline.

Aspect 172. A reactive polyamide amic acid oligomer comprising units derived from:

an aromatic diamine selected from at least one of.

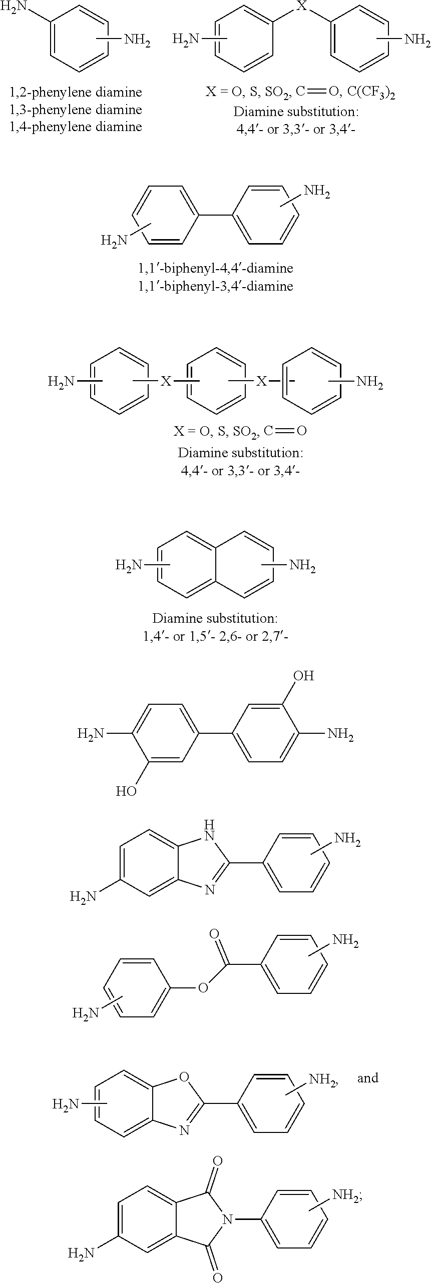

a di-, tri-, or tetra-functional aromatic carboxylic acid or functional equivalent thereof selected from at least one of:

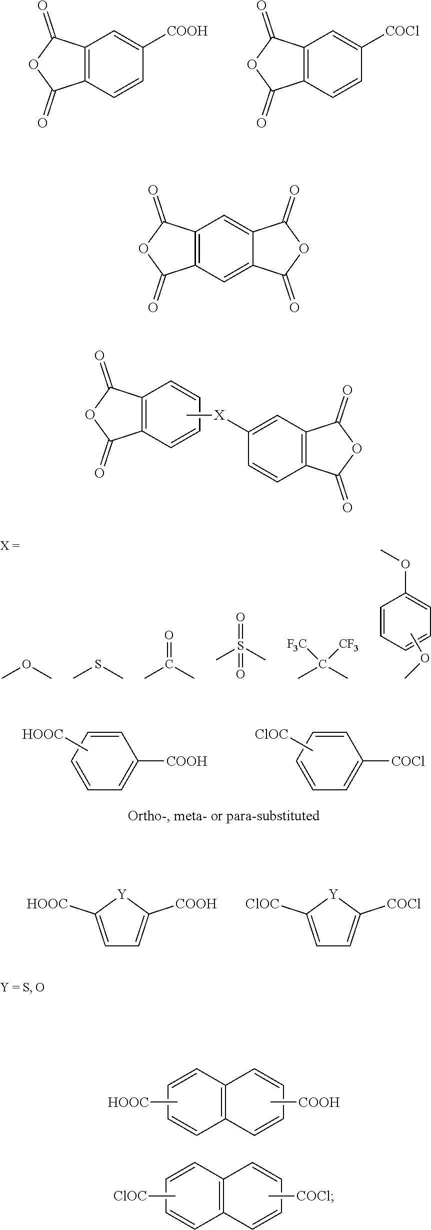

and
a crosslinkable monomer or crosslinkable end-capper selected from at least one of:

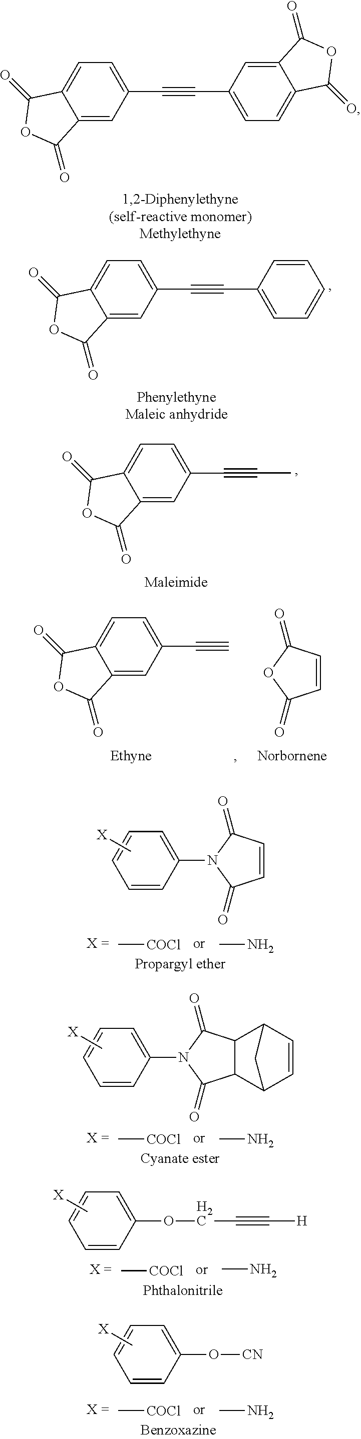

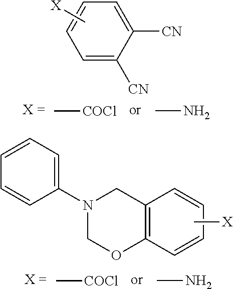

Aspect 173. A reactive polyamide amic acid oligomer comprising units derived from: an aromatic diamine selected from at least one of 1,3-phenylene diamine, 4,4′-oxydianiline, or 3,4′-oxydianiline; a di-, tri-, or tetra-functional aromatic carboxylic acid or functional equivalent thereof selected from at least one of trimellitic anhydride, 4-chloroformylphthalic anhydride, isophthalic anhydride, isophthaloyl chloride, pyromellitic dianhydride, or biphenyl tetracarboxylic acid dianhydride; and a crosslinkable monomer or crosslinkable end-capper selected from at least one of 4-ethynyl phthalic anhydride, 4-methylethynyl phthalic anhydride, 4-phenylethynylphthalic anhydride (PEPA), or 4,4′-(ethyne-1,2-diyl)diphthalic anhydride.

Aspect 174. A method of manufacture of the reactive polyamide amic acid oligomer of any of aspects 155 to 173, the method comprising: copolymerizing at least one aromatic diamine, at least one aromatic di-, tri-, or tetra-functional carboxylic acid or functional equivalent thereof, and at least one crosslinkable monomer or crosslinkable end-capper in the presence of a polar solvent to form the reactive polyamide amic acid oligomer; wherein the crosslinkable monomer or crosslinkable end-capper is reactive with the at least one aromatic diamine or the at least one di-, tri-, or tetra-functional aromatic carboxylic acid or functional equivalent thereof and has at least one unreacted functional group capable of chain extension and crosslinking after formation of the reactive polyamide amic acid oligomer.

Aspect 175. The method of manufacture of aspect 174, wherein the polar solvent is at least one of N-methyl-2-pyrollidone, N,N-dimethylacetamide, N,N-dimethylformamide, 1,2-dichlorobenzene, 1,2,4-trichlorobenzene, or sulfolane.

Aspect 176. The method of manufacture of aspect 174 or 175, further comprising isolating the reactive polyamide amic acid oligomer from the polar solvent.

Aspect 177. A blend composition comprising the reactive polyamide amic acid oligomer of any of aspects 155 to 173 and a thermoplastic polymer.

Aspect 178. A method of compounding the reactive polyamide amic acid oligomer of any of aspects 155 to 173, comprising mixing the reactive polyamide amic acid oligomer with at least one other material at a sufficient temperature and time imidize, but not crosslink, the reactive polyamide amic acid oligomer.

Aspect 179. A method of manufacture of an article, the method comprising heating the reactive polyamide amic acid oligomer of any of aspects 155 to 173 at a sufficient temperature and time to imidize, shape, and crosslink the reactive polyamide amic acid oligomer.

Aspect 180. The method of manufacture of aspect 179, wherein the sufficient temperature and time is about 160 to about 400° C. for about 10 to about 60 minutes.

Aspect 181. An article manufactured by a method of aspect 179 or 180.

Aspect 182. An article comprising the reactive polyamide amic acid oligomer of any of aspects 155 to 173.

Aspect 183. The method of manufacture of aspect 179 or 180, wherein the method is additive manufacturing.

Aspect 184. The method of manufacture of aspect 183, wherein the method is fused filament fabrication, the method comprising extruding the reactive polyamide amic acid oligomer in adjacent horizontal layers such that there is an interface between each layer of reactive polyamide amic acid oligomer, and exposing the layers to heat at a sufficient temperature and time to imidize and crosslink the reactive polyamide amic acid oligomer and form the article.

Aspect 185. The method of manufacture of aspect 183, wherein the method is selective laser sintering, the method comprising selectively sintering, imidizing, and crosslinking particles of the reactive polyamide amic acid oligomer with a laser to form the article.

Aspect 186. The method of manufacture of aspect 183, wherein the method is directed energy deposition (DED) or laser engineered net shaping (LENS).

Aspect 187. An article manufactured by the method of any of aspects 183 to 186.

Aspect 188. An additive manufactured article comprising the reactive polyamide amic acid oligomer of any of aspects 155 to 173.

### EXAMPLES

### Materials and Methods

Abbreviations for materials used or mentioned herein are defined in Table 2. For those materials used in the examples, sources are provided. A key for other abbreviations used herein is provided in Table 3.

TABLE 2
Materials

| Short Name | Chemical Name | Source |
|---|---|---|
| 1,3-PD | 1,3-Diaminobenzene | TCI America |
| 3,4′-ODA | 3,4′-Oxydianiline | TCI America |
| 4,4′-ODA | 4,4′-Oxydianiline | TCI America |
| a-BPDA | 2,3,3′,4′-Biphenyl tetracarboxylic | — |
| | dianhydride | |
| BPA | 4,4′-(2,2-Propanediyl)diphenol | — |
| | (Bisphenol A) | |
| DMAc | N,N-Dimethyl acetami de | — |
| DMF | N,N-Dimethylformamide | — |
| EBPA | 4,4′-(Ethyne-l,2-diyl) bis(phthalic | Nexam Chemical |
| | anhydride) | |
| EtOH | Ethanol | — |
| HCl | Hydrochloric acid | — |
| IPC | Isophthaloyl chloride | Sigma-Aldrich |
| | | Chemicals |
| MeOH | Methanol | — |
| MEPA | 4-Methylethynylphthalic anhydride | Nexam Chemical |
| NMP | N-methyl-2-pyrrolidone | Across Organics |
| N₂ | Molecular nitrogen | — |
| ODPA | 4,4′-oxydiphthalic anhydride | TCI America |
| PAAA | Polyamide amic acid | — |
| PAI | Polyamideimide | — |
| PEPA | 4-Phenylethynylphthalic anhydride | Nexam Chemical |
| PMDA | Pyromellitic dianhydride | TCI America |
| Pt | Platinum | — |
| THF | Tetrahydrofuran | — |
| TMA | Trimellitic anhydride | TCI America |
| TMACl | 4-Chloroformylphthalic anhydride | TCI America |
| Tol | Toluene | — |

TABLE 3
Other Abbreviations

| Abbreviation | Full Name |
|---|---|
| atm | Atmosphere(s) |
| CAD | Computer aided design |
| Eq. | Equation |
| FDM | Fused deposition modeling |
| FFF | Fused filament fabrication (fused |
| | deposition modeling) |
| Fig. | Figure |
| g | Gram(s) |
| h | Hour(s) |
| GPa | Gigapascal(s) |
| M | Molar |
| Mₙ | Number average molecular weight |
| MPa | Megapascal(s) |
| min | Minute(s) |
| MJ | Megajoule(s) |
| mL | Milliliter(s) |
| mm | Milimeter(s) |
| mol | Mole(s) |
| mmol | Millimole(s) |
| Pa · s | Pascal · second(s) |
| SLS | Selective laser sintering |
| T_{g} | Glass transition temperature |
| Tₘ | Melting point |
| UD | Unidirectional |
| μm | Micrometer(s) |

Rheology. Melt complex viscosity was measured by oscillatory shear rheology at a heating rate of 10° C./minute under N₂, a frequency of 2 radians/second, and a strain of 0.03% to 1.0%. A 13-millimeter diameter sample is centered between 25-millimeter diameter parallel plates for the measurements.

Thermogravimetric Analysis (TGA). For determining T_{d,5% wt. loss}: TA instruments TGA 5500, Pt pans, 10° C./min, N₂, 10 mg sample.

Differential Scanning Calorimetry (DSC). For determining T_{g}: TA instruments DSC2500, Tzero pan with hermetic lid, 10° C./min, N₂, ˜7 mg sample. In this method, T_{g} is determined from the inflection point.

Dynamic Mechanical Thermal Analysis (DMTA). TA instruments RSA G2 in tension mode, 25° C. to 400° C. at 2° C./min, N₂ atmosphere, sample dimensions=0.030 mm×2 mm×10 mm. In this method, T_{g} is determined from the maximum of the loss modulus peak.

Stress strain measurements. TA instruments RSA G2 (32 N load cell), strain rate of 1 mm/min, sample dimensions=˜0.030 mm×˜2 mm×10 mm. Young's modulus was determined by linear fitting of stress-strain curve in the elastic region; between 0.1 to 0.3% strain.

Gel Permeation Chromatograph (GPC). Shimadzu Prominence ultrafast liquid chromatograph (UFLC) system equipped with a LC20AD pump, SIL-20A HT autosampler, CTO-20A column oven at 60° C., and a RID-20A refractive index detector. For measurements, the column used was a SHODEX™ LF-804. Eluent utilized for measurements was NMP containing 0.05 M LiBr and 0.05 M H₃PO₄ operating at a constant flow rate of 0.5 mL/min. Relative molecular weights were obtained by comparison with SHODEX™ polystyrene standards.

### Example 1

The manufacture of a reactive polyamideimide oligomer is illustrated below in Scheme 5. Molecular weight of the oligomer influences thermal, (thermo-)mechanical, and melt properties of the reactive polyamideimide oligomers. In this example, a phenylethynyl end-capper (PEPA) was used to prepare reactive polyamideimide oligomers with Mₙ values of 5,000 g/mol (Ex. 1B-1E), 3,000 g/mol (Ex. 1F-1G), and 8,000 g/mol (Ex. 1H-1I). The Carothers equation (Eq. 2) was used to calculate monomer amounts needed to prepare reactive polyamideimide oligomers with the desired Mₙ values. Keeping Mₙ constant, when more than one diamine monomer is utilized, the relative molar amounts of the diamine monomers will affect the rigidity of the oligomeric backbone. Thus, the thermal, (thermo-)mechanical, and melt properties of reactive polyamideimide oligomer can be varied by varying the ratio of diamine monomers. In Example 1A, the Mₙ of the reactive polyamideimide oligomer was 5,000 g/mol and the backbone consisted of two diamines, 4,4′-ODA and 1,3-PD in a 0.72:0.28 molar ratio. Changing the molar ratio of the two diamines will result in change in oligomer properties. The molar ratio of 4,4′-ODA to 1,3-PD is 0.72:0.28 in Ex. 1A-1I, 0.62:0.32 in Examples 1J-1K, and 0.813:0.197 in Examples 1L-1M.

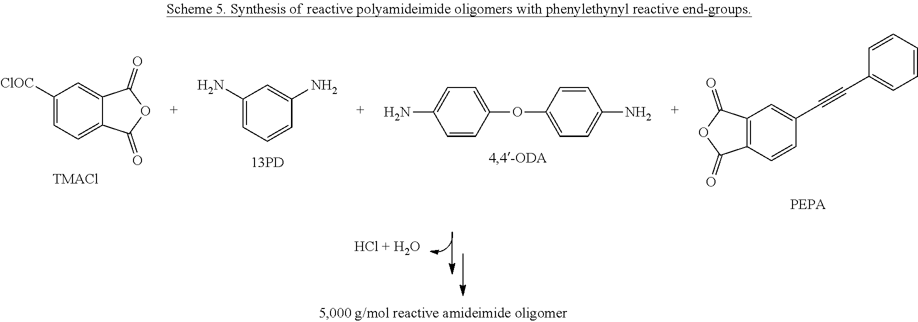

### Example 1A—Reactive Polyamide Amic Acid Oligomer Solution, Mₙ=5,000 g/mol

A 150 mL 2-neck round bottom flask equipped with stir bar and nitrogen inlet tube was charged with 1,3-phenylene diamine (6.38 mmol, 0.69 g), 4,4′-oxydianiline (16.33 mmol, 3.27 g) and 37 g NMP. The mixture was stirred until a homogenous solution was obtained. The solution was cooled to 0° C. Trimellitic anhydride chloride (21.28 mmol, 4.48 g) and 4-(phenylethynyl)phthalic anhydride (2.9 mmol, 0.72 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h) to provide a solution of reactive polyamide amic acid oligomer in NMP.

### Example 1B—Reactive Polyamideimide Oligomer Film, Mₙ=5,000 g/mol

This is an example of preparation of a free-standing reactive polyamideimide oligomer film without curing of the phenylethynyl end-groups. The reactive polyamide amic acid oligomer solution prepared in Example 1A (10 mL) was cast onto a glass plate and dried at 60° C. under vacuum. The temperature was increased stepwise to 100° C. for 1 h, 200° C. for 1 h, and 300° C. for 1 h to dehydrate the reactive polyamide amic acid oligomer and obtain a reactive polyamideimide oligomer having unreacted phenylethynyl end-groups. The film was brittle and difficult to handle, which is a direct consequence of the low molecular weight. The T_{g} was 248° C., measured by Differential Scanning Calorimetry (N₂, 10° C./min).

### Example 1C—Cured Polyamideimide Oligomer Film, Mₙ=5,000 g/mol

This is an example of preparation of a flexible, free-standing film with curing of the phenylethynyl end-groups. The reactive polyamide amic acid oligomer solution as prepared in Example 1A (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained. Thermogravimetric analysis (N₂, 10° C./min) showed a 5% weight loss at 483° C. Differential Scanning Calorimetry (N₂, 10° C./min) shows a T_{g} of 301° C. Dynamic Mechanical Thermal Analysis (N₂, 10° C./min, 1 Hz) shows a storage modulus (E′) of 3.2 GPa at 33° C., 0.81 GPa at 300° C. and a T_{g} of 306.8° C. Stress-strain experiments (25° C.) show that the films exhibit a Young's modulus of 3.4 GPa, strength at break of 134 MPa, and strain at break of 17%. The film properties exceed what is expected for a high molecular weight polymer film.

### Example 1D—Isolated Reactive Polyamideimide Oligomer Powder, Mₙ=5,000 g/mol

An imidized reactive polyamideimide oligomer powder was obtained by precipitation of the reactive polyamide amic acid solution in NMP of Example 1A in MeOH. The polyamide amic acid was precipitated by pouring 50 mL of the polyamide amic acid solution of Example 1A into 200 mL MeOH in a Warring blender, with mixing for 1-3 min. The precipitate was collected by filtration on a Buchner funnel, and washed with an additional 200 mL MeOH. The washed polyamide amic acid powder was dried in the oven at 60° C. for 2 h under vacuum. The temperature was stepwise increased to 100° C. for 1 h, 200° C. for 1 h, and 260° C. for 1 h to dehydrate the reactive polyamide amic acid oligomer and obtain a reactive polyamideimide oligomer powder with unreacted phenylethynyl end-groups. Parallel-Plate Rheology (N₂, 10° C./min) of the fully imidized, reactive polyamideimide oligomer showed a melt complex viscosity of 19,000 Pa·s at 361° C.

### Example 1E—Cured Polyamideimide Oligomer Film, Mₙ=5,000 g/mol

This is another example of preparation of a flexible, free-standing film with curing of the phenylethynyl end-groups. The reactive polyamide amic acid oligomer solution of Example 1A was imidized as follows. Dry toluene was added to the reaction flask. Water formed during cyclodehydration (of amic acid to imide) was removed by azeotropic distillation. After 2 h, the reactive polyamide amic acid oligomer was 98% imidized and the remaining toluene was removed by distillation. A solution (10 mL) of the resulting reactive polyamideimide oligomer in NMP (30 wt. % solids) was cast onto a glass plate and dried at 60° C. under vacuum. After cooling to room temperature, the temperature was stepwise increased to 40° C. for 2 h, 60° C. for 2 h, 100° C., 200° C., 300° C. for 30 min, and 370° C. for 1 h. After cooling the film to 25° C., a flexible and tough film was obtained. Differential Scanning Calorimetry (N₂, 10° C./min) showed a T_{g} of 326° C., which is about 46° C. higher than the T_{g} of a currently available PAI film (280° C.).

### Example 1F, Cured Polyamideimide Oligomer Film, Mₙ=3,000 g/mol

A reactive polyamideimide oligomer having Mₙ=3,000 g/mol was prepared with 4-phenylethynylphthalic anhydride end-cappers. A 150 mL 2-neck round bottom flask equipped with stir bar and nitrogen inlet tube was charged with 1,3-phenylene diamine (22.84 mmol, 2.47 g), 4,4′-oxydianiline (62.07 mmol, 12.43 g) and 82 g NMP. The mixture was stirred until a homogenous solution was obtained. The solution was cooled to 0° C. Trimellitic anhydride chloride (76.08 mmol, 16.02 g) and 4-(phenylethynyl)phthalic anhydride (17.64 mmol, 4.38 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h) to provide a solution of reactive polyamide amic acid oligomer in NMP. The reactive polyamide amic acid oligomer solution (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible film was obtained. Thermogravimetric analysis (N₂, 10° C./min) showed a 5% weight loss at 500° C. Differential Scanning Calorimetry (N₂, 10° C./min) shows a T_{g} of 291° C. Dynamic Mechanical Thermal Analysis (N₂, 10° C./min, 1 Hz) shows a storage modulus (E′) of 1.71 GPa at 35° C., 0.25 GPa at 300° C. and a T_{g} of 292° C. Stress-strain experiments (25° C.) show that the films exhibit a Young's modulus of 3.0 GPa, strength at break of 110 MPa, and strain at break of 16.4%.

### Example 1G—Isolated Reactive Polyamideimide Oligomer Powder, Mₙ=3,000 g/mol

An imidized reactive polyamideimide oligomer powder was obtained by precipitation of the reactive polyamide amic acid solution in NMP of Example 1D in MeOH. The polyamide amic acid was precipitated by pouring 50 mL of the polyamide amic acid solution of Example 1D into 200 mL MeOH in a Warring blender, with mixing for 1-3 min. The precipitate was collected by filtration on a Buchner funnel, and washed with an additional 200 mL MeOH. The washed polyamide amic acid powder was dried in the oven at 60° C. for 2 h under vacuum. The temperature was stepwise increased to 100° C. for 1 h, 200° C. for 1 h, and 260° C. for 1 h to dehydrate the reactive polyamide amic acid oligomer and obtain a reactive polyamideimide oligomer powder with unreacted phenylethynyl end-groups. Parallel-Plate Rheology (N₂, 10° C./min) of the fully imidized, reactive polyamideimide oligomer showed a melt complex viscosity of 5450 Pa·s at 361° C.

### Example 1H—Cured Polyamideimide Oligomer Film, Mₙ=8,000 g/mol

A reactive polyamideimide oligomer having Mₙ=8,000 g/mol was prepared with 4-phenylethynylphthalic anhydride reactive end-groups. A 150 mL 2-neck round bottom flask equipped with stir bar and nitrogen inlet tube was charged with 1,3-phenylene diamine (22.84 mmol, 2.47 g), 4,4′-oxydianiline (56.43 mmol, 11.30 g) and 73 g NMP. The mixture was stirred until a homogenous solution was obtained. The solution was cooled to 0° C. Trimellitic anhydride chloride (76.08 mmol, 16.02 g) and 4-(phenylethynyl)phthalic anhydride (6.04 mmol, 1.5 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h) to provide a solution of reactive polyamide amic acid oligomer in NMP. The reactive polyamide amic acid oligomer solution (10 mL) was cast onto a glass plate and dried at 40° C. for 2 h. and at 60° C. for 2 h. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling to 25° C., a flexible film was obtained. Thermogravimetric analysis (N₂, 10° C./min) showed a 5% weight loss at 490° C. Differential Scanning Calorimetry (N₂, 10° C./min) showed a T_{g} of 287° C. Dynamic Mechanical Thermal Analysis (N₂, 10° C./min, 1 Hz) showed a storage modulus (E′) of 3.0 GPa at 35° C., 0.75 GPa at 300° C. and a T_{g} of 300° C. Stress-strain experiments (25° C.) showed that the films exhibit a Young's modulus of 3.1 GPa, strength at break of 139 MPa, and strain at break of 57.4%.

### Example 1I—Isolated Reactive Polyamideimide Oligomer Powder, Mₙ=8,000 g/mol

An imidized, reactive polyamideimide oligomeric powder was obtained by precipitation of the reactive polyamide amic acid solution in NMP of Example 1F in MeOH. The polyamide amic acid was precipitated by pouring 50 mL of the polyamide amic acid solution into 200 mL MeOH in a Warring blender, with mixing for 1-3 min. The precipitate was collected by filtration on a Buchner funnel, and washed with an additional 200 mL MeOH. The washed polyamide amic acid powder was dried in tam oven at 60° C. for 2 h under vacuum. The temperature was stepwise increased to 100° C. for 1 h, 200° C. for 1 h, and 260° C. for 1 h to dehydrate the reactive polyamide amic acid oligomer and obtain a reactive polyamideimide oligomer powder with unreacted phenylethynyl end-groups. Parallel-Plate Rheology (N₂, 10° C./min) of the fully imidized, reactive polyamideimide oligomer showed a melt complex viscosity of 49,902 Pa·s at 333° C.

### Example 1J—Cured Oligomeric Polyamideimide Oligomer Film, 4,4′-ODA:1,3-PD Ratio=0.62:0.32, Mₙ=5,000 g/mol

In this example, the molar ratio of the two diamines; 4,4′-ODA and 1,3-PD was 0.62:0.32. A 150 mL 2-neck round bottom flask equipped with stir bar and nitrogen inlet tube was charged with 1,3-phenylene diamine (37.54 mmol, 4.06 g), 4,4′-oxydianiline (62.52 mmol, 12.52 g) and 92 g NMP. The mixture was stirred until a homogenous solution was obtained. The solution was cooled to 0° C. Trimellitic anhydride chloride (93.89 mmol, 19.77 g) and 4-(phenylethynyl)phthalic anhydride (12.41 mmol, 3.08 g) were added all at once. This reaction mixture was stirred at 0° C. for 1 to 2 h under a nitrogen atmosphere, after which time the ice-bath was removed and the reaction mixture was stirred and allowed to warm to 25° C. overnight (˜16 h) to provide a solution of reactive polyamide amic acid oligomer in NMP. The reactive polyamide amic acid oligomer solution (10 mL) was cast onto a glass plate and dried at 40° C. for 2 h and at 60° C. for 2 h under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling to 25° C., a flexible film was obtained. Thermogravimetric analysis (N₂, 10° C./min) showed a 5% weight loss at 478° C. Differential Scanning Calorimetry (N₂, 10° C./min) showed a T_{g} of 283° C. Dynamic Mechanical Thermal Analysis (N₂, 10° C./min, 1 Hz) showed a storage modulus (E′) of 2.0 GPa at 35° C., 0.24 GPa at 300° C. and a T_{g} of 291.3° C. Stress-strain experiments (25° C.) show that the films exhibit a Young's modulus of 2.5 GPa, strength at break of 82.5 MPa, and strain at break of 10.1%.

### Example 1K—Isolated Reactive Polyamideimide Oligomer Powder, 4,4′-ODA:1,3-PD Ratio=0.62:0.32, Mₙ=5,000 g/mol

An imidized, reactive polyamideimide oligomer powder was obtained by precipitation of the reactive polyamide amic acid oligomer solution in NMP of Example 1I in MeOH. The reactive polyamide amic acid oligomer was precipitated by pouring 50 mL of the reactive polyamide amic acid oligomer solution into 200 mL MeOH in a Waring blender, and mixing for 1-3 min. The precipitate was collected by filtration on a Buchner funnel, and washed with an additional 200 mL MeOH. The washed reactive polyamide amic acid oligomer powder was dried in an oven at 60° C. for 2 h under vacuum. The temperature was stepwise increased to 100° C. for 1 h, 200° C. for 1 h, and 260° C. for 1 h to dehydrate the reactive polyamide amic acid oligomer and obtain a reactive polyamideimide oligomer powder with unreacted phenylethynyl end-groups. Parallel-Plate Rheology (N₂, 10° C./min) of the fully imidized, reactive polyamideimide oligomer shows a melt complex viscosity of 40,339 Pa·s at 370° C.

### Example 1L—Cured Oligomeric Polyamideimide Oligomer Film, 4,4′-ODA:1,3-PD Ratio=0.813:0.197, Mₙ=5,000 g/mol

In this example, the molar ratio of the two diamines; 4,4′-ODA and 1,3-PD was 0.813:0.187. A 150 mL 2-neck round bottom flask equipped with stir bar and nitrogen inlet tube was charged with 1,3-phenylene diamine (18.77 mmol, 2.03 g), 4,4′-oxydianiline (81.70 mmol, 16.36 g) and 96 g NMP. The mixture was stirred until a homogenous solution was obtained. The solution was cooled to 0° C. Trimellitic anhydride chloride (93.89 mmol, 19.77 g) and 4-(phenylethynyl)phthalic anhydride (12.41 mmol, 3.08 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h) to provide a solution of reactive polyamide amic acid oligomer in NMP. The reactive polyamide amic acid oligomer solution (10 mL) was cast onto a glass plate and dried at 40° C. for 2 h and at 60° C. for 2 h under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling to 25° C., a flexible film was obtained. Thermogravimetric analysis (N₂, 10° C./min) showed a 5% weight loss at 496° C. Differential Scanning Calorimetry (N₂, 10° C./min) showed a T_{g} of 308° C. Dynamic Mechanical Thermal Analysis (N₂, 10° C./min, 1 Hz) showed a storage modulus (E′) of 2.5 GPa at 35° C., 1.0 GPa at 300° C. and a T_{g} of 322° C. Stress-strain experiments (25° C.) showed that the films exhibit a Young's modulus of 3.7 GPa, strength at break of 132 MPa, and strain at break of 12.6%.

### Example 1M—Isolated Reactive Polyamideimide Oligomer Powder, 4,4′-ODA:1,3-PD Ratio=0.813:0.197, Mₙ=5,000 g/mol

The imidized, reactive polyamideimide oligomer powder was obtained by precipitation of the reactive polyamide amic acid oligomer solution in NMP in MeOH. The reactive polyamide amic acid oligomer was precipitated by pouring 50 mL of the reactive polyamide amic acid oligomer solution into 200 mL MeOH in a Warring blender, and mixing for 1-3 min. The mixture was washed in the Warring blender for 1-3 minutes. The precipitate was collected by filtration on a Buchner funnel, and washed with an additional 200 mL MeOH. The washed reactive polyamide amic acid oligomer powder was dried in an oven at 60° C. for 2 h under vacuum. The temperature was stepwise increased to 100° C. for 1 h, 200° C. for 1 h, and 260° C. for 1 h. to dehydrate the reactive polyamide amic acid oligomer and obtain a reactive polyamideimide oligomer powder with unreacted phenylethynyl end-groups. The Parallel-Plate Rheology (N₂, 10° C./min) of the fully imidized, reactive polyamideimide shows a melt complex viscosity of 49502 Pa·s at 359° C.

### Example 2

The manufacture of a reactive polyamideimide (PAI) oligomer having a Mₙ of 5,000 g/mol using two different end-cappers is shown below in Scheme 6. The two different end-cappers are 4-(phenylethynyl)phthalic anhydride and 4-(methylethynyl)phthalic anhydride.

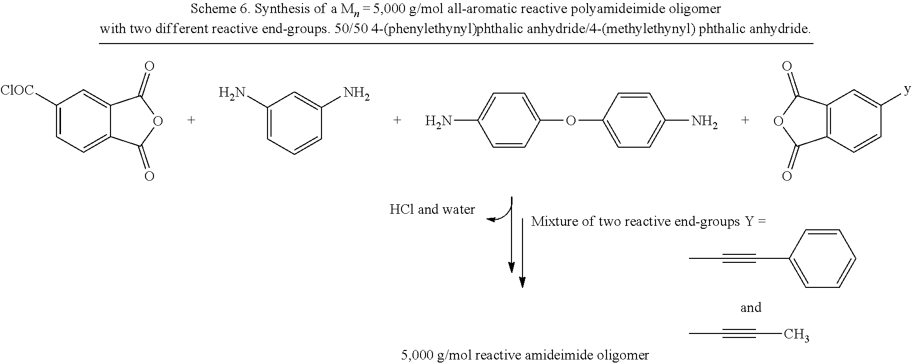

A 150 mL 2-neck round bottom flask equipped with stir bar and nitrogen inlet tube was charged with 1,3-phenylene diamine (6.38 mmol, 0.69 g), 4,4′-oxydianiline (16.33 mmol, 3.27 g) and 36 g NMP. The mixture was stirred until a homogenous solution was obtained. The solution was cooled to 0° C. Trimellitic anhydride chloride (21.28 mmol, 4.48 g), 4-(phenylethynyl)phthalic anhydride (1.45 mmol, 0.36 g) and 4-(methylethynyl) phthalic anhydride (1.45 mmol, 0.27 g) were added all at once. This reaction mixture was stirred at 0° C. for 1 to 2 h under a nitrogen atmosphere, after which time the ice-bath was removed and the reaction mixture was allowed to stir and warm-up to 25° C. overnight (˜16 h). The reactive polyamide amic acid oligomer solution as prepared (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained.

Thermogravimetric analysis (N₂, 10° C./min) showed a 5% weight loss at 466° C. Differential Scanning Calorimetry (N₂, 10° C./min) showed a T_{g} of 298° C. Dynamic Mechanical Thermal Analysis (N₂, 10° C./min, 1 Hz) showed a storage modulus (E′) of 2.6 GPa at 33° C., 0.64 GPa at 300° C. and a T_{g} of 301° C. Parallel-Plate Rheology (N₂, 10° C./min) showed a viscosity of 98,560 Pa·s at 301° C. Stress-strain experiments at 25° C. showed that the films exhibit a Young's modulus of 3.6 GPa, a strength at break of 155 MPa, an elongation at break of 75%, and a toughness of 94.3 MJ/m³. In contrast, a review of available literature show that at best currently available PAI has a toughness of only ˜10 MJ/m³, a strength at break of 140 MPa, and an elongation at break of 10 to 15%. Therefore, the toughness of PAI films made from the reactive polyamideimide oligomer can be almost 10 times higher, the elongation at break can be about 5 times higher, and the strength at break can be about 10% higher than the toughness, elongation at break, and strength at break, respectively, of currently available PAL. In general, crosslinking of polymers results in a decrease in elongation at break. Surprisingly, upon crosslinking of reactive polyamideimide oligomers, both the strength at break and elongation at break increases, which results in a large increase in toughness.

In additive manufacturing methods, such as fused filament fabrication and selective laser sintering, the low molecular weight of the reactive polyamideimide oligomer promotes rapid diffusion across the interface between two filaments or particles. Moreover, the reactive functionalities can be selected to polymerize (chain extend/crosslink) over a broad temperature range. In this example, the reactive polyamideimide oligomer is capable of two-step curing at different temperatures. The methylethynyl group cures over a temperature range of 280 to 330° C., and the phenylethynyl group cures over a temperature range of 330 to 400° C. In an additive manufacturing method, the lower temperature curing methylethynyl groups ensures rapid fixation of the structure and the higher temperature curing phenylethynyl groups allow for additional chain diffusion and chain extension/crosslinking after curing of the lower temperature groups without losing structural integrity.

### Example 3

The manufacture of another reactive polyamideimide oligomer is shown below in Scheme 7. TMACI is expensive so it is desirable to minimize its use in the manufacture of reactive polyamideimide oligomers. TMACI has one acid chloride group and one carboxylic acid anhydride group. Instead of using one equivalent TMACI, ½ equivalent of pyromellitic dianhydride (PMDA) and ½ equivalent of isophthaloyl chloride (TPC) was used. A reactive oligomer was prepared with a Mₙ of 5,000 g/mol with 4-(phenylethynyl)phthalic anhydride reactive end-groups.

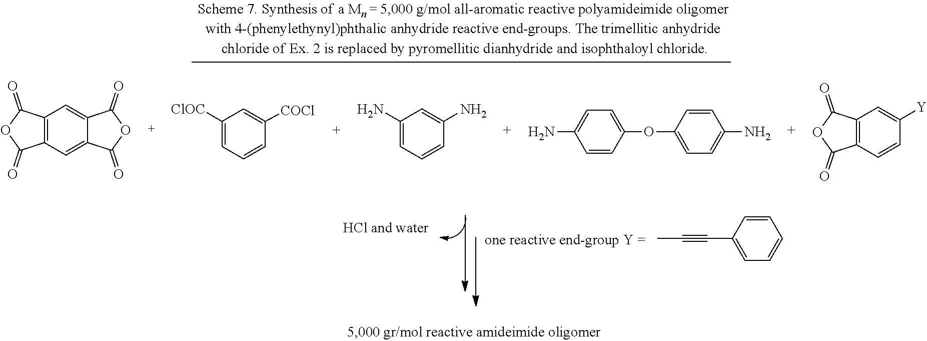

A 150 mL 2-neck round bottom flask equipped with stir bar and nitrogen inlet tube was charged with pyromellitic dianhydride (10.64 mmol, 2.32 g), isophthaloyl chloride (10.64 mmol, 2.16 g), 4-(phenylethynyl)phthalic anhydride (2.9 mmol, 0.72 g) and 37 g NMP. This suspension was stirred for 15 min and cooled to 0° C. Both diamines, 1,3-phenylene diamine (6.38 mmol, 0.69 g) and 4,4′-oxydianiline (16.33 mmol, 3.27 g) were added all at once. This reaction mixture was stirred at 0° C. for 1 h under a nitrogen atmosphere, after which time the ice-bath was removed and the reaction mixture was allowed to stir and warm-up to 25° C. overnight (˜16 h). The reactive polyamide amic acid oligomer solution as prepared (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained. Thermogravimetric analysis (N₂, 10° C./min) showed a 5% weight loss at 476° C. Differential Scanning Calorimetry (N₂, 10° C./min) showed a T_{g} of 315° C. Dynamic Mechanical Thermal Analysis (N₂, 10° C./min, 1 Hz) showed a storage modulus (E′) of 2.8 GPa at 33° C. and 0.93 GPa at 300° C., and a T_{g} of 299° C. Stress-strain experiments at 25° C. showed that the films exhibit a Young's modulus of 3.2 GPa, a strength at break of 121 MPa, an elongation at break of 25%.

### Example 4

The manufacture of another reactive polyamideimide oligomer is shown below in Scheme 8. A crosslinkable dianhydride monomer (4,4′-(ethyne-1,2-diyl)diphthalic dianhydride or EBPA) was incorporated into the reactive oligomer backbone. In order to limit molecular weight (Mₙ) to 5,000 g/mol, phthalic anhydride (non-reactive) end-capper was used.

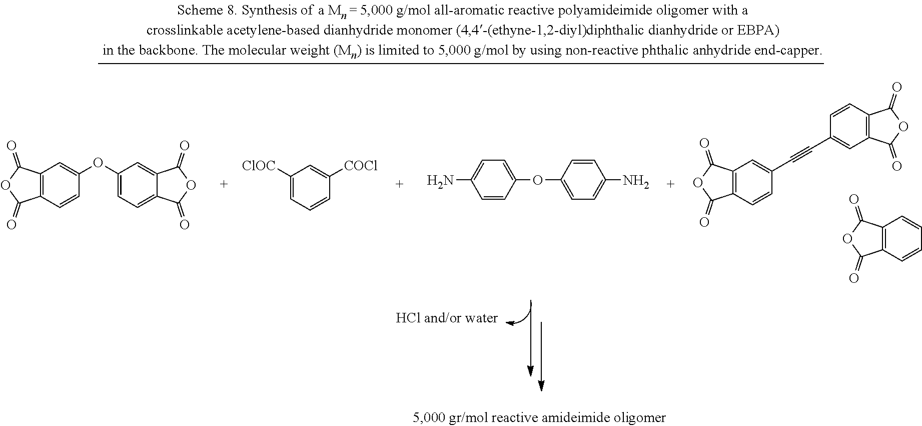

A 150 mL 2-neck round bottom flask equipped with stir bar and nitrogen inlet tube was charged with 4,4′-oxydiphthalic anhydride (ODPA) (7.98 mmol, 2.48 g), isophthaloyl chloride (10.64 mmol, 2.16 g), EBPA (2.66 mmol, 0.85 g), phthalic anhydride (2.9 mmol, 0.43 g) and 42 g NMP. This suspension was stirred for 15 min and cooled to 0° C. The diamine 4,4′-oxydianiline (22.71 mmol, 4.55 g) was added all at once. This reaction mixture was stirred at 0° C. for 1 h under a nitrogen atmosphere, after which time the ice-bath was removed and the reaction mixture was allowed to stir and warm up to 25° C. overnight (˜16 h). The reactive polyamide amic acid oligomer solution as prepared (10 mL) was cast onto a glass plate and dried at 60° C. under vacuum to form a film. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 370° C. and the film was kept at this temperature for 1 h. After cooling the film to 25° C., a flexible and tough film was obtained. Thermogravimetric analysis (N₂, 10° C./min) showed a 5% weight loss at 463° C. Differential Scanning Calorimetry (N₂, 10° C./min) showed a T_{g} of 268° C.

Another film was formed in the same way, except the reactive polyamideimide oligomer film was cured at 400° C. instead of at 370° C. for 1 h. Thermogravimetric analysis (N₂, 10° C./min) showed a 5% weight loss at 459° C. Dynamic Mechanical Thermal Analysis (N₂, 10° C./min, 1 Hz) showed a storage modulus (E′) of 2.0 GPa at 33° C. and 0.16 GPa at 300° C. and a T_{g} of 282° C. Stress-strain experiments at 25° C. showed that the film exhibits a Young's modulus of 2.1 GPa, a strength at break of 56 MPa, and an elongation at break of 3%.

### Example 5

The manufacture of another reactive polyamideimide oligomer is shown below in Scheme 9. A crosslinkable dianhydride monomer (4,4′-(ethyne-1,2-diyl)diphthalic dianhydride or EBPA) was incorporated into the reactive oligomer backbone. In order to limit the molecular weight (M) to 5,000 g/mol, 4-(phenylethynyl)phthalic anhydride reactive end-cappers were used.

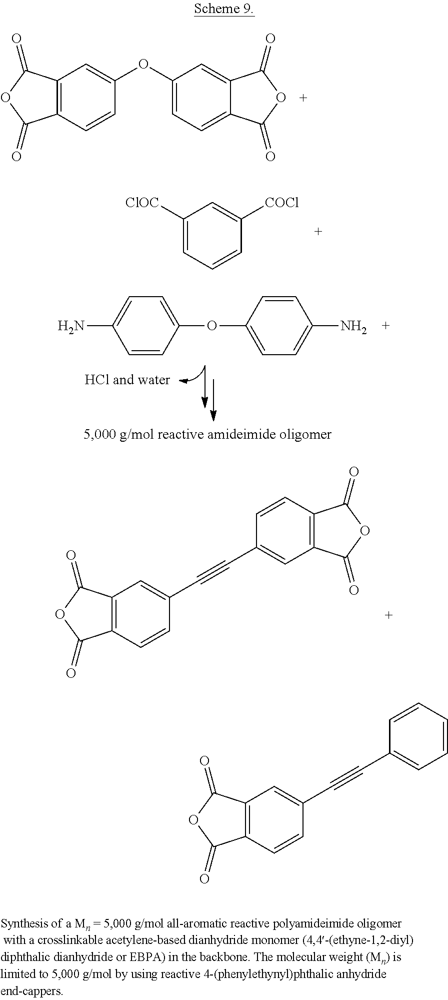

A 150 mL 2-neck round bottom flask equipped with stir bar and nitrogen inlet tube was charged with 4,4′-oxydiphthalic anhydride (ODPA) (7.98 mmol, 2.48 g), isophthaloyl chloride (10.64 mmol, 2.16 g), EBPA (2.66 mmol, 0.85 g), 4-(phenylethynyl)phthalic anhydride (2.9 mmol, 0.72 g) and 42 g NMP. This suspension was stirred for 15 min and cooled to 0° C. The diamine 4,4′-oxydianiline (22.71 mmol, 4.55 g) was added all at once. This reaction mixture was stirred at 0° C. for 1 h. under a nitrogen atmosphere, after which time the ice-bath was removed and the reaction mixture was allowed to stir and warm-up to 25° C. overnight (˜16 h).

### Example 5A

This is an example of preparation of a free-standing polyamideimide film obtained by selectively curing the phenylethynyl end-groups, and not the backbone ethynyl groups. The reactive polyamide amic acid oligomer solution as prepared in Example 5 (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups and 1,2-diphenylethynyl backbone groups. The temperature was increased to 370° C. and the film was kept at this temperature for 1 h. At this temperature, the phenylethynyl end-groups cured, but not the 1,2-diphenylethynyl backbone groups. After cooling the film to 25° C., a flexible and tough film was obtained. Differential Scanning Calorimetry (N₂, 10° C./min) showed a T_{g} of 298° C. Dynamic Mechanical Thermal Analysis (N₂, 10° C./min, 1 Hz) showed a storage modulus (E′) of 2.3 GPa at 33° C. and a T_{g} of 302° C.

### Example 5B

This is an example of preparation of a free-standing polyamideimide film with curing of both the phenylethynyl end-groups and the backbone 1,2-diphenylethynyl groups. The reactive polyamide amic acid oligomer solution as prepared in Example 5 (10 mL) was cast onto a glass plate and dried at 60° C. under vacuum. The temperature was stepwise increased to 100° C. for 1 h, 200° C. for 1 h, and 300° C. for 1 h to dehydrate the reactive polyamide amic acid oligomer and obtain a reactive polyamideimide oligomer with unreacted phenylethynyl end-groups. The temperature was increased to 400° C. and the film was kept at this temperature for 1 h. At this temperature, both the phenylethynyl end-groups and the 1,2-diphenylethynyl backbone groups cured. After cooling the film to 25° C., a flexible and tough film was obtained. Thermogravimetric analysis (N₂, 10° C./min) showed a 5% weight loss at 453° C. Dynamic Mechanical Thermal Analysis (N₂, 10° C./min, 1 Hz) showed a storage modulus (E′) of 2.7 GPa at 33° C. and a T_{g} of 324° C. Stress-strain experiments at 25° C. showed that the film exhibits a Young's modulus of 2.6 GPa, a strength at break of 78 MPa, and an elongation at break of 4%.

### Example 6

The manufacture of another reactive polyamideimide oligomer with Mₙ=5000 g/mol using the ammonium carboxylate salt route is shown below in Scheme 10.

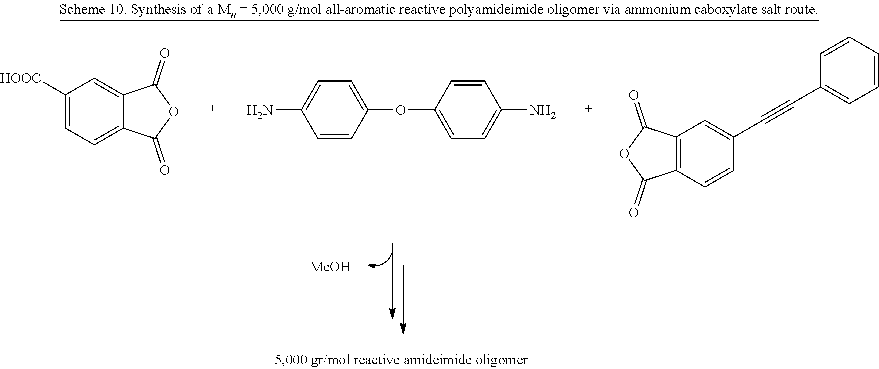 [SMILES: "MeOH" ; O=C(O)c1ccc2c(c1)C(=O)OC2=O ; Nc1ccc(Oc2ccc(N)cc2)cc1 ; O=C1OC(=O)c2cc(C#Cc3ccccc3)ccc21]

A flame-dried 3-neck, 500 mL round bottomed flask equipped with a reflux condenser and a nitrogen inlet adapter was charged with 0.2556 moles (49.11 g) of trimellitic anhydride, 0.036 moles (8.94 g) of 4-(phenylethynyl)phthalic anhydride, and 85 g of MeOH. The mixture was refluxed at 70° C. under nitrogen for 2 hours. To this mixture, 0.2730 moles (54.67 g) of 4,4′-oxydianiline was added in one batch. The mixture was refluxed for 24 h, and methanol was removed by evaporation. The resulting ammonium carboxylate salt was dried under vacuum at 70° C. The salt was heated at 10° C./min to 300° C. under nitrogen and held isothermally at 300° C. for 1 h at 3 atm pressure to obtain the reactive polyamideimide oligomer.

Thermogravimetric analysis (N₂, 10° C./min) showed a 5% weight loss at 510° C. Differential Scanning Calorimetry (N₂, 10° C./min) shows a T_{g} of 226° C. for the oligomer prior to crosslinking. After thermally crosslinking the reactive oligomer (1 h at 370° C.) the T_{g} increased from 226° C. to 287° C. Fourier Transform Infrared Spectroscopy (FTIR) using Perkin Elmer Spectrum, ATR mode: 1718 cm⁻¹ (imide C═O), 1660 cm⁻¹ (amide C═O) and 1374 cm⁻¹ (imide C—N).

### Example 7

The manufacture of a reactive polyamideimide (PAI) oligomer by reactive extrusion is illustrated below in Scheme 11. A phenylethynyl end-capper (PEPA) was used to prepare the reactive oligomer with a Mₙ of 5,000 g/mol.

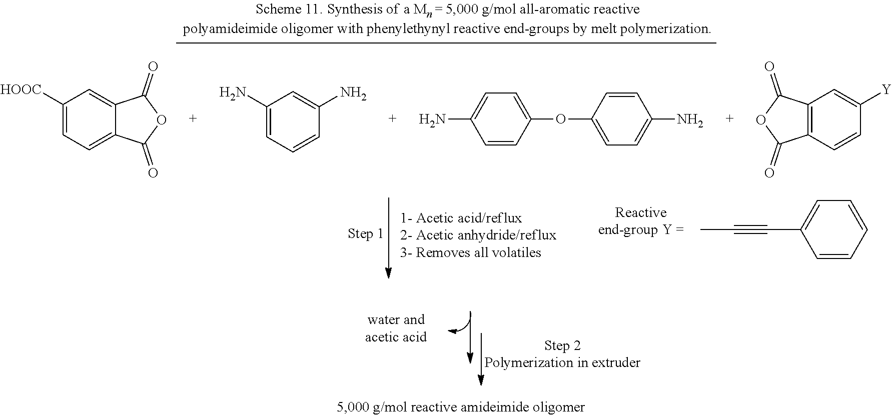

A 500 mL 2-neck round bottom flask equipped with over-head stirrer and nitrogen inlet tube was charged with 1,3-phenylene diamine (63.8 mmol, 6.9 g), 4,4′-oxydianiline (163.3 mmol, 32.7 g), trimellitic anhydride (212.8 mmol, 40.9 g), 4-(phenylethynyl)phthalic anhydride (29 mmol, 7.2 g) and 200 mL glacial acetic acid. The resulting reaction mixture was heated at reflux for 2 h, after which 20 mL of acetic anhydride was added, and the reaction was allowed to reflux for 1 more hour. Acetic acid, residual acetic anhydride, and water formed during reaction were removed by vacuum distillation. The resulting yellow monomer mixture was fed into an Xplore twin-screw extruder with vent capability at 290° C. The melt was circulated in the extruder at 290° C. for 55 min at 50 rpm to allow for polymerization to take place. Polymerization was monitored by measuring the axial force (N) versus time (min), as shown in FIG. 2. Polymerization was judged complete when an axial force of 5000 N was reached (55 min). At this point the reactive PAI oligomer was extruded as a continuous amber filament and analyzed.

To confirm that a reactive oligomer was obtained and not a crosslinked material, a small sample was dissolved in NMP. GPC analysis against a polystyrene standard showed a Mₙ of 4500 and a polydispersity index (PDI) of 2.22. TGA was run under nitrogen at 10° C./min on the resulting filament and showed 1% mass loss at 395° C. and 5% mass loss at 448° C. A powdered sample was compressed in a 13 mm Pellet press die and subjected to an oscillatory shear temperature ramp at 0.03% strain and at 2 rad/s with a ramp rate of 10° C./min from 30° C. to 350° C. The minimum recorded viscosity was 33,000 Pa·s.

A sample of the filament was ground into a powder and dissolved in NMP at 20 wt % overnight and then cast as a film with a thickness of approximately 40 μm. The film was cured under vacuum at 40° C. for 2 h, 60° C. for 1.5 h, and 100° C., 200° C., 300° C., and 350° C. for 1 h each. The cured film was subjected to uniaxial deformation and displayed a best stress at break of 115 MPa at 17% strain with a 3 GPa modulus. The sample was subjected to a uniaxial oscillatory temperature ramp at 0.03% strain and at 2 rad/s with a ramp rate of 2° C./min from 30° C. to 400° C. The sample showed a modulus of 3 GPa and a T_{g} of 290° C.

### Example 8

A reactive polyetherimide (PEI) oligomer having a Mₙ of 5,000 g/mol, a T_{g} of about 200° C., and two different end-cappers is illustrated below. The two different end-cappers are 4-(methylethynyl)phthalic anhydride and N-aryl maleimide. In this example, the reactive polyetherimide oligomer is capable of two-step curing at different temperatures. The N-aryl maleimide group cures over a temperature range of 200 to 250° C., and the methylethynyl group cures over a temperature range of 280 to 330° C. In an additive manufacturing method, the lower temperature curing N-aryl maleimide groups ensure rapid fixation of the structure and the higher temperature curing methylethynyl groups allow for additional chain diffusion and chain extension/crosslinking after curing of the lower temperature groups without losing structural integrity.

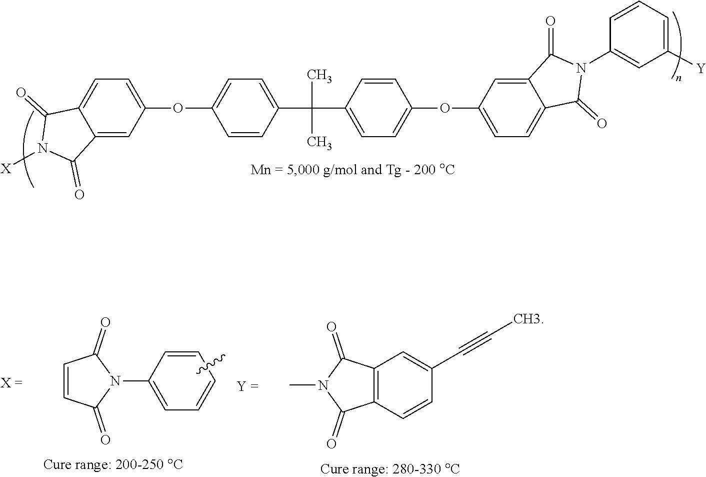

### Example 9

The manufacture of a reactive polyetherimide (PEI) oligomer having a Mₙ of 5,000 g/mol using two different end-cappers is shown below in Scheme 12. The two different end-cappers are 4-(phenylethynyl)phthalic anhydride and 4-(methylethynyl)phthalic anhydride. Also in this example, the reactive polyetherimide oligomer is capable of two-step curing at different temperatures. The methylethynyl cures over a temperature range of 280 to 330° C., and the phenylethynyl group cures over a temperature range of 330 to 400° C. In an additive manufacturing method, the lower temperature curing methylethynyl ensures rapid fixation of the structure and the higher temperature curing phenylethynyl groups allow for additional chain diffusion and chain extension/crosslinking after curing of the lower temperature groups without losing structural integrity.

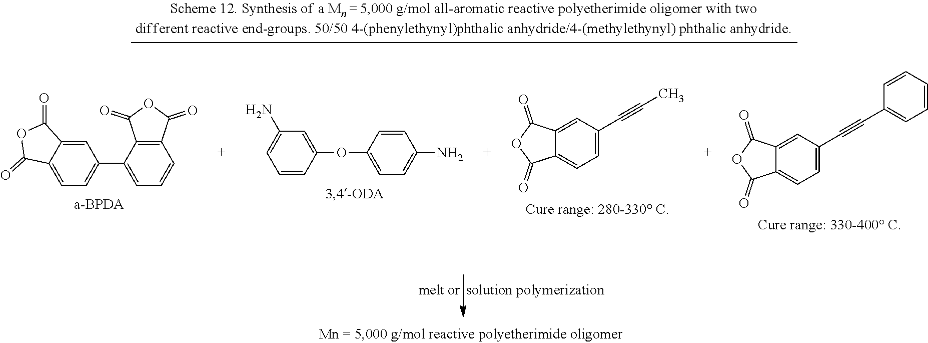 [SMILES: O=C1OC(=O)c2cc(-c3cccc4c3C(=O)OC4=O)ccc21 ; Nc1ccc(Oc2cccc(N)c2)cc1 ; CC#Cc1ccc2c(c1)C(=O)OC2=O ; O=C1OC(=O)c2cc(C#Cc3ccccc3)ccc21]

The reactive oligomers described herein, e.g. reactive polyamideimide oligomers and reactive polyamide amic acid oligomers, can also be referred to as “macromonomers”.

“Crosslinkable monomer” as used herein refers to a monomer that is reactive with at least one aromatic diamine or at least one di-, tri-, or tetra-functional aromatic carboxylic acid or functional equivalent thereof and having a unreacted functional group capable of chain extension and crosslinking after formation of the reactive polyamideimide oligomer.

“Crosslinkable end-capper” as used herein refers to an end-capper that is reactive with at least one aromatic diamine or at least one di-, tri-, or tetra-functional aromatic carboxylic acid or functional equivalent thereof and has at least one unreacted functional group capable of chain extension and crosslinking after formation of the reactive polyamideimide oligomer.

“Non-crosslinkable end-capper” as used herein refers to an end-capper that is reactive with at least one aromatic diamine or at least one di-, tri-, or tetra-functional aromatic carboxylic acid or functional equivalent thereof, but does not have an unreacted functional group capable of chain extension and/or crosslinking after formation of the reactive polyamideimide oligomer.

“Functional equivalents” of carboxylic acids include compounds in which the carbon atom of the carboxylic acid group is in the same oxidation state, and includes esters, acid chlorides, and anhydrides thereof.

Curing as used herein refers collectively to any combination of chain extension, branching, and crosslinking that leads to an enhancement in thermomechanical properties. The curing can be initiated by heat, actinic (electromagnetic) radiation, or electron beam radiation. The terms “thermal curing”, “thermal post-treatment”, and “post-heat curing” are used interchangeably for curing initiated by heat.

The terms “acetylene” and “alkyne” are used interchangeable herein.

The terms “additive manufacturing” and “3D printing” are used interchangeably herein.

The terms “fused filament fabrication” and “fused deposition molding” are used interchangeably herein.

“At least one of” as used herein in connection with a list means that the list is inclusive of each element individually, as well as combinations of two or more elements of the list, and combinations of at least one element of the list with like elements not named.

The compositions, methods, and articles can alternatively comprise, consist of, or consist essentially of, any appropriate materials, steps, or components herein disclosed. The compositions and methods can additionally, or alternatively, be formulated so as to be devoid, or substantially free, of any materials (or species), steps, or components, that are otherwise not necessary to the achievement of the function or objective of the compositions and methods.

All ranges disclosed herein are inclusive of the endpoints, and the endpoints are independently combinable with each other (e.g., ranges of “less than or equal to 25 wt. %, or, more specifically, 5 wt. % to 20 wt. %”, is inclusive of the endpoints and all intermediate values of the ranges, including for example, “5 wt. % to 25 wt. %). Reference to “about” a value or parameter herein includes (and describes) embodiments that are directed to that value or parameter per se. In certain embodiments, the term “about” includes the indicated amount±50%. In certain other embodiments, the term “about” includes the indicated amount 20%. In certain other embodiments, the term “about” includes the indicated amount±10%. In other embodiments, the term “about” includes the indicated amount±5%. In certain other embodiments, the term “about” includes the indicated amount±1%. In certain other embodiments, the term “about” includes the indicated amount±0.5% and in certain other embodiments, 0.1%. Such variations are appropriate to perform the disclosed methods or employ the disclosed compositions. Also, to the term “about x” includes description of “x”.

“Combinations” is inclusive of blends, mixtures, alloys, reaction products, and the like. The terms “a” and “an” and “the” do not denote a limitation of quantity and are to be construed to cover both the singular and the plural, unless otherwise indicated herein or clearly contradicted by context. “Or” means “and/or” unless clearly stated otherwise.

Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements can be combined in any suitable manner in the various embodiments.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended aspects as filed, and as they can be amended, are intended to embrace all such alternatives, modifications variations, improvements, and substantial equivalents.

1. A reactive oligomer comprising a backbone derived from at least one of polyamideimide, polyimide, polyetherimide, polyaryletherketone, polyethersulfone, polyphenylene sulfide, polyamide, polyester, polyarylate, polyesteramide, polycarbonate, polybenzoxazole or polybenzimidazole and functionalized with at least one unreacted functional group capable of thermal chain extension and crosslinking after formation of the reactive oligomer, wherein the reactive oligomer has a number average molecular weight (Mₙ) of about 250 to about 10,000 g/mol, calculated using the Carothers equation.

2. The reactive oligomer of claim 1, wherein the at least one unreacted functional group is at least one of maleimide, 5-norbornene-2,3-dicarboxylic imide, phthalonitrile, benzocyclobutene, biphenylene, cyanate ester, ketoethyne, ethyne, methylethyne, phenylethyne, propargyl ether or benzoxazine.

3. The reactive oligomer of claim 1, functionalized with first and second unreacted functional groups capable of thermal chain extension and crosslinking after formation of the reactive oligomer, wherein the first unreacted functional group is self-reactive within a first temperature range, the second unreacted functional group is self-reactive within a second temperature range, and the second temperature range is higher than the first temperature range.

4. (canceled)

5. The reactive oligomer of claim 1, wherein the backbone is derived from a polyamideimide.

6. The reactive oligomer of claim 5, wherein the at least one unreacted functional group is derived from a monomer or end-capper selected from the group consisting of:

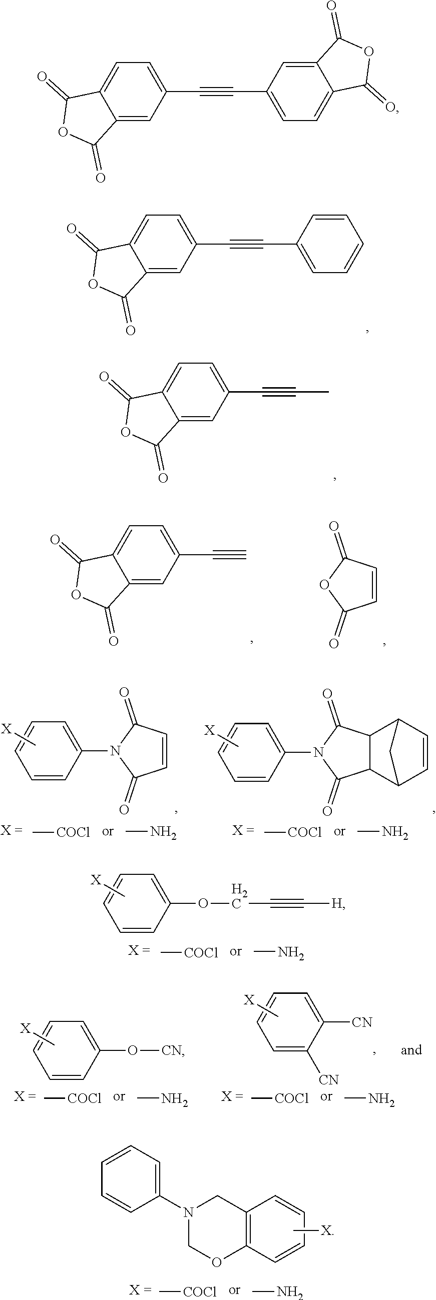

7-9. (canceled)

10. The reactive oligomer of claim 1, wherein the backbone is derived from a polyimide.

11. The reactive oligomer of claim 1, having the Formula (I): 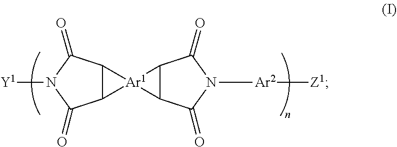
wherein the tetravalent aryl group represented by Ar¹ is at least one of: 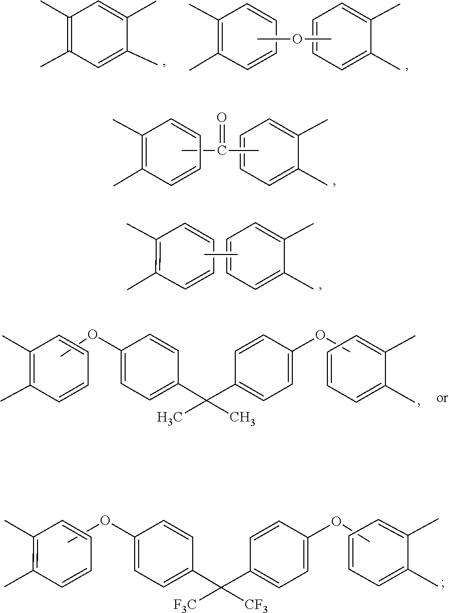
the divalent aryl group represented by Ar² is at least one of: 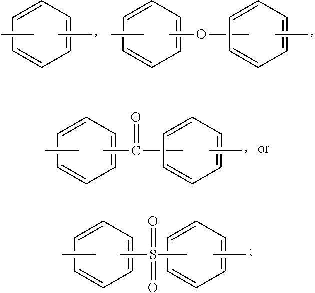
Y¹ and Z¹ are each independently derived from an end-capper selected from the group consisting of: 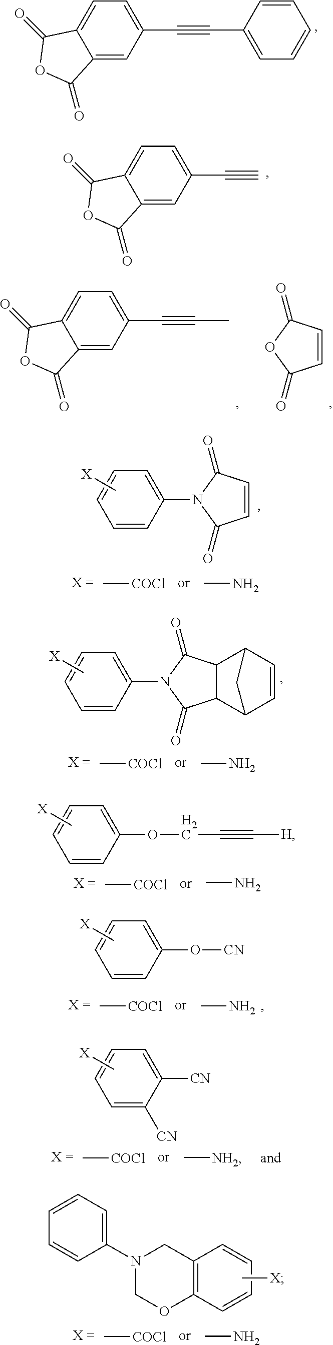
and
n is selected to provide a calculated Mₙ in the range of about 250 to about 10,000 g/mol.

12. The reactive oligomer of claim 11, wherein Y¹ and Z¹ are different.

13-42. (canceled)

43. A composition comprising at least one reactive oligomer of claim 1.

44. The composition of claim 43, comprising first and second reactive oligomers, wherein the first reactive oligomer is functionalized with a first unreacted functional group capable of thermal chain extension and crosslinking after formation of the first reactive oligomer, the second reactive oligomer is functionalized with a second unreacted functional group capable of thermal chain extension and crosslinking after formation of the second reactive oligomer, the first unreacted functional group is self-reactive within a first temperature range, the second unreacted functional group is self-reactive within a second temperature range, and the second temperature range is higher than the first temperature range.

45. The composition of claim 43, comprising first and second reactive oligomers, wherein the first reactive oligomer has a first number average molecular weight (M), and the second the second reactive oligomer has a second number average molecular weight (M).

46-52. (canceled)

53. A method of manufacture of an article, the method comprising heating the composition of claim 43 at a sufficient temperature and time to shape and crosslink the reactive oligomer.

54. The method of manufacture of claim 53, wherein the method is additive manufacturing.

55. The method of additive manufacturing of claim 54, wherein the method is fused filament fabrication (FFF), selective laser sintering (SLS), directed energy deposition (DED) laser engineered net shaping (LENS), or composite-based additive manufacturing (CBAM).

56. A method of additive manufacturing using the reactive oligomer of claim 3, comprising the steps of:
curing the first unreacted functional group within the first temperature range; and
curing the second unreacted functional group within the second temperature range.

57. A method of additive manufacturing using the composition of claim 44, comprising the steps of:
curing the first reactive oligomer functionalized with the first unreacted functional group within the first temperature range; and
curing the second reactive oligomer functionalized with the second unreacted functional group within the second temperature range.

58. The method of manufacturing of claim 54, wherein the method is fused filament fabrication, the method comprising extruding the composition in adjacent horizontal layers such that there is an interface between each layer, and exposing the layers to heat at a sufficient temperature and time to crosslink the reactive oligomer and form an article.

59. The method of manufacture of claim 54, wherein the method is selective laser sintering, the method comprising selectively sintering and crosslinking particles of the composition with a laser to form an article.

60. An article manufactured by the method of claim 53.

61. The reactive oligomer of claim 6, wherein the at least one unreacted functional group is derived from an end-capper selected from the group consisting of:

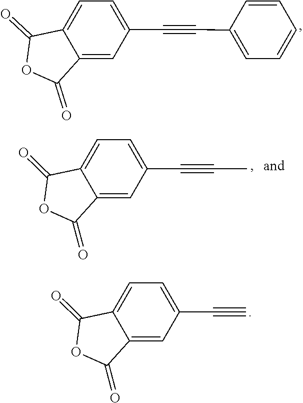

62. The reactive oligomer of claim 11, wherein the tetravalent aryl group represented by Ar¹ comprises: 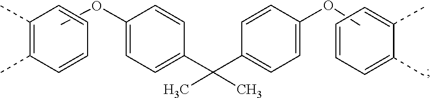
the divalent aryl group represented by Ar² comprises: 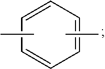
and
Y¹ and Z¹ are each independently derived from an end-capper selected from the group consisting of: [chemical structure]
